(19) United States
(12) Patent Application Publication
(10) Pub. No.: US 2010/0198121 A1
(43) Pub. Date: Aug. 5, 2010

(54) CHAIR-TYPE MASSAGE MACHINE

(75) Inventors: Mitsunori Tago, Tottori (JP); Keisuke Takatsuka, Tottori (JP); Tomoharu Fukuda, Tottori (JP); Noriaki Watanabe, Osaka (JP); Mitsunori Kato, Tottori (JP); Motoki Okuyama, Osaka (JP)

Correspondence Address: DRINKER BIDDLE & REATH (DC), 1500 K STREET, N.W., SUITE 1100, WASHINGTON, DC, 20005-1209, US

(73) Assignee: FAMILY Co., Ltd., Osaka-shi, Osaka (JP)

(21) Appl. No.: 12/669,120

(22) PCT Filed: Jul. 10, 2008
(86) PCT No.: PCT/JP2008/001858

§ 371 Date: Jan. 14, 2010

(30) Foreign Application Priority Data
Jul. 24, 2007 (JP) 2007-192360
Jul. 24, 2007 (JP) 2007-192361
Oct. 12, 2007 (JP) 2007-267169
Jan. 31, 2008 (JP) 2008-020116

(51) Int. Cl. A61H 9/00

(52) U.S. Cl. 601/150

(57) ABSTRACT

In a chair-type massage machine equipped with a seat section and a backrest section provided backwardly of this seat section and a pillow section (5) provided above the above-mentioned backrest section, shoulder outside air cells (21), shoulder inside air cells (22), shoulder lower air cells (23) and neck air cells (20) are disposed, and these air cells (20) to (23) are controlled independently of one another, thereby performing treatment operations at plural portions of the user.

### TECHNICAL FIELD

The present invention relates to a chair-type massage machine capable of treating the shoulder portions or neck portion of the user sitting on the seat section thereof.

### BACKGROUND ART

Among machines known as massage machines, chair type machines are available, each machine being equipped with a seat section and a backrest section and these sections being provided with treatment devices, such as air cells and massaging balls. This kind of massage machine can treat the user by performing rubbing and pounding operations while the massaging balls provided in the backrest section are moved up and down. In addition, a machine is known in which the backrest section thereof is provided with a pillow to stabilize the position of the neck of the user leaning against the backrest section (for example, refer to Patent document 1).

Furthermore, in order to perform appropriate treatment suited for the body length of the user, the massage machine described in Patent document 1 detects the shoulder position of the user, being different for each user, and estimates the positions of pressure points based on the detection, and then performs treatment at the positions of pressure points using the massaging balls. Moreover, as the pillow of the backrest section of this massage machine, a pillow, the position of which can be freely adjusted up and down, is provided to stabilize the position of the neck of the user leaning against the backrest section.

On the other hand, among the chair-type massage machines equipped with the seat section on which the user sits and the backrest section for supporting the upper body of the user sitting on the seat section from behind, a massage machine is proposed in which a massage unit equipped with pressure-massaging elements for massaging the neck and shoulder portions of the user sitting on the seat section using finger pressure is changed so as to have a forward tilting posture, a backward tilting posture or a pushing-out posture by virtue of the expansion and contraction operations of treatment bags, whereby the pressure-massaging elements corresponding to the neck and shoulder portions are moved integrally and the pressure-massaging elements are used to perform massage, such as rubbing up and rubbing down, for the neck and shoulder portions of the user (for example, refer to Patent document 2). In the case of the chair-type massage machine described in Patent document 2, the pressure-massaging elements provided corresponding to the neck portion and the shoulder portions are used to perform pressure massage at the right or left shoulder portion and the neck portion of the user simultaneously.

Furthermore, another massage machine is proposed in which a posture changing plate equipped with pressure-massaging elements for massaging both the neck and shoulder portions using finger pressure is posture-controlled so as to have a forward tilting posture or a pushing-out posture using posture control bags, thereby massaging the neck and shoulder portions of the user (for example, refer to Patent document 3). In the case of the chair-type massage machine described in Patent document 3, the pressure-massaging elements provided corresponding to the neck portion and the shoulder portions are used to perform pressure massage at the right or left shoulder portion and the neck portion of the user simultaneously or alternately.

Patent document 1: JP-2006-102094-A

Patent document 2: HP-H11-235369-A

Patent document 3: JP-H11-244347-A

### DISCLOSURE OF THE INVENTION

### Problem to be Solved by the Invention

The back portion and shoulder portions of the user can be treated, for example, by providing treatment devices for treating the shoulder portions of the user on the pillow of the massage machine described in the above-mentioned Patent document 1. However, an effective treatment effect cannot be obtained by simply pressing the shoulder portions of the user using the treatment devices.

In addition, the shoulder position of the user is changed and the position of the pillow section is thus altered in some cases when the massage machine according to the above-mentioned Patent document 1 is reclined, for example. Although the massage machine is provided with air bags for treating the back portion of the user, when the shoulder position of the user is changed from its initial position, there occurs a problem in which the treatment operations using the massaging balls and the air bags are difficult to be adapted to the user.

Furthermore, in the inventions described in the above-mentioned Patent documents 2 and 3, as treatment for the area ranging from the shoulder portions to the neck portion of the user, only pressure treatment for pressing the left and right positions thereof simultaneously or alternately is performed.

Accordingly, the present invention is firstly intended to provide a chair-type massage machine capable of obtaining a high treatment effect using treatment devices provided on the pillow section thereof; secondly intended to provide a chair-type massage machine, in the case of being equipped with a treatment device provided on the backrest section thereof and capable of being raised and lowered to treat the back portion of the user and a treatment device provided to treat predetermined portions of the user sitting on the seat section, capable of causing treatment operations using both the treatment devices to be adapted to the user even if the position of the pillow section is changed; and thirdly intended to provide a chair-type massage machine capable of allowing the neck portion of the user to receive not only pressure treatment but also stretch treatment for performing stretching.

### Means for Solving Problem

For the purpose of attaining the above-mentioned objects, a chair-type massage machine according to the present invention includes: a seat section; a backrest section provided backward the seat section; a pillow section provided above the backrest section; shoulder treatment portions that are disposed on the pillow section and that have plural treatment devices to perform treatment correspondingly to plural positions of each shoulder portion of the user; and a control section configured so as to control the plural treatment devices independently of one another.

With the above-mentioned massage machine according to the present invention, the plural positions of each shoulder portion of the user are treated using the plural treatment devices controlled independently of one another, whereby various treatment operations can be performed for the shoulder portions, and the user can obtain a high treatment effect.

In addition, it is preferable that the plural treatment devices include: shoulder outside treatment devices provided correspondingly to the outside portions of the shoulder portions of the user to treat these portions from above; shoulder inside treatment devices provided correspondingly to the inside portions of the shoulder portions of the user to treat these portions from above; and shoulder lower treatment devices provided correspondingly to the rear side portions of the shoulder portions of the user to treat these portions from behind, and that the shoulder outside treatment devices, the shoulder inside treatment devices and the shoulder lower treatment devices are each formed of an air cell that is expanded by supplying air.

In this case, the above-mentioned massage machine can treat each one of the shoulder portions from above using the shoulder outside treatment device and the shoulder inside treatment device and from behind using the shoulder lower treatment device; hence, various treatment patterns can be used.

Examples of treatment patterns performed using the respective treatment devices include the following.

The control section executes control so that part of the time zone in which the shoulder outside treatment devices are expanded is overlapped with part of the time zone in which the shoulder inside treatment devices are expanded, whereby inside/outside double rubbing treatment is performed for the shoulder portions. Expansion is herein defined as a state obtained in a period from the time when a treatment device begins to be expanded to the time when the expanded treatment device is contracted.

With this treatment pattern, the shoulder portions of the user are very smoothly rubbed from outside to inside or from inside to outside, whereby the user can receive inside/outside double rubbing treatment.

Examples of treatment patterns for the inside/outside double rubbing treatment include the following.

The control section sets the length of the time zone in which the shoulder outside treatment devices are expanded to be substantially the same as the length of the time zone in which the shoulder inside treatment devices are expanded.

In addition, the control section expands the shoulder lower treatment devices when part of the time zone in which the shoulder outside treatment devices are expanded is overlapped with part of the time zone in which the shoulder inside treatment devices are expanded.

Furthermore, treatment patterns other than those for the inside/outside double rubbing treatment include the following.

The control section executes control so that the shoulder outside treatment devices, the shoulder inside treatment devices and the shoulder lower treatment devices are expanded simultaneously for a certain time and then, among them, the shoulder outside treatment devices or the shoulder inside treatment devices and the shoulder lower treatment devices are contracted, whereby inside/outside rubbing treatment is performed for the shoulder portions.

With this treatment pattern, the shoulder portions of the user are smoothly rubbed from outside to inside or from inside to outside, whereby the user can receive inside/outside rubbing treatment.

Besides, the control section executes control so that the shoulder lower treatment devices are expanded for a certain time and, while these remain expanded, the shoulder outside treatment devices and the shoulder inside treatment devices are expanded, whereby pushing-up rubbing treatment is performed for the shoulder portions.

With this treatment pattern, the shoulder portions of the user are pressed from above while being pushed up from below, whereby the user can receive pushing-up rubbing treatment.

Moreover, it is preferable that a neck treatment device is provided at a portion of the pillow section corresponding to the neck portion of the user to treat the neck portion, that the neck treatment device is formed of an air cell that is expanded by supplying air thereto, and that the control section is configured so as to control the neck treatment device independently of the above-mentioned plural treatment devices.

In this case, a treatment effect for the neck portion of the user is obtained, and treatment patterns can be increased further.

Still further, it is preferable that a neck treatment device is provided at a portion of the pillow section corresponding to the neck portion of the user to treat the neck portion, that the neck treatment device is formed of an air cell that is expanded by supplying air thereto, that the control section is configured so as to control the neck treatment device independently of the above-mentioned plural treatment devices, and that the control section executes control so that only the neck treatment device is expanded for a certain time and, while this remains expanded, the shoulder outside treatment devices and the shoulder inside treatment devices are expanded, whereby pushing-down treatment is performed for the shoulder portions.

With this treatment pattern, the shoulder portions are pushed down while the neck portion of the user is grasped, whereby the user can receive pushing-down treatment.

In addition, the above-mentioned plural treatment devices may include: shoulder upper treatment devices provided correspondingly to the shoulder portions of the user to treat these portions from above; shoulder lower treatment devices provided correspondingly to the rear side portions of the shoulder portions of the user to treat these portions from behind; and a neck treatment device provided correspondingly to the neck portion of the user to treat the portion, and the shoulder upper treatment devices, the shoulder lower treatment devices and the neck treatment device may each be formed of an air cell that is expanded by supplying air.

In this case, the above-mentioned massage machine can treat the shoulder portions from above using the shoulder upper treatment devices and from behind using the shoulder lower treatment devices and can treat the neck portion using the neck treatment device; hence, various treatment patterns can be used.

Furthermore, it is preferable that the neck treatment device includes: neck holding treatment devices provided correspondingly to portions near the left and right rear portions of the neck portion of the user to treat the neck portion while holding the neck portion therebetween; and a neck pushing treatment device provided correspondingly to the rear side portion of the neck portion of the user to treat the portion from behind and to push out the neck holding treatment devices toward the user, and that the control section is configured so as to control the neck holding treatment devices and the neck pushing treatment device independently of each other.

In this case, by virtue of the neck holding treatment devices and the neck pushing treatment device being controlled independently of each other, an effective treatment can be performed for the neck portion of the user.

Examples of treatment patterns using the above-mentioned respective treatment devices include the following.

The control section executes control so that the neck pushing treatment device is expanded for a certain time and, while this remains expanded, the neck holding treatment devices are expanded for a certain time and then, while the neck holding treatment devices remain expanded, the neck pushing treatment device is contracted, whereby push-pull rubbing treatment is performed for the neck portion.

With this treatment pattern, the neck portion is sandwiched on both the left and right sides while the neck portion of the user is pushed from behind, and the neck portion is pulled while being sandwiched, whereby the user can receive push-pull rubbing treatment.

Moreover, the control section executes control so that the shoulder upper treatment devices and the shoulder lower treatment devices are expanded simultaneously for a certain time, whereby sandwiching/rubbing treatment is performed for the shoulder portions.

With this treatment pattern, the shoulder portions of the user are pushed from above and behind simultaneously, whereby the user can receive sandwiching/rubbing treatment.

Still further, the control section executes control so that the shoulder upper treatment devices are expanded for a certain time and, while these remain expanded, the shoulder lower treatment devices are expanded, whereby pushing-down/sandwiching/rubbing treatment is performed for the shoulder portions. With this treatment pattern, the shoulder portions of the user are pushed from above first and then pushed from behind, whereby the user can receive pushing-down/sandwiching/rubbing treatment.

The air cells of the neck holding treatment devices should only be configured so as to be expanded while positions corresponding to the rear side portions of portions near the left and right rear portions of the neck portion of the user or positions corresponding to the front side portions thereof are used as rocking fulcrums, for example.

The air cells of the shoulder upper treatment devices should only be configured so as to be expanded while positions corresponding to the outside portions of the shoulder portions of the user or positions corresponding to the inside portions thereof are used as rocking fulcrums, for example.

The air cells of the shoulder lower treatment devices should only be configured so as to be expanded while positions corresponding to the upper side portions of the rear side portions of the shoulder portions of the user or positions corresponding to the lower side portions thereof are used as rocking fulcrums, for example.

In addition, for the purpose of attaining the above-mentioned objects, a chair-type massage machine according to the present invention includes: a seat section on which the user sits; a backrest section provided behind the seat section; a pillow section provided above the backrest section so that the position thereof can be freely adjusted in the up and down direction; an up/down movable first treatment device provided in the backrest section to treat the back portion of the user; a second treatment device provided so as to treat predetermined portions of the user sitting on the seat section; and a control section configured so as to control the treatment operations of the first treatment device and the second treatment device depending on the position of the pillow section.

With the above-mentioned massage machine according to the present invention, the control section is configured so as to control the treatment operations of the first treatment device and the second treatment device depending on the position of the pillow section; hence, even if the position of the pillow section is changed by the reclining of the backrest section, for example, the treatment operations using both the treatment devices can be adapted to the user. Examples of the first treatment device include massaging balls provided in the backrest section and examples of the second treatment device include air cells provided in the backrest section, etc.

Furthermore, it is preferable that the second treatment device is a pillow treatment device provided in the pillow section to treat the shoulder portions of the user and that the control section is configured so as to selectively perform one of treatment operations using the first treatment device and the pillow treatment device for the shoulder portions of the user.

In this case, the user can receive treatment using the treatment devices provided on the pillow section; furthermore, one of the treatment operations using the first treatment device and the pillow treatment device for the shoulder portions of the user is performed selectively, whereby the burden to the shoulder portions of the user can be relieved.

Moreover, it is preferable that a first detection portion that detects the shoulder portion is provided and that the control section sets a treatment regulation range extending in the up and down direction of the shoulder portions based on the detection result of the first detection portion and executes control so that one of the treatment operations using the first treatment device and the pillow treatment device is performed selectively in the treatment regulation range.

In this case, one of the treatment operations using the first treatment device and the pillow treatment device is performed selectively in the treatment regulation range set for the shoulder portions, whereby the burden to the shoulder portions of the user can be relieved securely.

For example, the control section should only stop the pillow treatment device in response to an arrival of the first treatment device to the treatment regulation range from below.

Furthermore, the control section may also return the first treatment device in response to an arrival of the first treatment device to the treatment regulation range from below.

It is preferable that the pillow treatment device has shoulder lower treatment devices extending from the shoulder portions to the back portion and that the treatment regulation range is a range extending from the shoulder position detected using the first detection portion to a position below the vertical dimension of the shoulder lower treatment devices.

In this case, the burden to the shoulder portions of the user making contact with the shoulder lower treatment devices can be relieved securely. In addition, it is preferable to adopt a second detection portion that detects the first treatment device when the first treatment device has been raised to the position of the pillow.

In the case that the position of the pillow section is lowered from the position located when the treatment regulation range was set, the burden to the shoulder portions of the user can be relieved by, for example, stopping the first treatment device or the pillow treatment device when the first treatment device has been raised to the position of the pillow.

Moreover, it is preferable that the control section renews the treatment regulation range extending in the up and down direction of the shoulder portions based on the detection result of the second detection portion and executes control so that one of the treatment operations using the first treatment device and the pillow treatment device is performed selectively in the renewed treatment regulation range.

In this case, the treatment regulation range is renewed even when the shoulder position of the user is changed, whereby the burden to the shoulder portions of the user can be relieved securely.

It is preferable that the pillow treatment device has: shoulder upper treatment devices that treat the shoulder portions from above; and a neck treatment device that treats the neck portion.

In this case, the neck portion of the user is treated, whereby the user can receive treatment having a higher effect.

Furthermore, it is preferable that the second treatment device has shoulder side treatment devices provided at positions corresponding to the sides of the shoulder portions to treat the shoulder portions from the sides.

In this case, the shoulder portions can be treated from the sides, and the user can receive treatment having a higher effect.

Moreover, it is preferable that a third detection portion that detects that the shoulder side treatment devices have made contact with the side portions of the pillow section is provided and that the control section stops the treatment operation of the shoulder side treatment devices based on the detection result of the third detection portion.

In this case, for example, when the user lowers the pillow section and the shoulder side treatment devices make contact with the side portions of the pillow section, the treatment operation of the shoulder side treatment devices can be stopped. Hence, the treatment operation of the shoulder side treatment devices does not become wasteful, and the user is prevented from suffering discomfort due to noise caused by interference between the pillow section and the shoulder side treatment devices.

In addition, for the purpose of attaining the above-mentioned objects, a chair-type massage machine according to the present invention includes: a seat section on which the user sits; a backrest section that supports the upper body of the user sitting on the seat section from behind; a pillow section provided above the backrest section; shoulder treatment portions having shoulder treatment devices provided at the left and right positions so as to be opposed to the upper faces of the shoulder portions of the user sitting on the seat section; and a neck treatment portion having a neck treatment device provided so as to be opposed to the neck portion or the head portion of the user sitting on the seat section, and further includes: a control section that drives/controls the shoulder treatment devices at the left and right positions independently of each other and that independently drives/controls the neck treatment device. The “neck treatment device” is a treatment device for treating the area ranging from the neck portion to the head portion of the user sitting on the seat section. Furthermore, it is herein assumed that the concept of the directions used in this specification and the claims coincides with the concept of the directions as viewed from the user sitting on the seat section. With this configuration, the shoulder portions and the neck portion or the head portion of the user can be pressed independently using the shoulder treatment devices and the neck treatment device that are driven/controlled independently of each other at the right position or the left position of the user sitting on the seat section; as a result, it is possible to receive stretch treatment in which the area ranging from the shoulder portions to the neck portion of the user is stretched by tilting the head portion while the shoulder portions of the user are pressed.

Moreover, the control section may also be equipped with a function in which, after the shoulder treatment devices on either one of the left and right positions are expanded for a certain time, while the shoulder treatment devices remain expanded, the neck treatment device is expanded for a certain time. With this configuration, while one of the left and right shoulder portions of the user is pressed using the shoulder treatment devices and the position thereof is held, the neck portion or the head portion can be pressed using the neck treatment device; as a result, it is possible to receive stretch treatment in which the area ranging from the shoulder portion to the neck portion is stretched by tilting the head portion while the shoulder portion of the user is pressed.

Besides, the neck treatment device may have head side treatment devices provided at the left and right positions so as to be opposed to the head side portions of the user sitting on the seat section, and the control section may also be equipped with a function of driving/controlling the head side treatment devices at the left and right positions independently of each other. With this configuration, the head portion can be tilted left and right by pressing the head side portions of the user from the left and right positions; as a result, stretch treatment for stretching the left and right positions of the neck portion can be received effectively.

Still further, the shoulder treatment devices may have first air cells that are expanded/contracted by supplying/exhausting air, the head side treatment devices may have second air cells that are expanded/contracted by supplying/exhausting air, the first air cells may also be configured so that the outside portions thereof serve as base end portions and the inside portions thereof are expanded toward the upper faces of the shoulder portions of the user, and the second air cells may also be configured so that the inside portions thereof serve as base end portions and the outside portions thereof are expanded toward the head side portions of the user. With this configuration, while the insides of the shoulder portions of the user are pressed using the first air cells, the head side portions are pressed from the outsides using the second air cells, whereby the head portion can be tilted sideways; as a result, stretch treatment for stretching the area ranging from the shoulder portions to the neck portion can be received gently by effectively using the cushioning property of the air cells.

In addition, the second air cells may also each be disposed so as to be inclined such that the outside portion thereof is positioned above the inside portion. With this configuration, the area ranging from the neck portion to the head portion of the user can be pressed downward; as a result, oblique tilting of the head portion of the user can be performed smoothly.

Furthermore, the neck treatment device may have a neck rear treatment device provided so as to be opposed to the rear face of the neck portion of the user sitting on the seat section, and the control section may also be equipped with a function of independently driving/controlling the neck rear treatment device. With this configuration, the head portion can be tilted backward (in the direction that the chin is raised) by pressing the rear face of the neck portion of the user and by lifting the rear portion of the head; as a result, stretch treatment for stretching the front portion of the neck portion can be received effectively.

Moreover, the neck rear treatment device may have a third air cell that is expanded/contracted by supplying/exhausting air, and the third air cell may also be configured so that the upper side portion thereof serves as a base end portion and the lower side portion thereof is expanded toward the neck portion of the user. With this configuration, the rear portion of the head can be lifted by pressing the lower portion of the rear face of the neck portion of the user when the third air cell is expanded; as a result, stretch treatment for effectively stretching the front portion of the neck portion can be received gently by effectively using the cushioning property of the air cell.

Besides, armrest sections that support the arm portions of the user sitting on the seat section may also be provided at the left and right positions, the armrest sections may have fourth air cells that treat the arm portions of the user, and the control section may be equipped with a function of driving/controlling the fourth air cells located at the left and right positions independently of each other. With this configuration, while stretch treatment for stretching the area ranging from the shoulder portions to the neck portion is performed, pressure treatment can also be received at one or both of the arm portions.

What's more, fifth air cells that treat the leg portions of the user sitting on the seat section from the left and right positions may also be provided, and the control section may be equipped with a function of driving/controlling the fifth air cells located at the left and right positions independently of each other. With this configuration, while stretch treatment for stretching the area ranging from the shoulder portions to the neck portion is performed, pressure treatment can also be received at one or both of the thighs.

Still further, back treatment devices that treat the back portion of the user leaning against the backrest section from the left and right positions may be provided, and the control section may also be equipped with a function of driving/controlling the back treatment devices located at the left and right positions independently of each other. With this configuration, while stretch treatment for stretching the area ranging from the shoulder portions to the neck portion is performed, treatment for twisting the body can be received by pressing one or both sides of the back portion.

### Effects of the Invention

With the present invention, by virtue of the units described above, firstly, plural portions of each shoulder portion of the user are treated using the plural treatment devices controlled independently of one another, whereby various treatment operations can be performed and the user can obtain a high treatment effect. Furthermore, secondly, the control section is provided that is configured so as to control the treatment operations of the first treatment device and the second treatment device depending on the position of the pillow section, whereby even if the position of the shoulder is changed and the position of the pillow section is thus altered, the treatment operations using both the treatment devices can be adapted to the user. Furthermore, thirdly, it is possible to provide a chair-type massage machine by which the user sitting on the seat section thereof can effectively receive stretch treatment for stretching the area ranging from the shoulder portions to the neck portion.

### BRIEF DESCRIPTION. OF THE DRAWINGS

FIG. 1 is an overall perspective view showing a massage machine according to a first embodiment of the present invention.

FIG. 2 is a front view showing a pillow section shown in FIG. 1.

FIG. 3 is a front view showing the pillow section with a cover, etc. removed therefrom.

FIG. 4 is an overall perspective view showing the massage machine as seen from behind.

FIG. 5 is a front view showing a back cover.

FIG. 6 is a perspective view showing the back cover as seen from the back side.

FIG. 7 is a block diagram showing a control system.

FIG. 8 is a diagram illustrating the expansion and contraction operations of respective air cells in treatment patterns 1 to 4.

FIG. 9 is a diagram illustrating the expansion and contraction operations of respective air cells in treatment patterns 5 to 8.

FIG. 10 is a front view showing the pillow section of a massage machine according to a second embodiment of the present invention with a cover, etc. removed therefrom.

FIG. 11 is a bottom view showing the pillow section shown in FIG. 10.

FIG. 12 is a diagram illustrating the expansion and contraction operations of respective air cells in treatment patterns 9 to 11.

FIG. 13A is a front schematic view showing the pillow section of a massage machine according to a third embodiment; FIG. 13B is a front schematic view showing the pillow section of a massage machine according to a fourth embodiment; and FIG. 13C is a front schematic view showing the pillow section of a massage machine according to a fifth embodiment

FIG. 14A is a front schematic view showing a massage machine according to a sixth embodiment; and FIG. 14B is a front schematic view showing a massage machine according to a seventh embodiment.

FIG. 15A is a front schematic view showing a massage machine according to an eighth embodiment; and FIG. 15B is a front schematic view showing a massage machine according to a ninth embodiment.

FIG. 16A is a front schematic view showing a massage machine according to a 10th embodiment; and FIG. 16B is a front schematic view showing a massage machine according to an 11th embodiment.

FIG. 17 is a front schematic view showing a massage machine according to a 12th embodiment.

FIG. 18A is a front schematic view showing a massage machine according to a 13th embodiment; and FIG. 18B is a front schematic view showing a massage machine according to a 14th embodiment.

FIG. 19A is a front schematic view showing a massage machine according to a 15th embodiment; and FIG. 19B is a front schematic view showing a massage machine according to a 16th embodiment.

FIG. 20A is a front schematic view showing a massage machine according to a 17th embodiment; and FIG. 20B is a front schematic view showing a massage machine according to an 18th embodiment.

FIG. 21A is a front schematic view showing a massage machine according to a 19th embodiment; and FIG. 21B is a front schematic view showing a massage machine according to a 20th embodiment.

FIG. 22A is a side schematic view showing a massage machine according to a 21st embodiment; and FIG. 22B is a front schematic view showing a massage machine according to a 22nd embodiment.

FIG. 23 is an overall perspective view showing a massage machine according to a 23rd embodiment of the present invention.

FIG. 24 is a front view showing a pillow section shown in FIG. 23 with a cover removed therefrom.

FIG. 25 is a perspective view showing the massage machine shown in FIG. 23 as seen from behind.

FIG. 26 is a front view showing the pillow main body of the pillow section shown in FIG. 23 with a cover, treatment devices, etc. removed therefrom.

FIG. 27 is a perspective view showing the pillow main body shown in FIG. 26.

FIG. 28 is a front view showing the pillow main body shown in FIG. 26 with a front face member removed therefrom.

FIG. 29 is a block diagram illustrating the control system of the massage machine shown in FIG. 23.

FIG. 30 is a flowchart showing the flow of the treatment operations of massaging balls and air cells according to the 23rd embodiment.

FIG. 31 is a schematic view illustrating the treatment operations of the massaging balls and the air cells according to the 23rd embodiment.

FIG. 32 is a flowchart showing the flow of the treatment operations of massaging balls and air cells according to a 24th embodiment.

FIG. 33 is a schematic view illustrating the treatment operations of the massaging balls and the air cells according to the 24th embodiment.

FIG. 34 is a flowchart showing the flow of the treatment operations of massaging balls and air cells according to a 25th embodiment.

FIG. 35 is a schematic view illustrating the treatment operations of the massaging balls and the air cells according to the 25th embodiment.

FIG. 36 is an overall perspective view showing a chair-type massage machine according to a 26th embodiment of the present invention as seen from front.

FIG. 37 is an overall perspective view showing the chair-type massage machine shown in FIG. 36 as seen from behind.

FIG. 38 is a front view showing the pillow section of the chair-type massage machine shown in FIG. 36.

FIG. 39 is a block diagram illustrating the mechanical functions of the chair-type massage machine shown in FIG. 36.

FIG. 40 is a diagram illustrating the expansion and contraction operations of respective air cells in treatment patterns 12 to 14 in the chair-type massage machine shown in FIG. 36.

FIG. 41 is a diagram illustrating the expansion and contraction operations of respective air cells in treatment pattern 15 in the chair-type massage machine shown in FIG. 36.

FIG. 42 is a diagram illustrating the expansion and contraction operations of respective air cells in treatment patterns 16 and 17 in the chair-type massage machine shown in FIG. 36.

FIG. 43 is a diagram illustrating the expansion and contraction operations of respective air cells in treatment patterns 18 and 19 in the chair-type massage machine shown in FIG. 36.

FIG. 44 is a diagram illustrating the expansion and contraction operations of respective air cells in treatment patterns 20 and 21 in the chair-type massage machine shown in FIG. 36.

FIG. 45 is a diagram illustrating the expansion and contraction operations of respective air cells in treatment patterns 22 and 23 in the chair-type massage machine shown in FIG. 36.

FIG. 46 is a diagram illustrating the expansion and contraction operations of respective air cells in treatment pattern 24 in the chair-type massage machine shown in FIG. 36.

FIG. 47 is a diagram illustrating the expansion and contraction operations of respective air cells in treatment pattern 25 in the chair-type massage machine shown in FIG. 36.

FIG. 48A is a front view of the chair-type massage machine, showing treatment positions in treatment pattern 12.

FIG. 48B is a front view of the chair-type massage machine, showing treatment positions in treatment pattern 13.

FIG. 49 is a front view of the chair-type massage machine, showing treatment positions in treatment pattern 14.

FIG. 50 is a front view of the chair-type massage machine, showing treatment positions in treatment pattern 15.

FIG. 51A is a front view of the chair-type massage machine, showing treatment positions in treatment pattern 16.

FIG. 51B is a front view of the chair-type massage machine, showing treatment positions in treatment pattern 17.

FIG. 52A is a front view of the chair-type massage machine, showing treatment positions in treatment pattern 18.

FIG. 52B is a front view of the chair-type massage machine, showing treatment positions in treatment pattern 19.

FIG. 53A is a front view of the chair-type massage machine, showing treatment positions in treatment pattern 20.

FIG. 53B is a front view of the chair-type massage machine, showing treatment positions in treatment pattern 21.

FIG. 54A is a front view of the chair-type massage machine, showing treatment positions in treatment pattern 22.

FIG. 54B is a front view of the chair-type massage machine, showing treatment positions in treatment pattern 23.

FIG. 55 is a front view of the chair-type massage machine, showing treatment positions in treatment pattern 24.

FIG. 56 is a front view of the chair-type massage machine, showing treatment positions in treatment pattern 25.

### EXPLANATIONS OF LETTERS OR NUMERALS

1 seat section
3 backrest section
5 pillow section
8 massaging balls
11 shoulder treatment face
35 upper apron
37 lower apron
20 neck air cell
21 shoulder outside air cell
22 shoulder inside air cell
23 shoulder lower air cell
30 control section
51 pillow supporting portion
201 seat section
203 backrest section
205 pillow section
207 massaging balls
209 control section
250 pillow main body
216 base portion
218 massaging ball sensor portion
222 first limit switch
225 abutment member
228 second limit switch
235 treatment regulation range
240 new treatment regulation range
A1 neck air cell
A2 shoulder upper air cell
A3 shoulder lower air cell
A4 shoulder side air cell
302 seat section
303 backrest section
304 armrest section
305 footrest section
306 arm cover portion
307 pillow section
320 head (neck) right air cell (second air cell)
321 head (neck) left air cell (second air cell)
322 neck rear air cell (third air cell)
323 shoulder right air cell (first air cell)
324 shoulder left air cell (first air cell)
325 back right air cell (sixth air cell)
326 back left air cell (sixth air cell)
336 arm right air cell (fourth air cell)
337 arm left air cell (fourth air cell)
338 leg right air cell (fifth air cell)
339 leg left air cell (fifth air cell)
360 control section
M24 chair-type massage machine

### BEST MODES FOR CARRYING OUT THE INVENTION

Embodiments according to the present invention will be described below referring to the drawings.

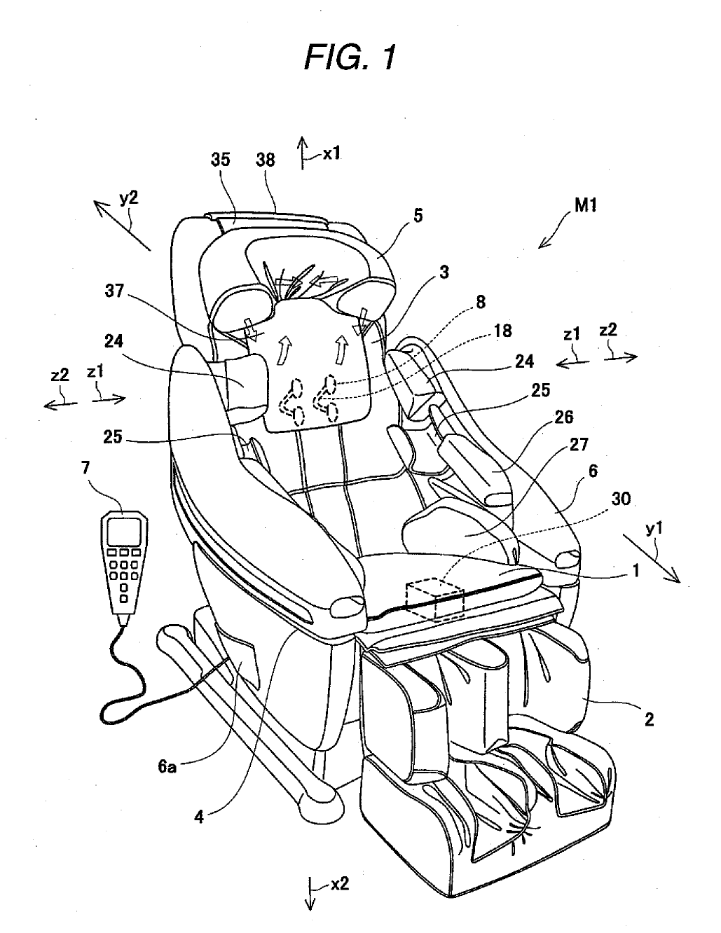

FIG. 1 is a perspective view showing a massage machine M1 according to an embodiment (first embodiment) of the present invention, and this massage machine M1 is configured as a chair type. The massage machine M1 includes a seat section 1, a footrest section (footrest) 2, a backrest section 3, armrest sections 4 on both the left and right sides of the seat section 1, and a pillow section 5 provided on the front upper portion of the backrest section 3 so that the position thereof can be freely adjusted. In addition, the armrest sections 4 are each provided with an arm cover member 6 formed so as to cover each entire arm of the user. Furthermore, a remote control apparatus 7 is contained in the side pocket 6a of the seat section 1. In the following description, it is determined that arrow x1 in the chair-type massage machine M1 shown in FIG. 1 indicates an upward direction, that arrow x2, reverse of arrow x1, indicates a downward direction, that arrow y1 indicates a forward direction, that arrow y2, reverse of arrow y1, indicates a backward direction, that arrow z1 pointing to the center of the chair-type massage machine M1 in the left and right direction indicates an inward direction, and that arrow z2, reverse of arrow z1, indicates an outward direction.

The footrest section 2 is installed forwardly of the seat section 1 so as to be turnable around a horizontal axis and can be moved using a lifting mechanism (not shown) from its moved-down state shown in FIG. 1 to its forward protruding and moved-up state. The backrest section 3 is turnably installed backwardly of the seat section 1 and can be moved using a reclining mechanism (not shown) from its standing state shown in FIG. 1 to a reclined state in which the section is tilted backward.

The inside of the backrest section 3 is provided with a treatment unit (not shown) equipped with two left and right sets of massaging balls 8, each set being formed of one upper ball and one lower ball, to apply mechanical stimulation to the user. These upper and lower massaging balls 8 are provided on V-shaped arms 18. In addition, the treatment unit is designed so as to be movable along a pair of left and right guide rails (not shown) being straight in the up and down direction and provided inside the backrest section 3, thereby being movable inside the backrest section 3 in the up and down direction using a movement mechanism (not shown).

Furthermore, the movement mechanism can move the massaging balls 8 in the front and rear direction, and in this front and rear direction movement, the strength of the force in the direction can be changed. Moreover, the treatment unit is equipped with a treatment mechanism (not shown) capable of causing the massaging balls 8 to perform treatment operations, rubbing and pounding. This treatment mechanism has, for rubbing, a motor and a rubbing mechanism section for causing the massaging balls 8 to perform rubbing using this motor, and has, for pounding, a motor and a pounding mechanism section for causing the massaging balls 8 to perform pounding using this motor, although these are not shown.

The rubbing mechanism section causes the massaging balls 8 to perform periodic rotation, thereby to perform rubbing, and the pounding mechanism section causes the massaging balls to perform periodic operation in the front and rear direction, thereby to perform pounding. Furthermore, the massage machine M1 is provided with various kinds of air cells serving as treatment devices that are expanded by supplying air. These air cells are connected to an air unit that is provided below the seat section 1 and has an air pump, and the expansion of the air cells using the air pump can perform treatment for the user. Moreover, vibrator mechanisms serving as treatment devices are provided in the seat section 1, the footrest section 2, the backrest section 3, etc., although these are not shown.

The treatment unit is provided with a shoulder position sensor portion (not shown) for detecting the shoulder position of the user. This shoulder position sensor portion is configured as a rocking detection sensor for detecting the rocking of the arms 18 on which the massaging balls 8 are provided. This rocking detection sensor is designed to detect that the arms 18 rock forward when the massaging balls 8 inside the backrest section 3 are moved, for example, from the lower back portion to the neck of the user in the height direction and when the upper massaging balls 8 reach the shoulder portions. The rocking detection sensor is formed of an optical sensor having a light-emitting element and a light-receiving element and detects that the arms are located in a predetermined rocking range depending on whether the light-receiving element receives the light form the light-emitting element. The shoulder position is recognized using a detection signal from the rocking detection sensor at this time.

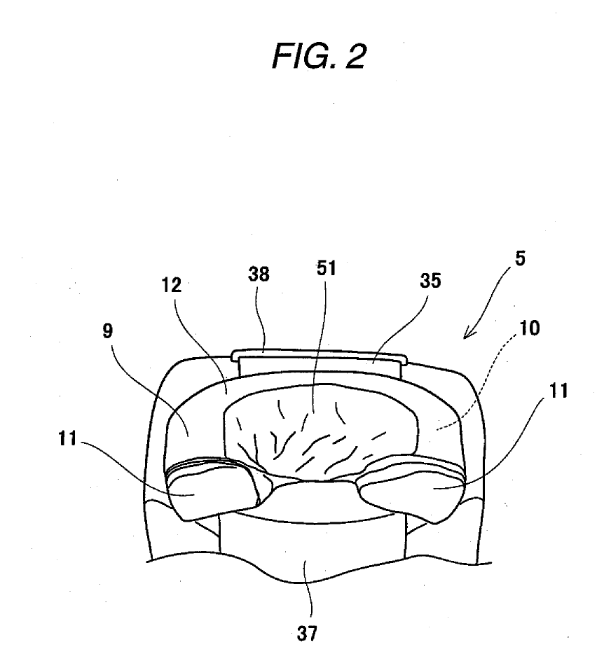

As shown in FIG. 2, the pillow section 5 is covered with a covering member 9 and is, as a whole, formed into a substantially triangular shape in side view, being long in the left and right direction and becoming wider forward and downward. The pillow section 5 has a flat back face 10 along the backrest section 3, a left and right pair of shoulder treatment faces 11 along both the shoulders of the user, a front face 12 formed into the shape of an arch in the up and down direction, and a pillow supporting portion 51 for supporting the rear portion of the head and the neck portion of the user. The shoulder treatment faces 11 extend from inside to outside and are inclined inward and upward along the shoulder portions.

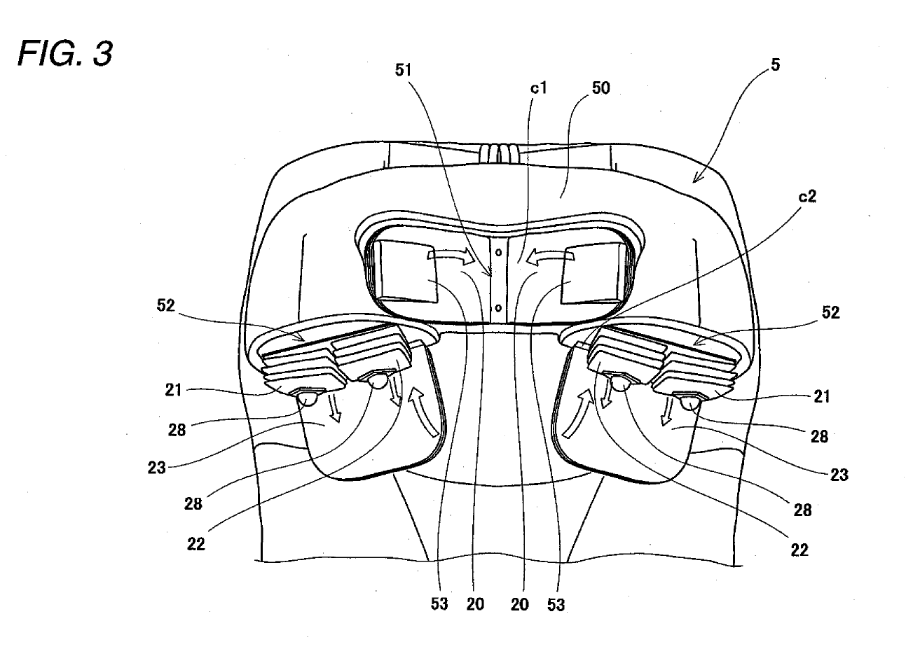

The pillow supporting portion 51 has a high cushioning property and is formed so as to be dented toward the lower central portion thereof. With the pillow section 5 formed as described above, the user places his or her head portion, neck portion and shoulder portions on the pillow supporting portion 51 and can receive treatment in a relaxed state. FIG. 3 shows a pillow main body 50 with the covering member 9, etc. removed from the pillow section 5. As shown in the figure, the pillow supporting portion 51 is provided with a left and right pair of neck air cells 20 serving as a neck treatment device for treating the neck portion at positions corresponding to the neck portion of the user. In addition, main body bottom portions 52 corresponding to the shoulder treatment faces 11 are provided with a left and right pair of shoulder outside air cells 21 (shoulder outside treatment devices) at positions corresponding to the outside portions of the shoulder portions of the user to treat the these portions from above and a left and right pair of shoulder inside air cells 22 (shoulder inside treatment devices) at positions corresponding to the inside portions of the shoulder portions of the user to treat the these portions from above.

Furthermore, the rear lower side of the pillow main body 50 is provided with a left and right pair of shoulder lower air cells 23 (shoulder lower treatment devices) at positions corresponding to the rear sides of the shoulder portions of the user to treat the these portions from behind. The neck air cells 20 are each provided with a pad 53 having a high cushioning property, and the neck air cells 20 are expanded/contracted while an inside portion c1 is used as a rocking fulcrum. The shoulder outside air cells 21 and the shoulder inside air cells 22 are provided with finger pressure devices 28 to perform finger-pressure treatment for the shoulder portions, and the shoulder outside air cells 21 and the shoulder inside air cells 22 are expanded/contracted in the up and down direction. The shoulder lower air cells 23 are formed into a substantially rectangular shape, and the shoulder lower air cells 23 are expanded/contracted while the upper side portion c2 (with respect to a position to be used as a rocking fulcrum in the following description, in the case that the upper side portion, lower side portion, right side portion, left side portion, front side portion or rear side portion of each air cell disposed is used as a rocking fulcrum, these are respectively referred to as a cell upper side portion, a cell lower side portion, a cell right side portion, a cell left side portion, a cell front side portion and a cell rear side portion) of each of the air cells 23 is used as a rocking fulcrum.

Hence, when the neck air cells 20 are expanded, the neck portion is grasped; when the shoulder outside air cells 21 and the shoulder inside air cells 22 are expanded, the upper portions of the shoulder portions are pressed from above; and when the shoulder lower air cells 23 are expanded, the shoulder portions are pushed up from behind.

Furthermore, the inner upper portions of the arm cover members 6 are provided with shoulder side, air cells 24 for treating the areas around the shoulder portions from the sides at positions corresponding to the outsides of the shoulder portions of the user (see FIG. 1). Moreover, the inside portions of the arm cover members 6 are provided with holders 25 for grasping the arms and arm air cells 26 for treating the front portions of the arms, and both side portions of the seat section 1 are provided with leg air cells 27 for treating the thighs (see FIG. 1). The above-mentioned configuration in which the air cells are provided is taken as an example, and the number of the air cells and the arrangement thereof are not limited to those according to this embodiment.

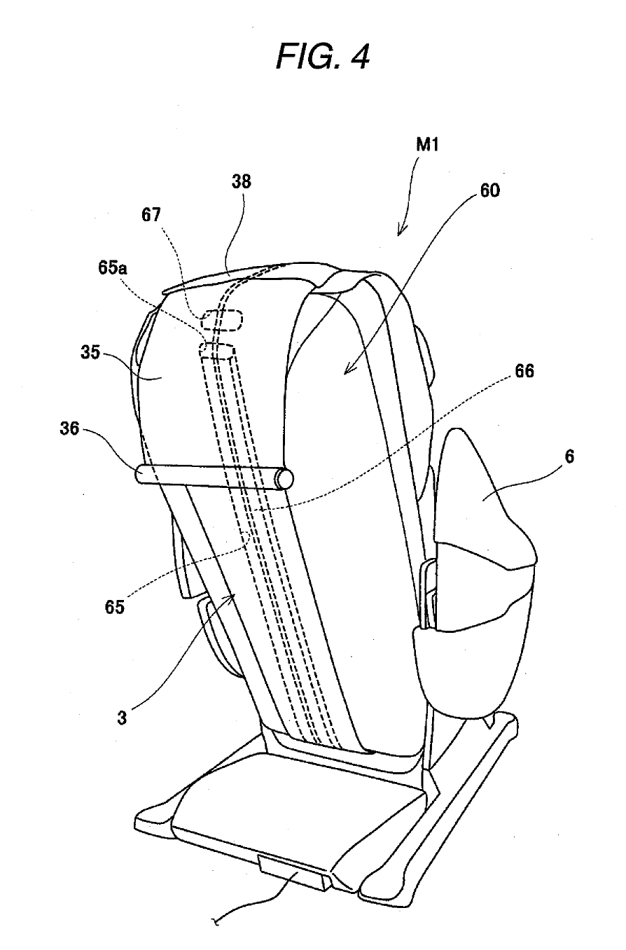

As shown in FIGS. 1 and 4, the back face upper fringe of the pillow section 5 is provided with a cloth-like upper apron 35 covered with the same material as that of the backrest section 3. This upper apron 35 extends from the position of the pillow section 5 beyond the upper face of the backrest section 3 to the back face of the backrest section 3. Furthermore, on the tip end of the upper apron 35, a weight 36 extending in the left and right direction is secured. The back face lower fringe of the pillow section 5 is provided with a cloth-like lower apron 37 covered with the same material as that of the backrest section 3. This lower apron 37 is placed on the front face of the backrest section 3 and is sandwiched between the user and the backrest section 3 when the user leans against the backrest section 3.

Moreover, the upper face of the backrest section 3 is provided with an insertion portion 38 through which the upper apron 35 can be inserted in the front and rear direction. As the upper apron 35 is inserted through this insertion section 38, the tip end thereof hangs down in the vertical direction by virtue of the weight 36. As a result, the pillow section 5 is in a state of being biased upward.

When the user wishes to lower the position of the pillow section 5, the user holds the pillow section 5 or the lower apron 37 and pulls it downward. At that time, if the user pulls the pillow section 5 obliquely while slightly lifting the pillow section 5 so that the pillow section is set in a state of being spaced from the backrest section 3, the pillow section 5 can be lowered with a smaller force. In addition, since the lower apron 37 provided at the back face lower fringe of the pillow section 5 is sandwiched between the user and the backrest section 3 when the user leans against the backrest section 3, the position of the pillow section 5 having been lowered to a desired position can be secured and prevented from being displaced. When the position of the pillow section 5 is desired to be raised and when the pillow section 5 is released from its secured or held state by lifting the pillow section 5, for example, the pillow section is moved upward by virtue of the biasing force of the weight 36. With this simple configuration, the position of the pillow section 5 can be freely adjusted in the up and down direction. Furthermore, since the lower apron 37 provided at the back face lower fringe of the pillow section 5 is sandwiched between the user and the backrest section 3, the pillow section 5 can be prevented from being displaced.

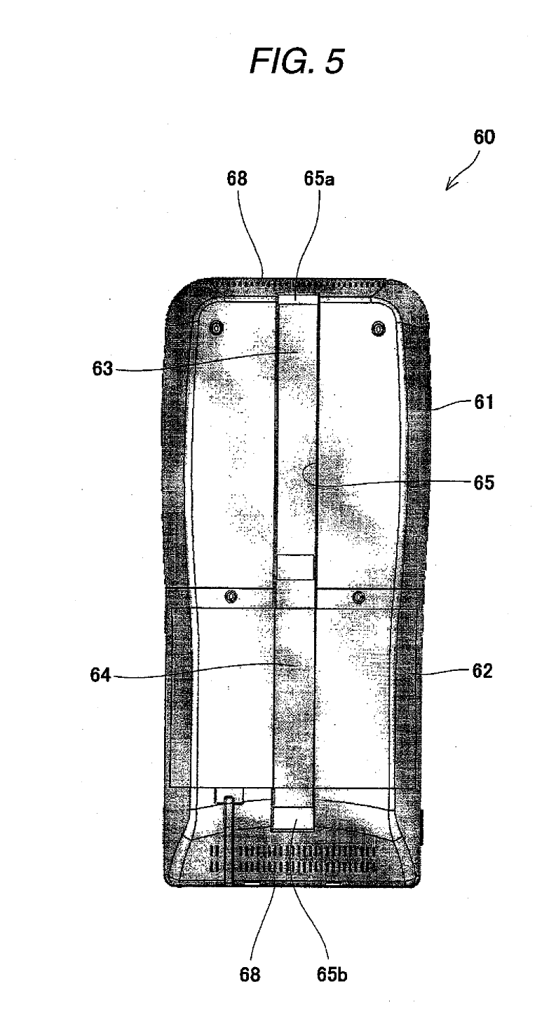

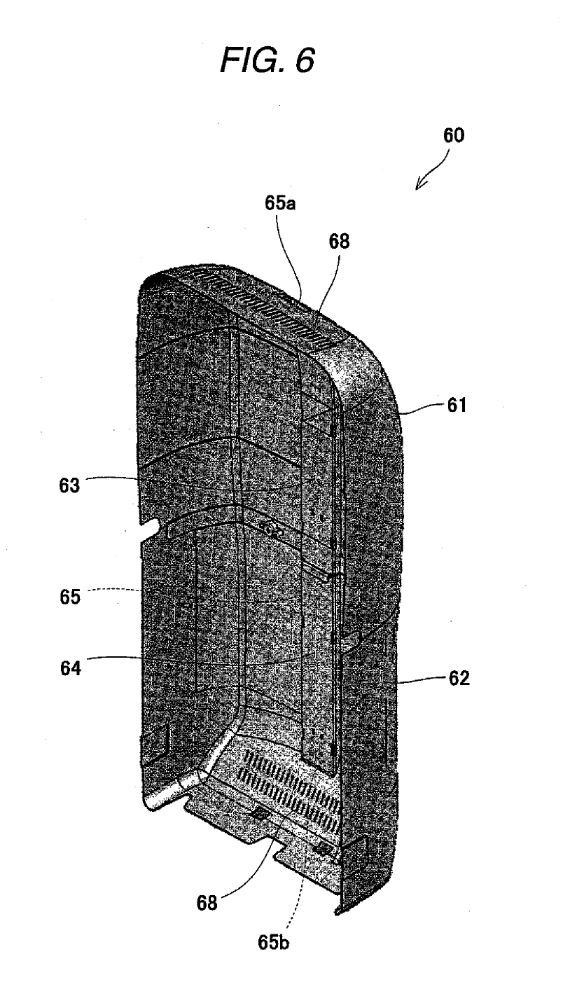

FIGS. 5 and 6 are views showing a back cover 60 provided on the back face of the backrest section (a state in which a cloth covering the outside is removed). This back cover 60 mainly includes an upper cover 61 disposed in the upper portion thereof, a lower cover 62 disposed in the lower portion of this upper cover 61, an upper duct 63 secured to the upper cover 61, and a lower duct 64 secured to the lower cover 62. The upper cover 61 and the lower cover 62 are connected to each other, whereby the back cover 60 is formed into a container shape as a whole. In addition, the upper cover 61 and the lower cover 62 are provided with ventilation holes 68. Since this back cover 60 is secured so that the back face side thereof is opposed to the rear face of the backrest section 3, the back face portion of the backrest section 3 has a shape expanding outward.

The upper duct 63 is formed into a rectangular cross-sectional shape extending in the up and down direction at the central portion of the upper cover 61 in the left and right direction thereof, and the lower duct 64 is formed into a rectangular cross-sectional shape extending in the up and down direction at the central portion of the lower cover 62 in the left and right direction thereof. In addition, the insides of both the duct 63 and 64 are hollow. Since the upper cover 61 and the lower cover 62 are connected to each other, the upper duct 63 and the lower duct 64 are also connected to each other, whereby a duct space 65 extending in the up and down direction is formed at the central portion of the back cover 60 in the left and right direction thereof. The upper end of the upper duct 63 is open, and the lower end of the lower duct 64 is open, whereby an upper opening 65a and a lower opening 65b are formed in the duct space 65.

While the above-mentioned back cover 60 is secured to the backrest section 3, plural pipes 66 for the pillow section 5 are passed through the duct space 65 (see FIG. 4). In FIG. 4, only one pipe 66 is shown. These pipes 66 are used to supply air to the respective air cells provides on the pillow section 5 and to exhaust air from the respective air cells. Pipes from an air supplying/exhausting apparatus 31, described later, provided in the seat section 1 are passed through the lower opening 65b, the duct space 65 and the upper opening 65a, further passed through a hole 67 formed in a cloth covering the back cover 60 and connected to the respective air cells of the pillow section 5. The pipes 66 having been passed through the hole 67 are covered with the upper apron 35. Since the plural pipes 66 introduced into the pillow section 5 are passed through the duct space 65 and the pipes 66 coming out from the duct space 65 are passed below the upper apron 35 as described above, the pipes 66 are not seen from the outside, whereby improvement can be attained in design.

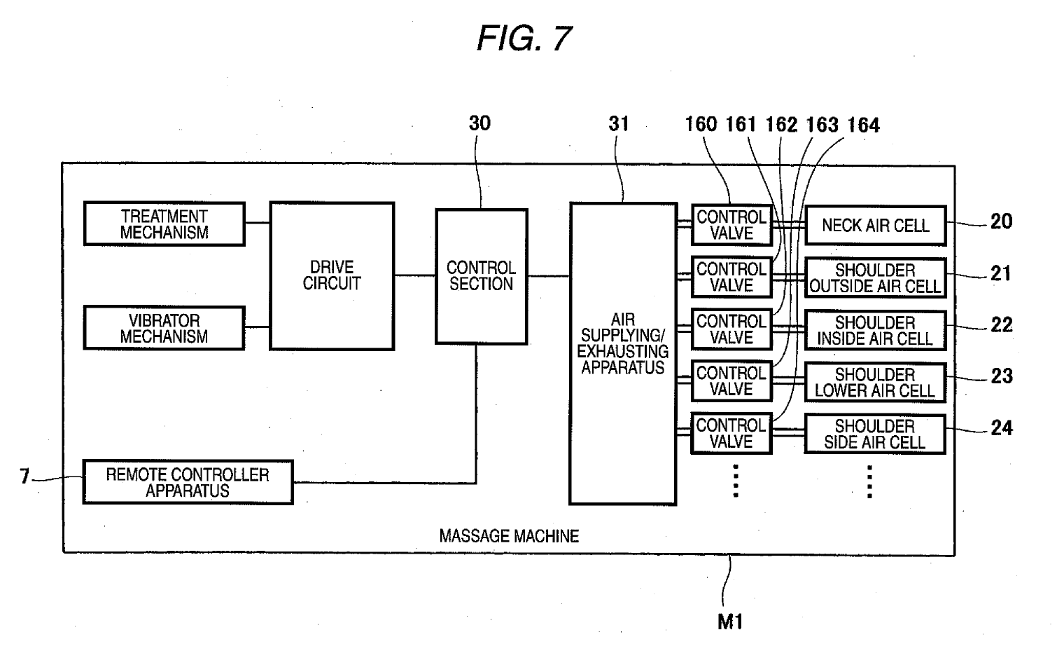

FIG. 7 is a block diagram showing the control system of the massage machine M1. A control section 30 for controlling the respective treatment devices is disposed below the seat section 1, includes a CPU, a ROM, a RAM, timers, etc. and executes various kinds of control programs, thereby being capable of controlling the treatment operations of the treatment unit and the air cells connected thereto.

To the control section 30, the air supplying/exhausting apparatus 31 is connected, whereby the operations of the air supplying/exhausting apparatus 31 are controlled. The air supplying/exhausting apparatus 31 includes changeover valves, such as solenoid valves, an air pump, etc. Furthermore, the air supplying/exhausting apparatus 31 is respectively connected via air hoses to a control valve 160 that is connected to the neck air cells 20 via air hoses, a control valve 161 that is connected to the shoulder outside air cells 21 via air hoses, a control valve 162 that is connected to the shoulder inside air cells 22 via air hoses, a control valve 163 that is connected to the shoulder lower air cells 23 via air hoses, and a control valve 164 that is connected to the shoulder side air cells 24 via air hoses. Hence, the air supplying/exhausting apparatus 31 can supply and exhaust air to/from the neck air cells 20, the shoulder outside air cells 21, the shoulder inside air cells 22, the shoulder lower air cells 23 and the shoulder side air cells 24 independently of one another.

In other words, the control section 30 can control the neck air cells 20, the shoulder outside air cells 21, the shoulder inside air cells 22, the shoulder lower air cells 23 and the shoulder side air cells 24 independently of one another, whereby the respective air cells 20, 21, 22, 23 and 24 can be expanded/contracted respectively individually. Hence, the massage machine M1 according to this embodiment can treat the shoulder portions and the neck portion of the user according to various treatment patterns, and the user can obtain a high treatment effect.

In addition, the treatment mechanism causing the massaging balls 8 to perform treatment operations, the vibrator mechanisms, etc. are connected to the control section 30 via a drive circuit, whereby the respective mechanisms are controlled. Furthermore, the remote control apparatus 7 for receiving operation instructions from the user is connected to the control section 30, whereby the user can instruct the massage machine M1 to operate. Moreover, control modes for operating the treatment mechanism and the respective air cells are prepared plurally so as to be able to perform various kinds of treatment modes, manual modes, etc.

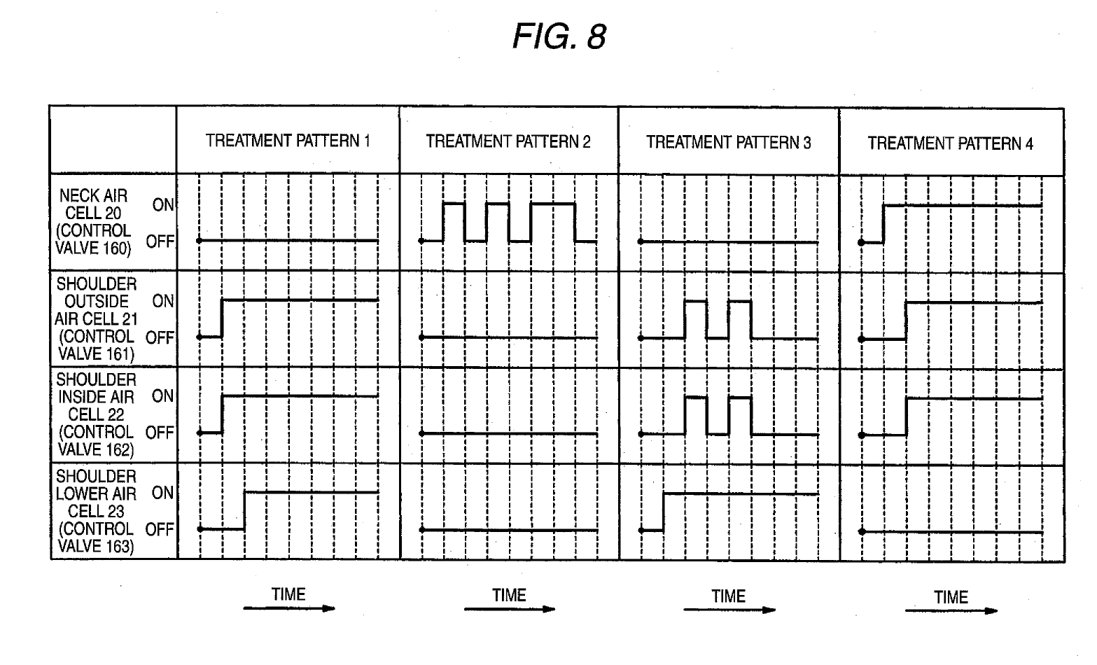

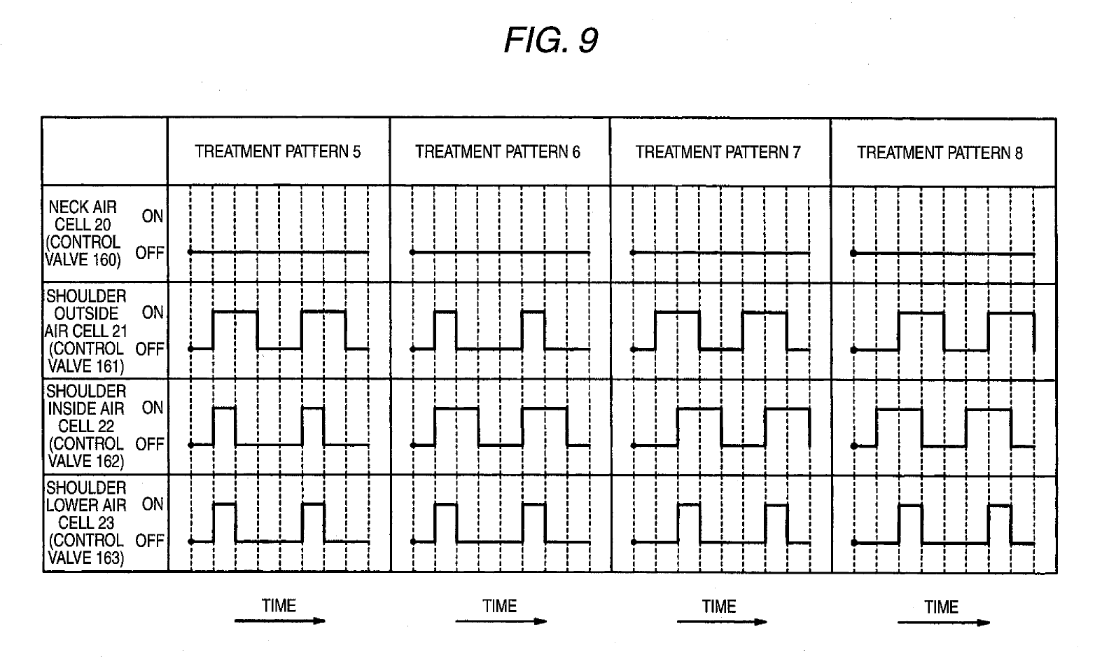

FIG. 8 shows treatment patterns 1 to 4 performed using the neck air cells 20, the shoulder outside air cells 21, the shoulder inside air cells 22 and the shoulder lower air cells 23 according to the on/off operations of the respective control valves 160, 161, 162 and 163, and FIG. 9 shows treatment patterns 5 to 8 performed using the same air cells 20, 21, 22 and 23 according to the on/off operations of the respective control valves 160, 161, 162 and 163. The horizontal axes in FIGS. 8 and 9 represent time zones in which the respective control valves 160, 161, 162 and 163 are turned on/off.

(Treatment Pattern 1)

The control section 30 expands the shoulder outside air cells 21 and the shoulder inside air cells 22 for a certain time and, while these remain expanded, the control section expands the shoulder lower air cells 23. With treatment pattern 1, the shoulder portions of the user are firmly grasped and rubbed, whereby the user can receive grasping and rubbing treatment.

(Treatment Pattern 2)

The control section 30 expands only the neck air cells 20 intermittently. In this case, the expansion time of the neck air cells 20 should only be changed rhythmically. With treatment pattern 2, the neck of the user is rubbed rhythmically, whereby the user can receive neck rubbing treatment.

(Treatment Pattern 3)

The control section 30 expands the shoulder lower air cells 23 for a certain time and, while these remain expanded, the control section expands the shoulder outside air cells 21 and the shoulder inside air cells 22 every certain time. With treatment pattern 3, the shoulder portions of the user are pressed from above while being pushed up from below, whereby the user can receive push-up rubbing treatment.

(Treatment Pattern 4)

The control section 30 expands the neck air cells 20 for a certain time and, while these remain expanded, the control section expands the shoulder outside air cells 21 and the shoulder inside air cells 22. With treatment pattern 4, the neck portion of the user is grasped and the shoulder portions are pushed down, whereby the user can receive push-down treatment. In addition, the neck is pulled in the up and down direction by the push-down treatment, and a neck stretching effect can also be provided.

(Treatment Pattern 5)

The control section 30 expands the shoulder outside air cells 21, the shoulder inside air cells 22 and the shoulder lower air cells 23 simultaneously for a certain time and then contracts, among them, the shoulder inside air cells 22 and the shoulder lower air cells 23. Finally, after a certain period, the control section contracts the shoulder outside air cells 21. The control section 30 repeats this control a predetermined number of times (FIG. 9 shows a treatment pattern in which this control is repeated twice). With treatment pattern 5, the shoulder portions of the user are smoothly rubbed from inside to outside, whereby the user can receive inside/outside rubbing treatment.

(Treatment Pattern 6)

The control section 30 expands the shoulder outside air cells 21, the shoulder inside air cells 22 and the shoulder lower air cells 23 simultaneously for a certain time and then contracts, among them, the shoulder outside air cells 21 and the shoulder lower air cells 23. Finally, after a certain period, the control section contracts the shoulder inside air cells 22. The control section 30 repeats this control a predetermined number of times (FIG. 9 shows a treatment pattern in which this control is repeated twice). With treatment pattern 6, the shoulder portions of the user are smoothly rubbed from the outside portions to the inside portions thereof, whereby the user can receive inside/outside rubbing treatment.

(Treatment Pattern 7)

The control section 30 expands the shoulder outside air cells 21 for a certain time and, while these remain expanded, the control section expands the shoulder inside air cells 22 and the shoulder lower air cells 23. Next, while only the shoulder inside air cells 22 remain expanded, the control section contracts the shoulder outside air cells 21 and the shoulder lower air cells 23. Finally, after a certain period, the control section contracts the shoulder inside air cells 22. The control section 30 repeats this control a predetermined number of times (FIG. 9 shows a treatment pattern in which this control is repeated twice). In other words, the control section 30 is configured so that the length of the time zone in which the shoulder outside air cells 21 are expanded is substantially the same as the time zone in which the shoulder inside air cells 22 are expanded, so that part of the time zone in which the shoulder outside air cells 21 are expanded first is overlapped with part of the time zone in which the shoulder inside air cells 22 are expanded later, and so that the shoulder lower air cells 23 are expanded when the expansion times of both the air cells 21 and 22 are overlapped. Expansion is herein defined as a state obtained in a period from the time when a treatment device begins to be expanded to the time when the expanded treatment device is contracted. With treatment pattern 7, the shoulder portions of the user are more smoothly rubbed from the outside portions to the inside portions than with treatment pattern 6, whereby the user can receive inside/outside double rubbing treatment.

(Treatment Pattern 8)

The control section 30 expands the shoulder inside air cells 22 for a certain time and, while these remain expanded, the control section expands the shoulder outside air cells 21 and the shoulder lower air cells 23. Next, while only the shoulder outside air cells 21 remain expanded, the control section contracts the shoulder inside air cells 22 and the shoulder lower air cells 23. Finally, after a certain period, the control section contracts the shoulder outside air cells 21. The control section 30 repeats this control a predetermined number of times (FIG. 9 shows a treatment pattern in which this control is repeated twice). In other words, the control section 30 is configured so that the length of the time zone in which the shoulder outside air cells 21 are expanded is substantially equal to the time zone in which the shoulder inside air cells 22 are expanded, so that part of the time zone in which the shoulder inside air cells 22 are expanded first is overlapped with part of the time zone in which the shoulder outside air cells 21 are expanded later, and so that the shoulder lower air cells 23 are expanded when the expansion times of both the air cells 21 and 22 are overlapped. Expansion is herein defined as a state obtained in a period from the time when a treatment device begins to be expanded to the time when the expanded treatment device is contracted. With treatment pattern 8, the shoulder portions of the user are more smoothly rubbed from the inside portions to the outside portions than with treatment pattern 5, whereby the user can receive inside/outside double rubbing treatment.

In the massage machine M1 according to this embodiment, since the neck air cells 20, the shoulder outside air cells 21, the shoulder inside air cells 22 and the shoulder lower air cells 23 can be controlled independently of one another, the above-mentioned treatment patterns 1 to 8 can be used, whereby various treatment operations can be performed and the user can obtain a high treatment effect. Furthermore, the treatment operations using the shoulder side air cells 24, etc. can be added as necessary to the treatment operations of the neck air cells 20, the shoulder outside air cells 21, the shoulder inside air cells 22 and the shoulder lower air cells 23, whereby a higher treatment effect can be obtained.

The above-mentioned treatment patterns are examples, and the control section 30 can cause the neck air cells 20, the shoulder outside air cells 21, the shoulder inside air cells 22 and the shoulder lower air cells 23 to perform treatment operations according to other treatment patterns as a matter of course. For example, the length of the expansion time and the length of the contraction time of each air cell in the above-mentioned treatment patterns 1 to 8 can be selected from among 2 seconds, 3 seconds, 4 seconds, . . . , 10 seconds, etc., for example, and the cycle times of the treatment patterns can be eliminated or extended. Furthermore, the strength of pressing the user may also be made different among the respective air cells by changing the strengths of the expansion of the respective air cells so as to be different from one another. Moreover, in the above-mentioned treatment patterns, although the air cells having the same name perform treatment operations for the same time period and with the same strength, the treatment operations may also be performed for time periods and with strengths being different between the left and right air cells according to the desire of the user.

Besides, the present invention is not limited to the above-mentioned respective embodiments. For example, it may also be possible that three or more shoulder air cells for treating the shoulder portions from above are disposed (the number of shoulder treatment portions is changed) and that these are controlled independently of one another so that the shoulder portions are further smoothly treated from outside to inside and from inside to outside. In addition, it may also be possible that each shoulder lower air cell 23 is divided into two pieces (the number of shoulder treatment portions is changed) and these pieces are controlled independently of each other so that softer treatment is performed for the rear side portions of the shoulder portions.

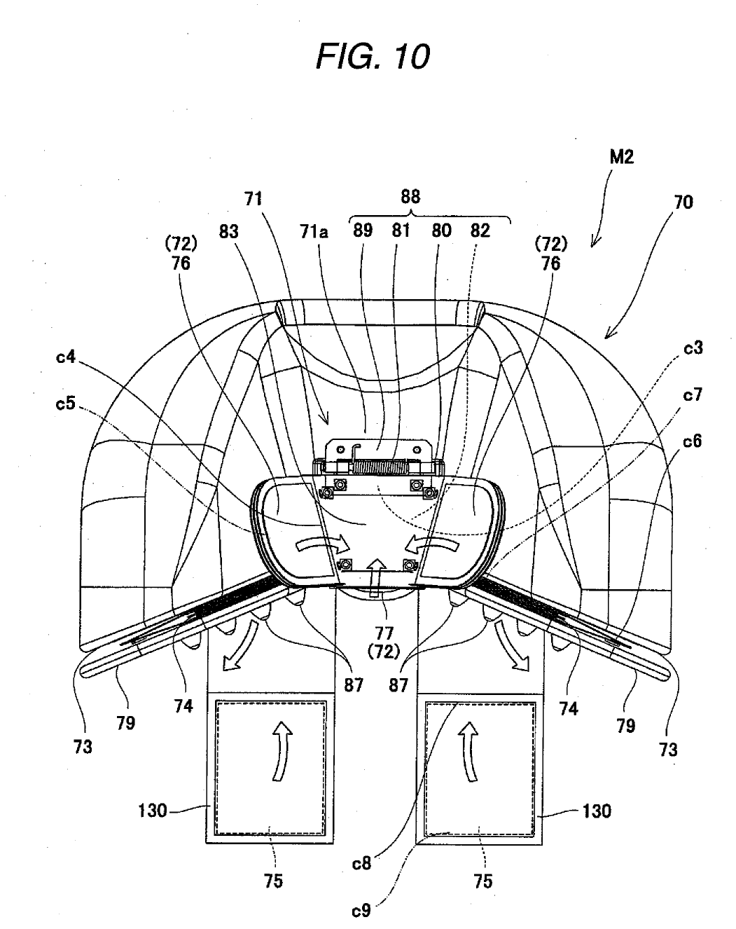

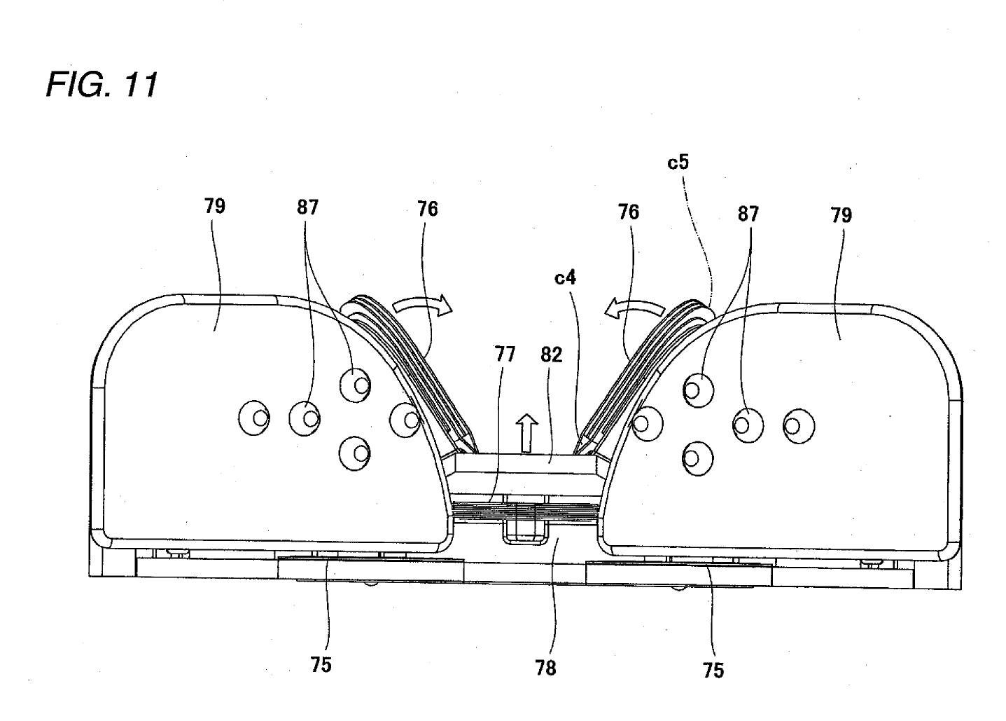

FIGS. 10 to 12 show a second embodiment of the massage machine according to the present invention. This embodiment is different from the above-mentioned first embodiment in that the respective treatment devices of the pillow section are changed. FIGS. 10 and 11 show a pillow main body 70 with the covering member thereof, etc. removed from the pillow section 5.

The pillow supporting portion 71 thereof is provided with a neck treatment device 72 at a position corresponding to the neck portion of the user to treat the neck portion. In addition, the main body bottom portions 73 thereof is provided with shoulder upper air cells 74 (shoulder upper treatment devices) for treating the shoulder portions of the user from above, and the lower side of the rear portion of the pillow main body 70 thereof is provided with shoulder lower air cells 75 (shoulder lower treatment devices) at positions corresponding to the rear side portions of the shoulder portions of the user to treat the these portions. Furthermore, the above-mentioned neck treatment device 72 includes neck holding air cells 76 (neck holding treatment devices), provided so as to correspond to portions near the left and right rear portions of the neck portion of the user, for treating the neck portion while holding the portion therebetween; and a neck pushing air cell 77 (neck pushing treatment device), provided so as to correspond to the rear side portion of the neck portion of the user, for treating the portion from behind and for pushing the neck holding air cells 76 toward the user.

A recessed bottom portion 71a being recessed in the pillow supporting portion 71 is provided with a hinge unit 88. This hinge unit 88 includes a hinge plate 89, a hinge pin 80, a torsion spring 81, a movable plate 82, etc., and the hinge plate 89 is secured to the recessed bottom portion 71a with screws. A neck plate 83 is secured to the movable plate 82 with screws. The rear side of the movable plate 82 is provided with the neck pushing air cell 77. The neck pushing air cell 77 is designed so as to be expanded while a cell upper side portion c3 is used as a rocking fulcrum. The rear side of the neck pushing air cell 77 is provided with a securing member 78 secured to the pillow main body 70. Hence, when the neck pushing air cell 77 is expanded, the movable plate 82 is pushed, and the neck plate 83 is moved toward the user. The neck plate 83 is made of resin or metal.

The neck holding air cells 76 and 76 are secured to both the left and right side portions of the neck plate 83. Both the air cells 76 and 76 are expanded while cell rear side portions c4 on side of the neck plate 83 are used as rocking fulcrums. Hence, when the neck pushing air cell 77 is expanded, the neck holding air cells 76 and 76 are moved forward. In this embodiment, although both the air cells 76 and 76 are expanded while the cell rear side portions c4 located at positions corresponding to the rear side portions near the left and right rear portions of the neck portion of the user are used as rocking fulcrums, the air cells may also be expanded while the cell front side portions c5 located at positions corresponding to the front side portions near the left and right rear portions of the neck portion of the user are used as rocking fulcrums. By virtue of the neck treatment device 72 configured as described above, the user is treated such that the rear portion of the neck portion of the user is pushed and such that portions near the left and right rear portions of the neck portion are sandwiched in the left and right direction.

Furthermore, as another mode of the neck treatment device, it may be possible that the neck holding air cells are secured to the pillow supporting portion and that the neck pushing air cell and the hinge unit and the neck plate provided on the front side of the neck pushing air cell are disposed independently of the neck holding air cells. In this case, the neck holding air cells are not moved even when the neck pushing air cell is expanded, whereby the neck pushing air cell can treat the neck portion of the user so as to push up the neck portion.

The shoulder upper air cells 74 disposed in the main body bottom portions 73 are designed so as to be expanded while cell outside portions c6 located at positions corresponding to the outside portions of the shoulder portions of the user are used as rocking fulcrums, whereby the inside portions of the shoulder portions of the user are treated stronger than the outside portions thereof using the shoulder upper air cells 74. However, the shoulder upper air cells 74 may be configured so as to be expanded while cell inside portions c7 located at positions corresponding to the inside portions of the user are used as rocking fulcrums. In this case, the outside portions of the shoulder portions of the user are treated stronger than the inside portions thereof using the shoulder upper air cells. Onto the front side of each of the shoulder upper air cells 74, a base plate 79 formed into a shape substantially the same as the shape of the main body bottom portion 73 is attached.

This base plate 79 is made of urethane so that each shoulder portion of the user is treated with a soft touch. Furthermore, on the front face of each base plate 79, five conical finger pressure devices 87 being rounded at the tip ends thereof are secured. These finger pressure devices 87 are disposed at positions corresponding to the portions ranging from the inside portion to the central portion of each of the shoulder portions of the user. Hence, a high finger pressure effect can be provided at the shoulder portions of the user. By virtue of the shoulder upper air cells 74, the user can receive treatment in which the shoulder portions are pushed from above.

The shoulder lower air cells 75 disposed on the lower side of the rear portion of the pillow main body 70 are formed into a substantially rectangular shape in front view and are designed so as to be expanded while cell upper side portions c8 located at positions corresponding to the upper side portions of the rear side portions of the shoulder portions of the user are used as rocking fulcrums. Hence, the user can receive treatment in which the rear side portions of the shoulders are pushed up. Furthermore, the surface of each of the shoulder lower air cells 75 on the side of the user is provided with a shoulder lower plate 130. This shoulder lower plate 130 is made of urethane so that each shoulder portion of the user is treated with a soft touch. Furthermore, the shoulder lower air cells 75 may be configured so as to be expanded while cell lower side portions c9 located at positions corresponding to the lower side portions of the rear side portions of the shoulder portions are used as rocking fulcrums. In this case, the user can receive treatment in which the rear side portions of the shoulder portions are pushed down.

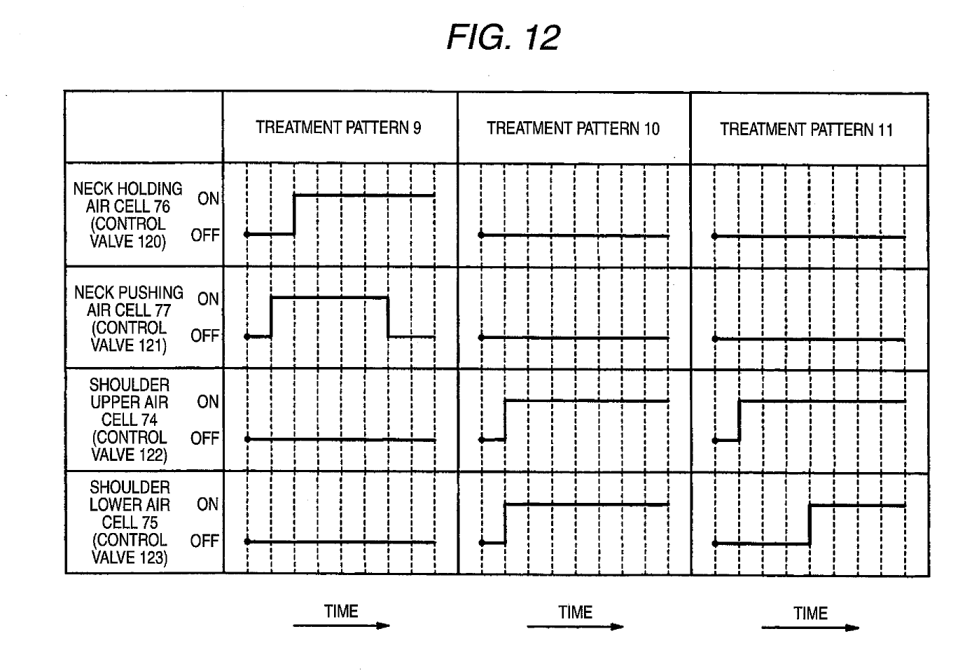

To the control section, an air supplying/exhausting apparatus is connected, whereby the operations of the air supplying/exhausting apparatus are controlled. The control system is not shown since it is substantially the same as that of the above-mentioned first embodiment. The air supplying/exhausting apparatus includes changeover valves, such as solenoid valves, an air pump, etc. Furthermore, the air supplying/exhausting apparatus is respectively connected via air hoses to a control valve 121 that is connected to the neck pushing air cell 77 via air hoses, a control valve 120 that is connected to both the neck holding air cells 76 via air hoses, a control valve 122 that is connected to both the shoulder upper air cells 74 via air hoses, and a control valve 123 that is connected to both the shoulder lower air cells 75 via air hoses (FIG. 12 shows the control valves corresponding to the respective air cells). Hence, the air supplying/exhausting apparatus can supply and exhaust air to/from the neck pushing air cell 77, both the neck holding air cells 76, both the shoulder upper air cells 74 and both the shoulder lower air cells 75 independently of one another.

In other words, the control section can control the neck pushing air cell 77, both the neck holding air cells 76, both the shoulder upper air cells 74 and both the shoulder lower air cells 75 independently of one another, whereby the respective air cells 77, 76, 74 and 75 can be expanded/contracted respectively individually. Hence, the massage machine M2 according to this embodiment can treat the neck portion and the shoulder portions of the user according to various treatment patterns, and the user can obtain a high treatment effect. Next, treatment patterns will be exemplified.

FIG. 12 shows treatment patterns 9 to 11 performed using the neck pushing air cell, both the neck holding air cells, the shoulder upper air cells and the shoulder lower air cells according to the on/off operations of the respective control valves. The horizontal axes in the figure represent time zones in which the respective control valves are turned on/off.

(Treatment Pattern 9)

The control section expands the neck pushing air cell 77 for a certain time and then, while this remains expanded, the control section expands both the neck holding air cells 76 for a certain time, and next, while both the neck holding air cells 76 remain expanded, the control section contracts the neck pushing air cell 77. With treatment pattern 9, the neck portion is sandwiched on both the left and right sides while the neck portion of the user is pushed from behind, and the neck portion is pulled while being sandwiched, whereby the user can receive treatment in which the neck portion is pushed, pulled and rubbed.

(Treatment Pattern 10)

The control section expands the shoulder upper air cells 74 and the shoulder lower air cells 75 simultaneously for a certain time. With treatment pattern 10, the user can receive treatment in which the shoulder portions are sandwiched and rubbed.

(Treatment Pattern 11)

The control section expands the shoulder upper air cells 74 for a certain time and, while these remain expanded, the control section expands the shoulder lower air cells 75. With treatment pattern 11, the shoulder portions of the user are pushed, and then the rear side portions of the shoulder portions are pushed, whereby the user can receive pushing down, sandwiching and rubbing treatment.

In the massage machine M2 according to this embodiment, since the neck pushing air cell 77, both the neck holding air cells 76, both the shoulder upper air cells 74 and both the shoulder lower air cells 75 can be controlled independently of one another, the above-mentioned treatment patterns 9 to 11 can be used for example, whereby various treatment operations can be performed and the user can obtain a high treatment effect.

The above-mentioned treatment patterns are examples, and the control section can cause the neck pushing air cell 77, both the neck holding air cells 76, the shoulder upper air cells 74 and the shoulder lower air cells 75 to perform treatment operations according to other treatment patterns as a matter of course. For example, the length of the expansion time and the length of the contraction time of each air cell in the above-mentioned treatment patterns can be selected from among 2 seconds, 3 seconds, 4 seconds, . . . , 10 seconds, etc., for example. Furthermore, the strength of pressing the user may be made different among the respective air cells by changing the strengths of the expansion of the respective air cells so as to be different from one another. Moreover, in the above-mentioned treatment patterns, although the air cells having the same name perform treatment operations for the same time period and with the same strength, the treatment operations may also be performed for time periods and with strengths being different between the left and right air cells according to the desire of the user.

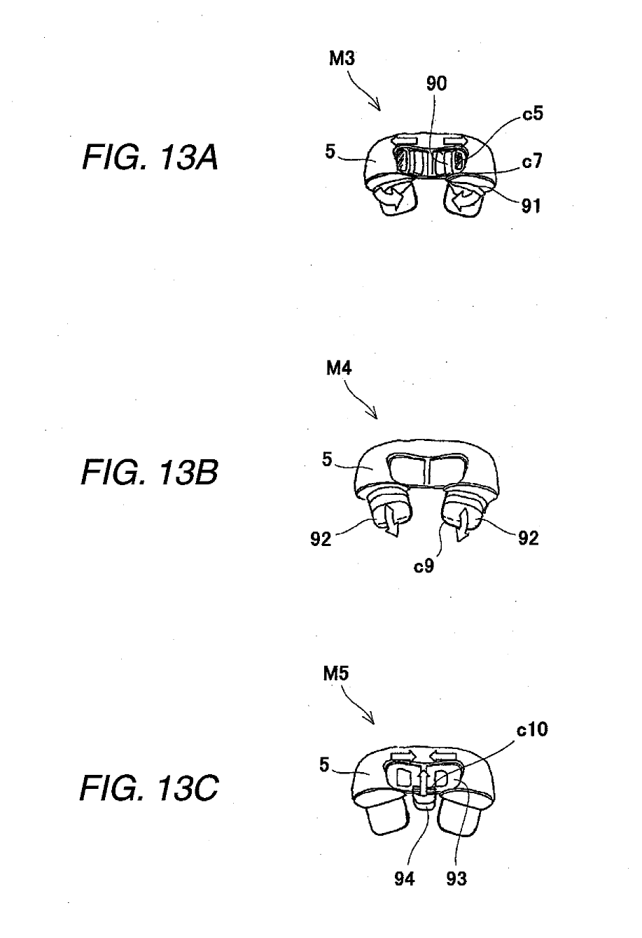

FIGS. 13 to 22 are views schematically showing massage machines according to other embodiments.

As in the case of a massage machine M3 according to a third embodiment shown in FIG. 13A, it may also be possible that neck holding air cells 90 are expanded while the cell front side portions c5 located at positions corresponding to the front side portions of portions near the left and right rear portions of the neck portion of the user are used as rocking fulcrums and that shoulder upper air cells 91 are expanded while the cell inside portions c7 located at positions corresponding to the inside portions of the shoulder portions of the user are used as rocking fulcrums. In this case, the neck portion is treated so as to be pressed (pushed out) from the rear inside to the front outside, and the shoulder (upper shoulder) portions are treated so as to be pressed (pushed down) from the upper outer side to the inner lower side.

As in the case of a massage machine M4 according to a fourth embodiment shown in FIG. 13B, it may also be possible that shoulder lower air cells 92 are expanded while the cell lower side portions c9 located at positions corresponding to the lower side portions of the rear side portions of the shoulder portions of the user are used as rocking fulcrums. In this case, the shoulder (lower shoulder) portions of the user are treated so as to be pressed (pushed down) from the rear upper side to the front lower side.

As in the case of a massage machine M5 according to a fifth embodiment shown in FIG. 13C, it may also be possible that a neck lower air cell 94 that is expanded while a cell upper side portion c10 is used as a rocking fulcrum is provided below neck holding air cells 93 to perform treatment so as to push up the neck portion of the user from below.

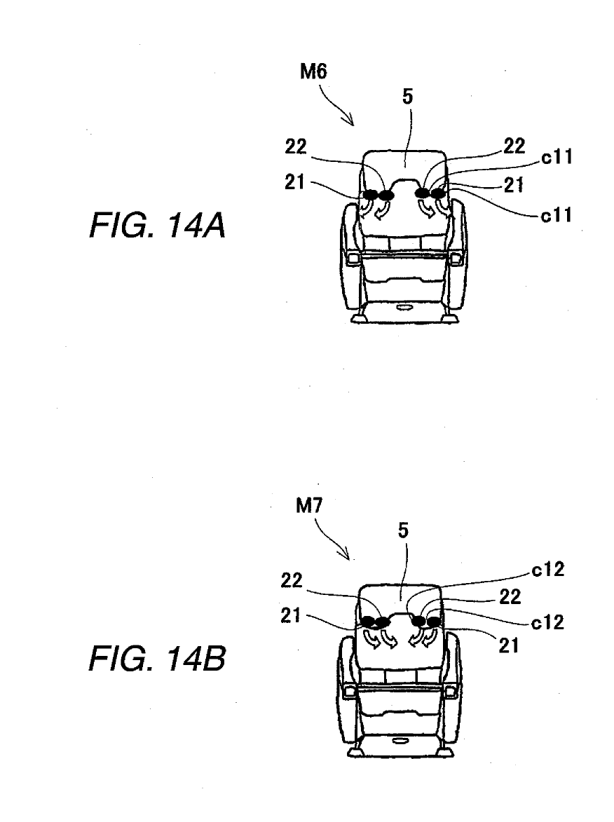

As in the case of a massage machine M6 according to a sixth embodiment shown in FIG. 14A, such treatment as that is performed using only the shoulder upper air cells included in the second embodiment may also be performed in a way such that the shoulder outside air cells 21, among the shoulder outside air cells 21 and the shoulder inside air cells 22 included in the massage machine according to the first embodiment, are expanded slightly and, at the same time, the shoulder inside air cells 22 are expanded more than the shoulder outside air cells 21. In the case of this embodiment, the inside portions of the shoulder portions of the user are pushed harder. Furthermore, it may also be possible that the shoulder outside air cells 21 and the shoulder inside air cells 22 are expanded while cell outside portions oil are used as rocking fulcrums as in the case of the second embodiment.

As in the case of a massage machine M7 according to a seventh embodiment shown in FIG. 14B, such treatment as that is performed using only the shoulder upper air cells included in the second embodiment may also be performed in a way such that the shoulder outside air cells 21, among the shoulder outside air cells 21 and the shoulder inside air cells 22 included in the massage machine according to the first embodiment, are expanded largely and, at the same time, the shoulder inside air cells 22 are expanded less than the shoulder outside air cells 21. In the case of this embodiment, the outside portions of the shoulder portions of the user are pushed harder. Furthermore, it may also be possible that the shoulder outside air cells 21 and the shoulder inside air cells 22 are expanded while cell inside portions c12 are used as rocking fulcrums as in the case of the third embodiment.

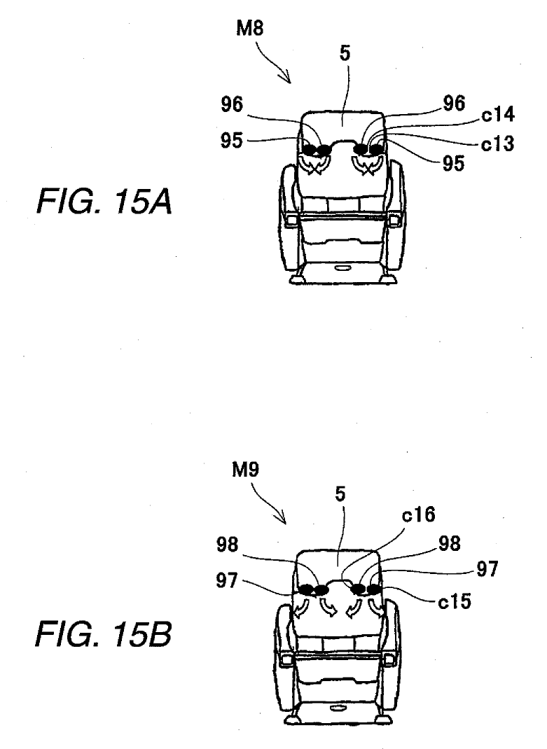

As in the case of a massage machine M8 according to an eighth embodiment shown in FIG. 15A, it is also possible to provide shoulder outside air cells 95 that are used to perform treatment from above at portions located at positions corresponding to the outsides of the shoulder portions of the user and are expanded while cell inside portions c13 are used as rocking fulcrums, and to provide shoulder inside air cells 96 that are used to perform treatment from above at portions located at positions corresponding to the inside portions of the shoulder portions of the user and are expanded while cell outside portions c14 are used as rocking fulcrums. In this case, one shoulder portion of the user is treated so as to be pushed from inside and outside.

As in the case of a massage machine M9 according to a ninth embodiment shown in FIG. 15B, it is also possible to provide shoulder outside air cells 97 that are used to perform treatment from above at portions located at positions corresponding to the outsides of the shoulder portions of the user and are expanded while cell outside portions c15 are used as rocking fulcrums, and to provide shoulder inside air cells 98 that are used to perform treatment from above at portions located at positions corresponding to the inside portions of the shoulder portions of the user and are expanded while cell inside portions c16 are used as rocking fulcrums. In this case, one shoulder portion of the user is treated so as to be pushed to inside and outside.

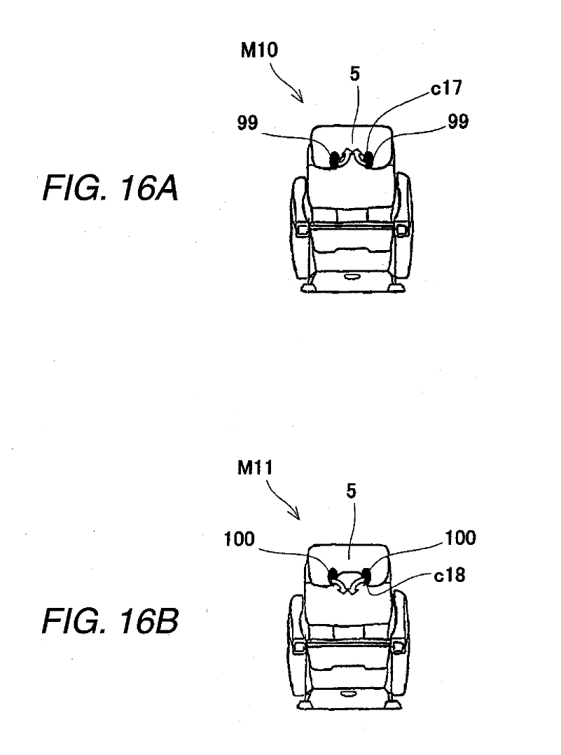

As in the case of a massage machine M10 according to a 10th embodiment shown in FIG. 16A, air cells 99 that are expanded while cell upper side portions c17 are used as rocking fulcrums may also be provided at both the side wall portions opposed to the pillow supporting portion of the pillow section 5 in the left and right direction. In this case, the sides of the neck portion of the user are treated so as to be pushed up.

As in the case of a massage machine M11 according to an 11th embodiment shown in FIG. 16B, air cells 100 that are expanded while cell lower side portions c18 are used as rocking fulcrums may also be provided at both the side wall portions opposed to the pillow supporting portion of the pillow section 5 in the left and right direction. In this case, the sides of the neck portion of the user are treated so as to be pushed down.

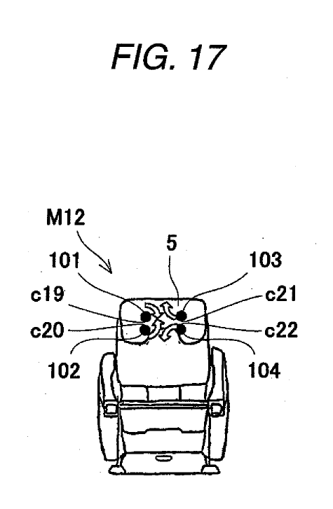

As in the case of a massage machine M12 according to a 12th embodiment shown in FIG. 17, two air cells may also be provided at each of both the side wall portions opposed to the pillow supporting portion of the pillow section 5 in the left and right direction. Among the air cells disposed at the left side portion, an air cell 101 on the upper side is expanded while a cell lower side portion c19 is used as a rocking fulcrum, and an air cell 102 disposed on the lower side is expanded while a cell upper side portion c20 is used as a rocking fulcrum. Among the air cells disposed at the right side portion, an air cell 103 on the upper side is expanded while a cell upper side portion c21 is used as a rocking fulcrum, and an air cell 104 disposed on the lower side is expanded while a cell lower side portion c22 is used as a rocking fulcrum. Furthermore, the neck portion can be treated according to various methods in various directions by appropriately combining the expansion directions of the air cells disposed at the left side portion, i.e., the air cell 101 disposed on the upper side and the air cell 102 disposed on the lower side, with the expansion directions of the air cells disposed at the right side portion, i.e., the air cell 103 disposed on the upper side and the air cell 104 disposed on the lower side.

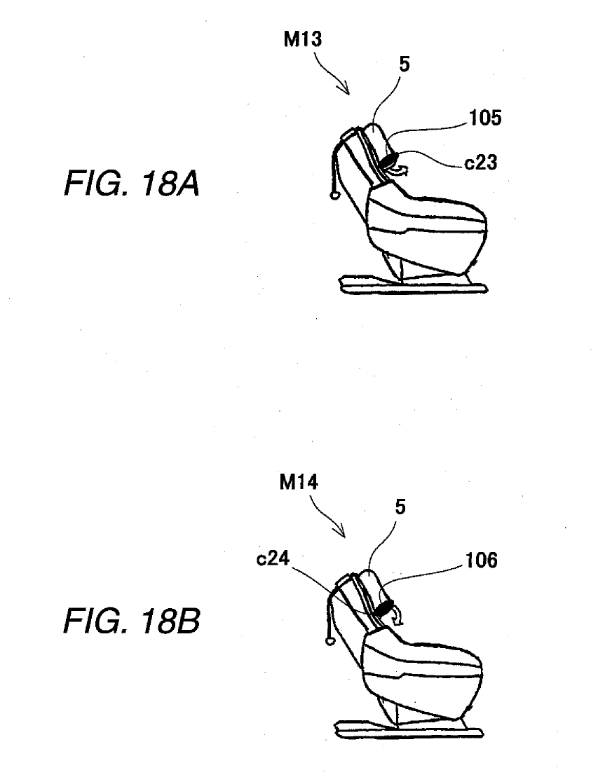

As in the case of a massage machine M13 according to a 13th embodiment shown in FIG. 18A, it may also be possible that shoulder upper air cells 105 included in the massage machine according to the second embodiment are configured so that cell front side portions c23 are used as rocking fulcrums. In this case, the rear side portions of the upper shoulder portions of the user are pushed harder. In this case, the shoulder (upper shoulder) portions of the user are treated so as to be pressed (pushed out) from the rear upper side to the front lower side.

As in the case of a massage machine M14 according to a 14th embodiment shown in FIG. 18B, it may also be possible that shoulder upper air cells 106 included in the massage machine according to the second embodiment are configured so that cell rear side portions c24 are used as rocking fulcrums. In this case, the front side portions of the upper shoulder portions of the user are pushed harder. In this case, the shoulder (upper shoulder) portions of the user are treated so as to be pressed (pushed) from the front upper side to the rear lower side.

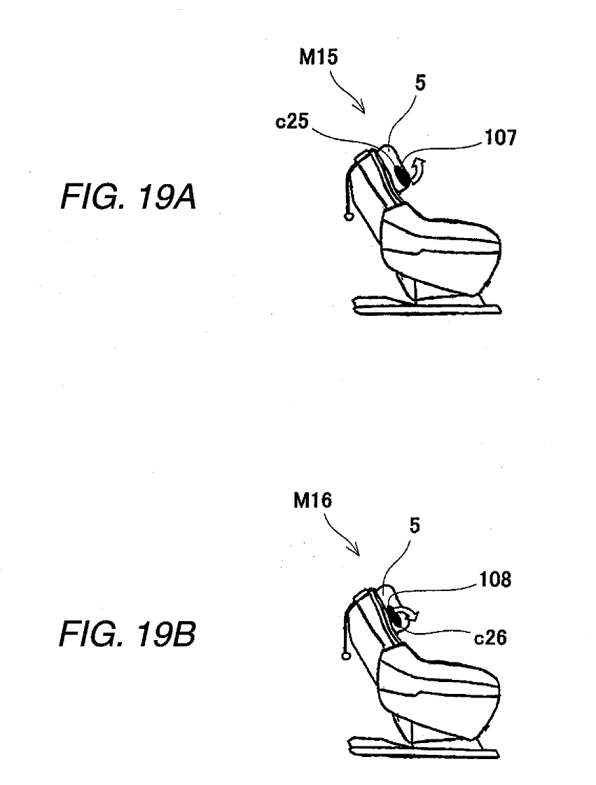

As in the case of a massage machine M15 according to a 15th embodiment shown in FIG. 19A, an air cell 107 that is expanded while a cell upper side portion c25 is used as a rocking fulcrum may also be disposed at the lower front side portion of the pillow supporting portion of the pillow section 5. In this case, the portions ranging from the neck to the rear portion of the head of the user are treated so as to be pressed (pushed up).

As in the case of a massage machine M16 according to a 16th embodiment shown in FIG. 19B, an air cell 108 that is expanded while a cell lower side portion c26 is used as a rocking fulcrum may also be disposed at the central portion of the pillow supporting portion of the pillow section 5. In this case, the portions ranging from the neck to the rear portion of the head of the user are treated so as to be pressed (pushed down).

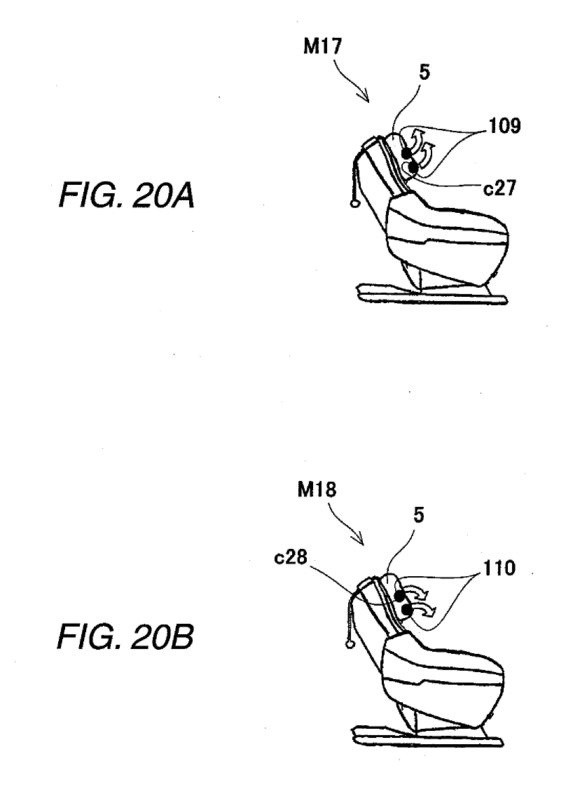

As in the case of a massage machine M17 according to a 17th embodiment shown in FIG. 20A, two air cells 109 that are expanded while a cell upper side portion c27 is used as a rocking fulcrum may also be disposed at the lower front side portion and the central front side portion of the pillow supporting portion of the pillow section 5. In this case, the portions ranging from the neck to the rear portion of the head of the user are treated so as to be pressed (pushed up).

As in the case of a massage machine M18 according to an 18th embodiment shown in FIG. 20B, two air cells 110 that are expanded while a cell lower side portion c28 is used as a rocking fulcrum may also be disposed at the lower front side portion and the central front side portion of the pillow supporting portion of the pillow section 5. In this case, the portions ranging from the neck to the rear portion of the head of the user are treated so as to be pressed (pushed down).

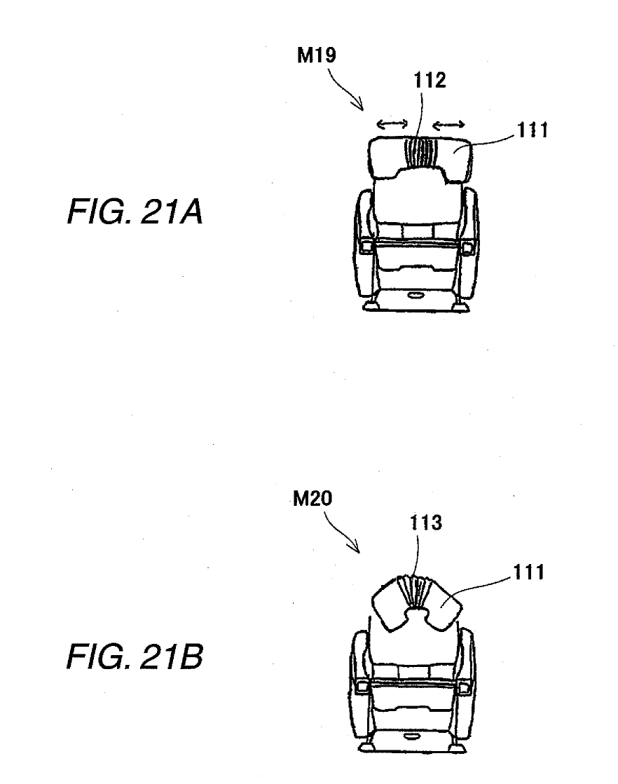

As in the case of a massage machine M19 according to a 19th embodiment shown in FIG. 21A, it may also be possible that a bellows portion 112 is provided at the central portion of a pillow section 111 in the left and right direction so that the pillow section is extended/contracted as desired in the left and right direction. In this case, the pillow section can be adjusted to match the shoulder width of the user, and the plural air cells disposed on the pillow section can perform treatment more suited for the physical size of the user. Furthermore, the user may manually align the width of the pillow section in the left and right direction with his or her shoulder width, or the alignment may also be performed automatically using a sensor or the like built in the massage machine.

As in the case of a massage machine M20 according to a 20th embodiment shown in FIG. 21B, it may also be possible that a bellows portion 113 is provided at the central portion of the pillow section 111 in the left and right direction so that the pillow section can be bent. In this case, the shoulder treatment faces of the pillow section can be tilted so as to be aligned along the shoulder portions of the user. In this case, the plural air cells disposed on the pillow section can perform treatment more suited for the tilted state of the shoulder portions of the user. Furthermore, the user may manually align the tilting angle of the pillow section with his or her shoulder portions, or the alignment may also be performed automatically using a sensor or the like built in the massage machine.

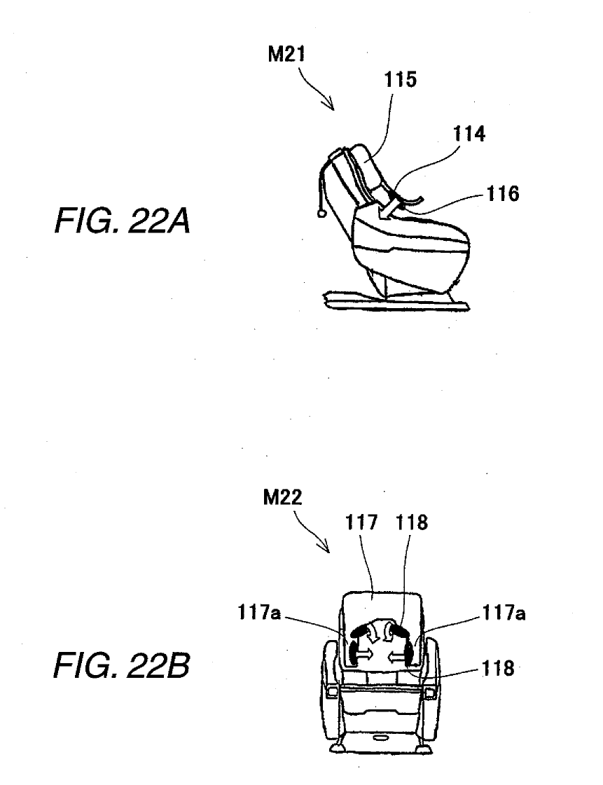

As in the case of a massage machine M21 according to a 21st embodiment shown in FIG. 22A, it may also be possible that a lower apron 114 is provided so as to be extended downward from the front side portion of a pillow section 115 and that an air cell 116, etc. are disposed on the back side portion (on the side of the user) of the extended portion. In this case, treatment can be performed such that the front side portion of the body of the user is stimulated using the air cell 116, etc.

As in the case of a massage machine M22 according to a 22nd embodiment shown in FIG. 22B, the side wall portions 117a of a pillow section 117 are extended downward to the outside portions of the arm portions of the user so that the side wall portions 117a make contact with the upper side portions of the shoulder portions and the outside portions of the shoulder portions of the user. In addition, air cells 118, etc. are disposed at positions of the side wall portions 117a making contact with the user. In this case, treatment can be performed such that the areas ranging from the upper side portions of the shoulder portions and the outside portions of the arm portions of the body of the user are stimulated using the air cells 118, etc.

Next, a chair-type massage machine according to a 23rd embodiment of the present invention will be described referring to the drawings.

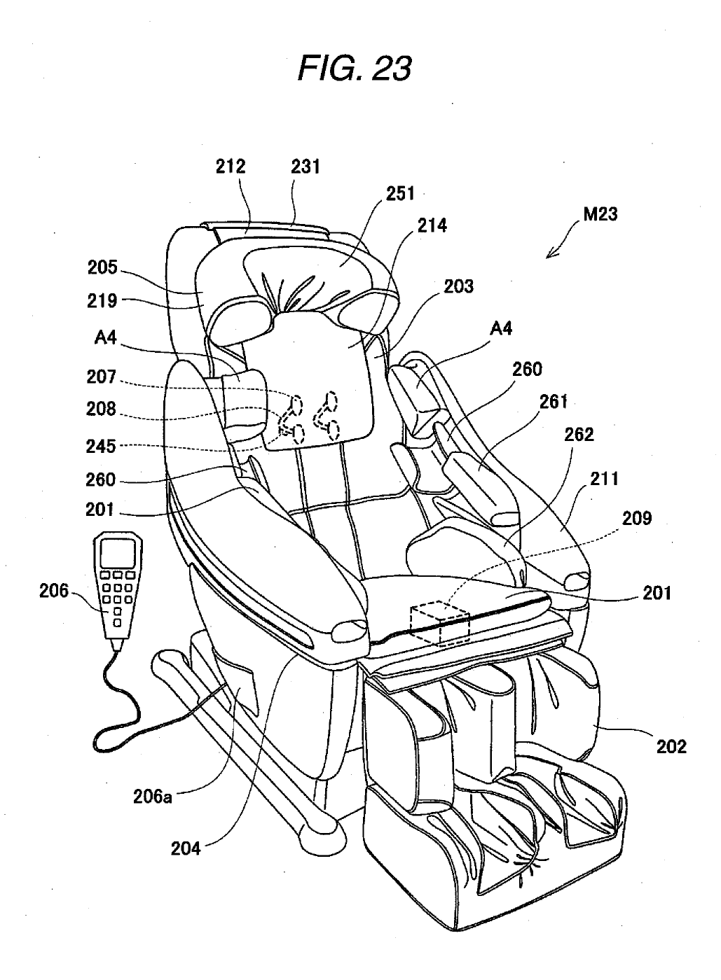

FIG. 23 is a perspective view showing a massage machine M23 according to the 23rd embodiment of the present invention, and this massage machine M23 is configured as a chair type. The massage machine M23 includes a seat section 201, a footrest section (footrest) 202, a backrest section 203, armrest sections 204 on both the left and right sides of the seat section 201, and a pillow section 205 provided on the front upper portion of the backrest section 203 so as to be movable up/down. In addition, the armrest sections 204 are each provided with an arm cover member 211 formed so as to cover each entire arm of the user. Furthermore, a remote control apparatus 206 is contained in the side pocket 206a of the seat section 201.

The footrest section 202 is installed forwardly of the seat section 201 so as to be turnable around a horizontal axis and can be moved using a lifting mechanism (not shown) from its moved-down state shown in FIG. 23 to its forward protruding and moved-up state. The backrest section 203 is turnably installed backwardly of the seat section 201 and can be moved using a reclining mechanism (not shown) from its standing state shown in FIG. 23 to a reclined state in which the section is tilted backward.

The inside of the backrest section 203 is provided with a treatment unit (not shown) equipped with two left and right sets of massaging balls 207 (first treatment device), each set being formed of one upper ball and one lower ball, to apply mechanical stimulation to the user. These upper and lower massaging balls 207 are provided on V-shaped arms 208. The left/right treatment unit is designed so as to be movable along a pair of left and right guide rails (not shown) being straight in the up and down direction (in the direction of the body length of the user) and provided inside the backrest section 203, thereby being movable inside the backrest section 203 in the up and down direction using a movement mechanism (not shown).

Furthermore, the movement mechanism can move the massaging balls 7 in the front and rear direction, and in this front and rear direction movement, the strength of the force in the direction can be changed. Moreover, the treatment unit is equipped with a treatment mechanism (not shown) capable of causing the massaging balls 207 to perform treatment operations, rubbing and pounding.

This treatment mechanism has, for rubbing, a motor and a rubbing mechanism section for causing the massaging balls 207 to perform rubbing using this motor, and has, for pounding, a motor and a pounding mechanism section for causing the massaging balls 207 to perform pounding using this motor, although these are not shown. The rubbing mechanism section causes the massaging balls 207 to perform periodic rotation, thereby to perform rubbing, and the pounding mechanism section causes the massaging balls 207 to perform periodic operation in the front and rear direction, thereby to perform pounding.

Furthermore, the massage machine is provided with air cells A (second treatment device) serving as treatment devices that are expanded/contracted by supplying/exhausting air. The air cells A are hereafter used as a general term to refer to neck air cells Al, shoulder upper air cells A2, shoulder lower air cells A3, shoulder side air cells A4, etc. described later. These air cells A are connected to an air unit that is provided below the seat section 201 and has an air pump, and the expansion of the air cells A using the air pump can perform treatment for the user. Vibrator mechanisms serving as treatment devices are provided in the seat section 201, the footrest section 202, the backrest section 203, etc., although these are not shown. The treatment unit is provided with a shoulder position sensor portion 245 (first detection portion) for detecting the shoulder position of the user. This shoulder position sensor portion 245 is configured as a rocking detection sensor for detecting the rocking of the arms 208 on which the massaging balls 207 are provided.

This rocking detection sensor is designed to detect that the arms 208 rock forward when the massaging balls 207 inside the backrest section 203 are moved, for example, from the lower back portion to the neck of the user in the height direction and when the upper massaging balls 7 reach the shoulder portions. The rocking detection sensor is formed of an optical sensor having a light-emitting element and a light-receiving element and detects that the arms 208 are located in a predetermined rocking range depending on whether the light-receiving element receives the light form the light-emitting element. The shoulder position is recognized using a detection signal from the rocking detection sensor at this time. Furthermore, a movement distance sensor (for example, a sensor having a hall IC or a rotary encoder) (not shown) fox detecting how much the massaging balls 207 have moved from the shoulder position (for example, how much the massaging balls have moved downward from the shoulder position).

It may also be possible that the shoulder position sensor portion is configured so as to serve as a conventionally known force sensor and that the force sensor is used to detect a reaction force generated from the user due to the force of the massaging balls 207 applied to push the user. Furthermore, instead of the above-mentioned rocking detection sensor, a limit switch can also be installed in the arms 208. This limit switch is changed over when the massaging balls 207 are moved, for example, from the neck to the lower back portion of the user in the height direction and when the massaging balls reach the shoulder portions, the arms 208 are rocked forward.

When the back side of the upper body of the user leaning against the backrest section 203 is treated, based on the detection result of the shoulder position sensor portion, the positions of pressure points can be obtained automatically so that the above-mentioned massaging balls 207 can be operated at the positions of pressure points of the user. Then, the pressure points can be stimulated by operating the massaging balls 207 at the positions of the pressure points on the body. The positions of the pressure points are obtained as described next.

The distribution of the positions of the pressure points varies among different individuals depending on physical form; however, even though there are differences in physical size, the positions of the pressure points on the upper body can be determined based on the positions of the thoracic spine, lumbar spine and sacral spine. Hence, after the positions of the thoracic spine, lumbar spine and sacral spine of the user are determined, the positions of the pressure points can also be determined accurately. Furthermore, since the positions of the thoracic spine, lumbar spine and sacral spine can be obtained by determining the shoulder position, the positions of the pressure points can be determined from the shoulder position detected using the rocking detection sensor.

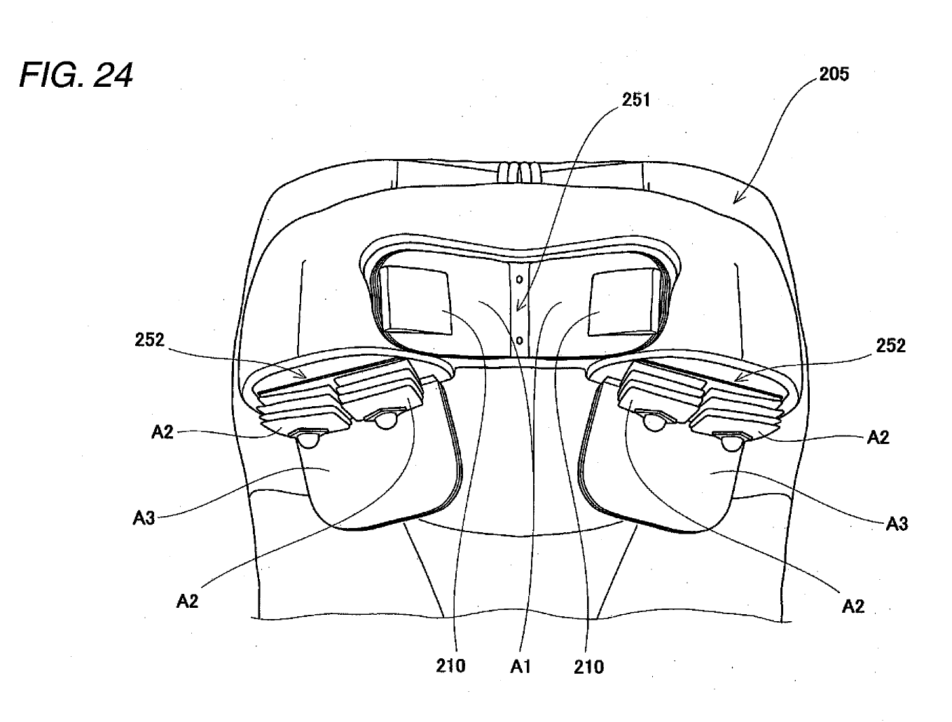

As shown in FIGS. 23 and 24, on the front face of the pillow section 205, a pillow supporting portion 251 is formed that is configured such that the head portion, shoulder portions and neck portion of the user are placed therealong. As shown in FIG. 24, the left/right inside portions of the pillow supporting portion 251 are provided with a left and right pair of neck air cells A1 (pillow treatment device) serving as a neck treatment device for treating the neck portion of the user.

The neck air cells A1 are each provided with a pad 210 having a high cushioning property. The neck portion of the user is included in the shoulder portions that are treated using the pillow treatment device according to the present invention. In addition, the bottom portions 252 of the pillow section 205 are provided with a left and right pair of shoulder upper air cells A2 (shoulder upper treatment devices; pillow treatment device) for treating the shoulder portions of the user from above. The shoulder upper air cells A2 are each formed of two air cells being driven independently of each other. Furthermore, the rear lower side portion of the pillow section 205 is provided with a left and right pair of shoulder lower air cells A3 (shoulder lower treatment devices ranging from the shoulder portions to the back portion; pillow treatment device) for treating the rear sides of the shoulder portions of the user.

Furthermore, as shown in FIG. 23, the inner upper portions of the arm cover members 211 are provided with shoulder side air cells A4 serving as shoulder side treatment devices for treating the areas around the shoulder portions from the sides at positions corresponding to the shoulder portions of the user. The above-mentioned respective air cells are all provided so as to be unable to be moved with respect to the pillow section 205 and the arm cover members 211. The inside portions of the arm cover members 211 are provided with holders 260 for grasping the arms and arm treatment devices 261 for treating the front portions of the arms, and both side portions of the seat section 201 are provided with leg treatment devices 262 for treating the thighs. The number of the air cells and the arrangement thereof are not limited to those according to this embodiment.

By virtue of the massaging balls 207 and the respective air cells configured as described above, the massage machine M23 according to this embodiment can treat the back portion and shoulder portions of the user. As a result, the massage machine M23 can provide treatment having a higher effect to the user.

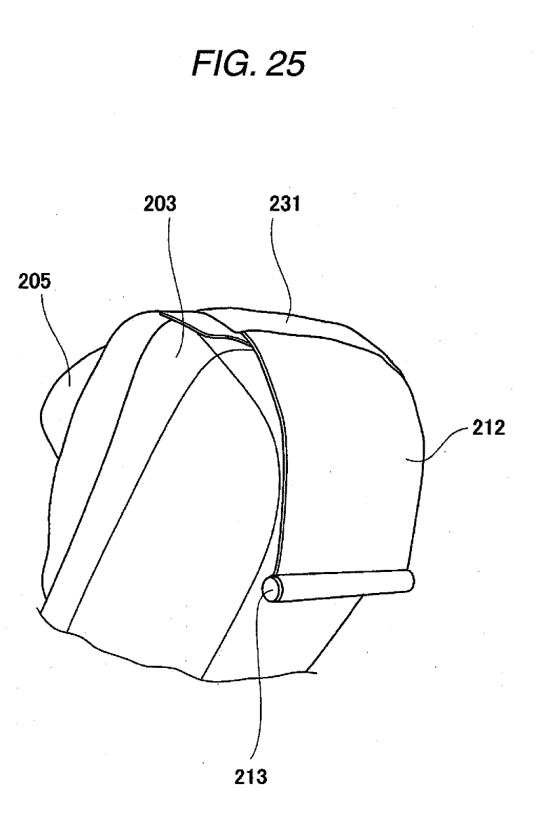

As shown in FIGS. 23 and 25, the back face upper fringe of the pillow section 205 is provided with a cloth-like upper apron 212 covered with the same material as that of the backrest section 203. This upper apron 212 extends from the position of the pillow section 205 beyond the upper face of the backrest section 203 to the back face of the backrest section 203. Furthermore, on the tip end of the upper apron 212, a weight 213 extending in the left and right direction is secured. The back face lower fringe of the pillow section 205 is provided with a cloth-like lower apron 214 covered with the same material as that of the backrest section 203. This lower apron 214 is placed on the front face of the backrest section 203 and is sandwiched between the user and the backrest section 203 when the user leans against the backrest section 203.

Moreover, as shown in FIG. 25, the upper face of the backrest section 203 is provided with an insertion portion 231 through which the upper apron 212 can be inserted in the front and rear direction. As the upper apron 212 is inserted through this insertion section 231, the tip end thereof hangs down in the vertical direction by virtue of the weight 213 (see FIG. 25). As a result, the pillow section 205 is in a state of being biased upward.

When the user wishes to lower the position of the pillow section 205, the user holds the pillow section 205 or the lower apron 214 and pulls it downward. At that time, if the user pulls the pillow section 205 obliquely while slightly lifting the pillow section 205 so that the pillow section 205 is set in a state of being spaced from the backrest section 203, the pillow section 205 can be lowered with a smaller force. In addition, since the lower apron 214 provided at the back face lower fringe of the pillow section 205 is sandwiched between the user and the backrest section 203 when the user leans against the backrest section 203, the position of the pillow section 205 having been lowered to a desired position can be secured and prevented from being displaced.

When the position of the pillow section 205 is desired to be raised and when the pillow section 205 is released from its secured or held state by lifting the pillow section 205, for example, the pillow section is moved upward by virtue of the biasing force of the weight 213. Furthermore, at that time, the user may pull the upper apron 212 or the weight 213 hanging down on the back face side of the backrest section 203. For example, if the user pulls the weight 213 while it is obliquely lifted, the pillow section 205 can be raised with a smaller force. With this simple configuration, the position of the pillow section 205 can be freely adjusted in the up and down direction.

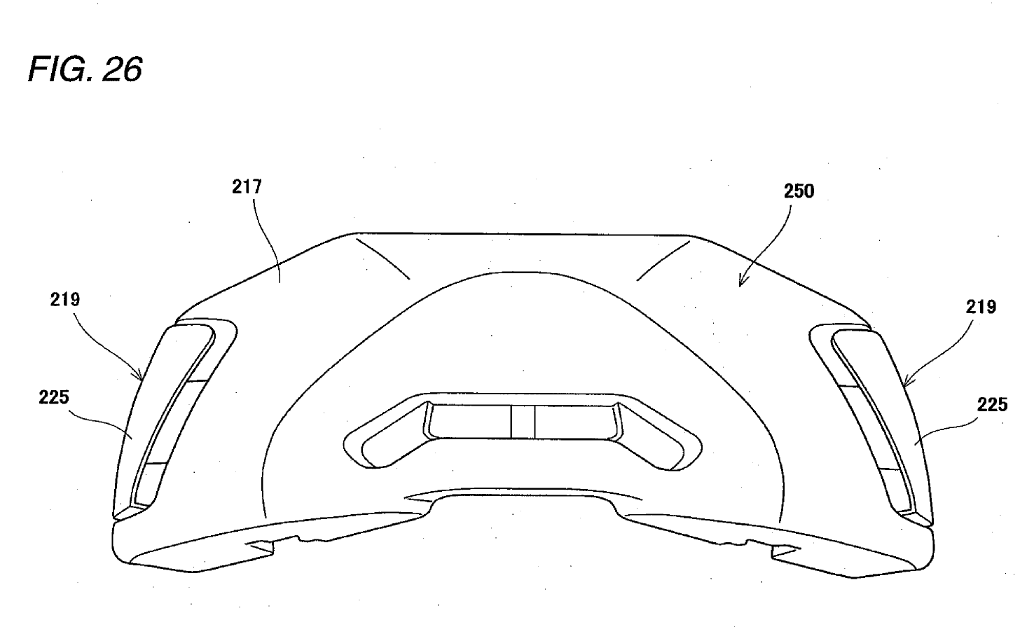

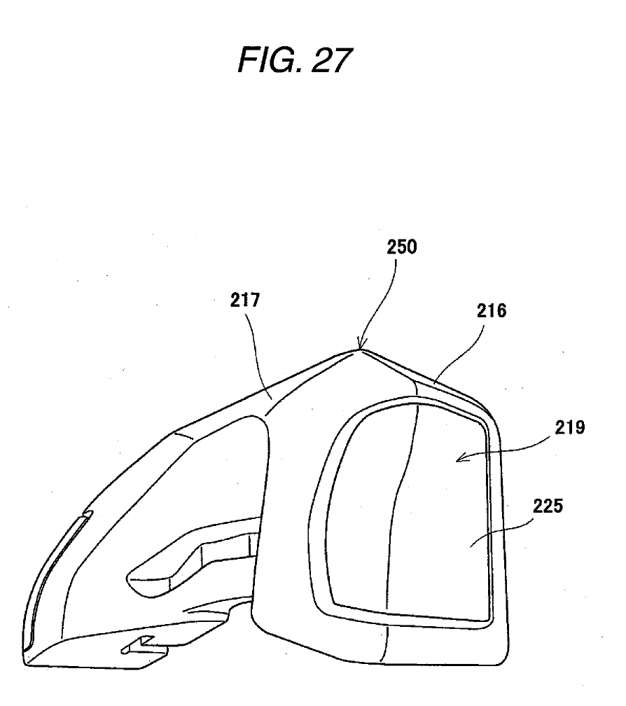

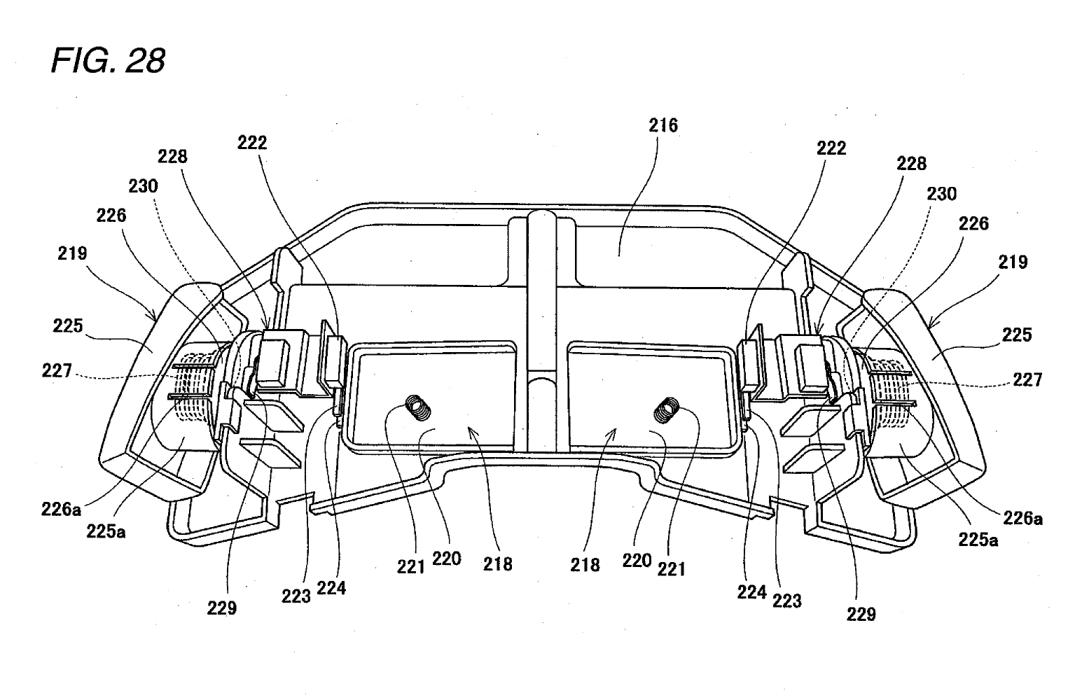

FIGS. 26 and 27 show a pillow main body 250 with a cover, treatment devices, etc. removed from the pillow section 205. As shown in the figures and FIG. 28, the pillow main body 250 includes a base portion 216 being long in the left and right direction, a front face member 217 secured to this base portion 216 with screws, a left and right pair of massaging ball sensor portions 218 (second detection portion) provided at the left and right outside portions of the base portion 216 and capable of being advanced/retracted to/from the head portion (left and right sides) of the user who is leaning, and air cell sensor portions 219 (third detection portion) provided at the left and right outside portions of the base portion 216 and capable of being advanced/retracted to/from the head portion of the user who is leaning.

Each massaging ball sensor portion 218 includes a substantially rectangular plate 220 fitted in a hollowed portion in the lower portion of the base portion 216, a spring 221 capable of advancing/retracting this plate 220, and a first limit switch 222 secured to the base portion 216 at the outside position of the plate 220. While the pillow section 205 is in a state of being installed on the backrest section 203, the left and right plates 220 are located at positions where the massaging balls 207 being moved up make contact therewith. The first limit switch 222 is equipped with a contact portion 223, and the outside end of the plate 220 is provided with an abutment portion 224 that makes contact with the contact portion 223. Furthermore, the base portion 216 is provided with a locking portion (not shown) for locking each plate 220 in a state of being biased toward the backrest section 203.

When the front face member 217 is installed on the base portion 216, the above-mentioned plate 220 is set in a state of being biased by the spring 221 toward the backrest section 203 and locked using the locking portion. When the plate 220 is pushed with the massaging balls 207 from the side of the backrest section, the abutment portion 224 of the plate 220 makes contact with the contact portion 223 of the first limit switch 222, and the first limit switch 222 detects this state. This signal is transmitted to a control section 209. In other words, when the first limit switch 222 is switched on/off, the state that the massaging balls 7 have reached the position of the pillow is detected.

Each air cell sensor portion 219 is equipped with an abutment member 225 positioned in both the outward directions of the base portion 216, a frame member 226 positioned in the inward direction of this abutment member 225, a spring 227 provided inside the frame member 226, and a second limit switch 228 secured to the base portion 216. In the inside portion of the abutment member 225, a cylindrical large-diameter portion 225a extending in the left and right direction is formed. In the outside portion of the frame member 226, a cylindrical small-diameter portion 226a is formed. The large-diameter portion 225a and the small-diameter portion 226a are fitted into each other with the spring 227 held therebetween.

Furthermore, the abutment member 225 is provided with a columnar portion (not shown) extending in the left and right direction and positioned on the inner circumferential side of the small-diameter portion 226a. The abutment member 225 is set in a state of being biased against the base portion 216 outward and locked using a locking portion (not shown). The second limit switch 228 is equipped with a contact portion 229 positioned in the vicinity of the inner end face of the above-mentioned columnar portion. When the abutment member 225 is pushed from the outside, the inner end face of the columnar portion makes contact with the contact portion 229 of the second limit switch 228, and the second limit switch 228 detects this state. This signal is transmitted to the control section 209.

When the pillow section 205 is installed on the backrest section 203 and the position of the pillow section 205 is adjusted in the up and down direction, the shoulder side air cells A4 disposed on the arm cover members 211 can make contact with the side portions of the pillow section 205. In other words, when the above-mentioned second limit switches 228 are switched on/off, the state that the shoulder side air cells A4 have made contact with the side portions of the pillow section 205 is detected.

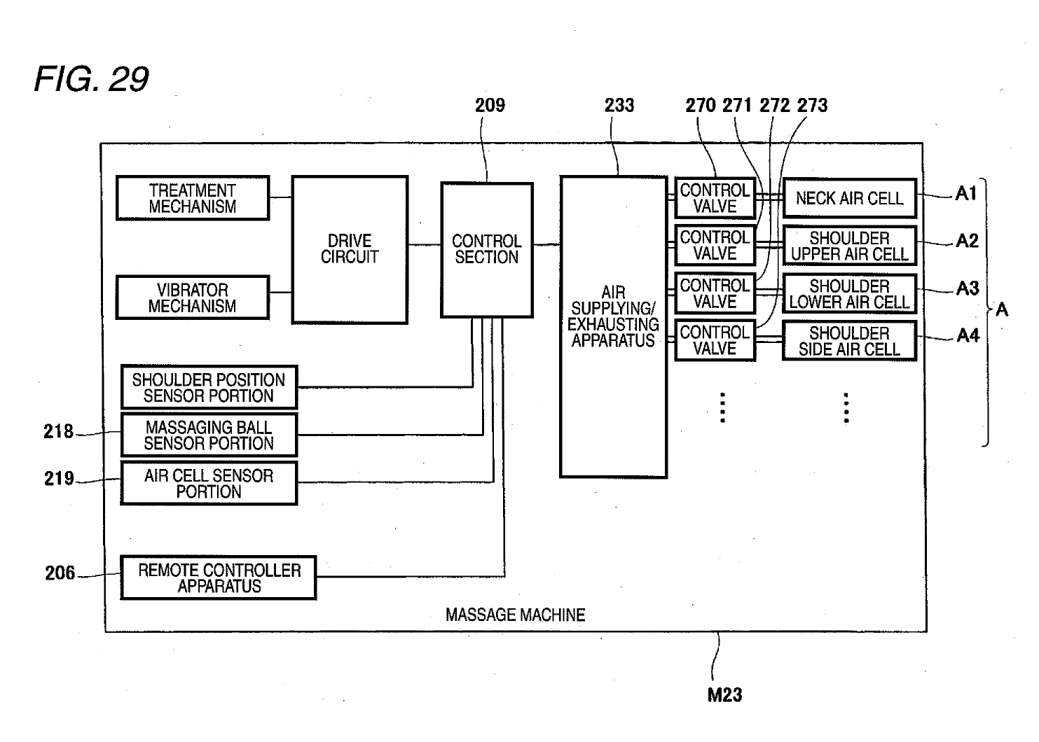

FIG. 29 is a block diagram showing the control system of the massage machine M23. The control section 209 is disposed below the seat section 201 (see FIG. 23), includes a CPU, a ROM, a RAM, timers, etc. and executes various kinds of control programs, thereby being capable of controlling the operations of the treatment units and the air cells connected thereto. To the control section 209, an air supplying/exhausting apparatus 233 is connected, whereby the operations of the air supplying/exhausting apparatus 233 are controlled.

The air supplying/exhausting apparatus 233 includes changeover valves, such as solenoid valves, an air pump, etc. Furthermore, the air supplying/exhausting apparatus 233 is respectively connected via air hoses to a control valve 270 that is connected to the neck air cells A1 via air hoses, a control valve 271 that is connected to the shoulder upper air cells A2 via air hoses, a control valve 272 that is connected to the shoulder lower air cells A3 via air hoses, and a control valve 273 that is connected to the shoulder side air cells A4 via air hoses. Hence, the air supplying/exhausting apparatus 233 can independently inhale and exhaust air to/from the respective air cells.

In addition, the treatment mechanism causing the massaging balls 207 to perform treatment operations, the vibrator mechanisms, etc. are connected to the control section 209 via a drive circuit, whereby the respective mechanisms are controlled. Furthermore, the shoulder position sensor portion, the massaging ball sensor portions 218 and the air cell sensor portions 219 are connected to the control section 209, and signals detected using these sensor portions are transmitted to the control section 209. Moreover, the remote control apparatus 206 for receiving operation instructions from the user is connected to the control section 209, whereby the user can instruct the massage machine M23 to operate. Control modes for operating the massaging mechanisms and the respective air cells are prepared plurally so as to be able to perform various kinds of treatment modes, manual modes, etc.

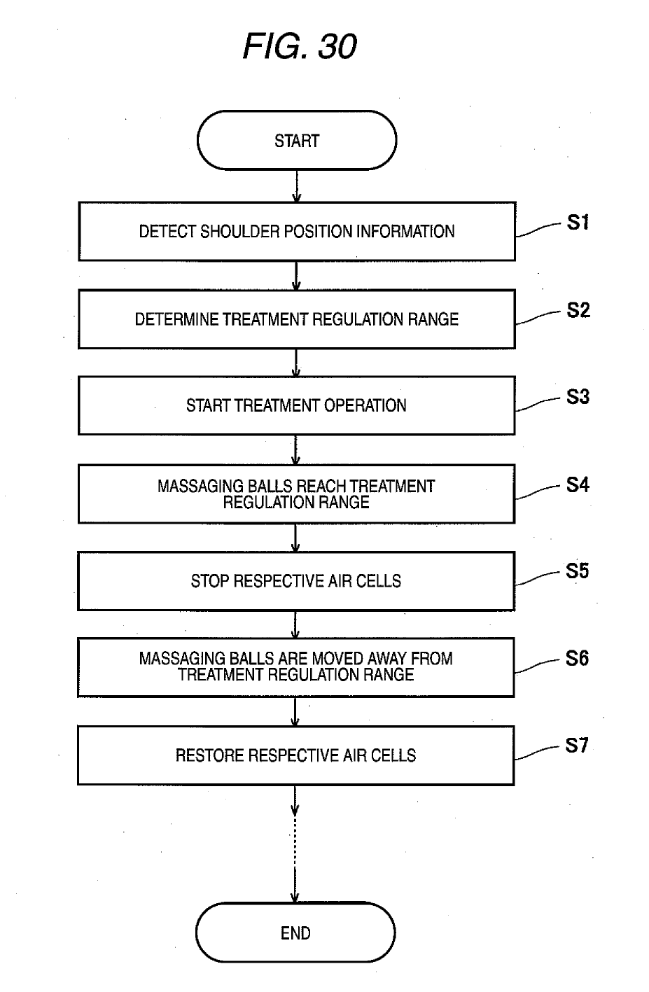

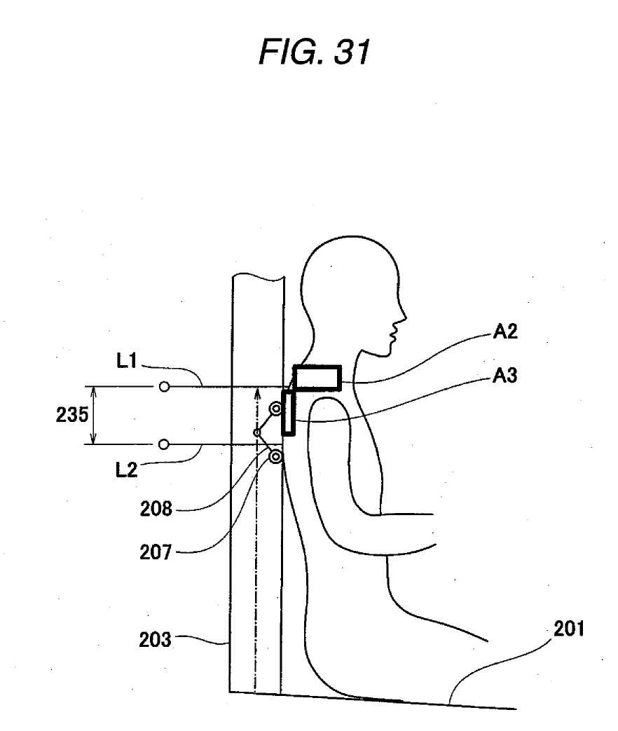

FIG. 30 is a flowchart showing the flow of the treatment operations of the massaging balls 207, the neck air cells A1, the shoulder upper air cells A2 and the shoulder lower air cells A3 in various kinds of treatment modes and manual modes, and FIG. 31 is a schematic view showing the positions of the shoulder upper air cell A2 and the shoulder lower air cell A3 and the operation of the massaging balls 207 while the user is in a state of sitting on the massage machine M23. When each mode is started, the shoulder position L1 of the user is first detected using the shoulder position sensor portion (at step 1). The shoulder position L1 is substantially the same as the shoulder position obtained when the user sits on the seat section 201 and the pillow section 205 is aligned with the shoulder portions of the user. Based on this detection result, the control section 209 sets a treatment regulation range 235 (at step 2).

The treatment regulation range 235 is a range in which one of treatment operations is selectively performed for the shoulder portions of the user using the neck air cells A1, the shoulder upper air cells A2 and the shoulder lower air cells A3 disposed on the pillow section 205 and the massaging balls 207 disposed on the backrest section 203. More specifically, in consideration of the vertical dimension of the shoulder lower air cell A3, approximately 100 mm, the treatment regulation range 235 is set in a range from the shoulder position L1 to a position (L2) that is located below the shoulder lower air cell A3 by 50 mm, that is, approximately 150 mm downward from the shoulder position L1.

When a treatment operation is started (at step 3), the massaging balls 7 are moved up from below and reach the treatment regulation range 235 (at step 4). In response to an arrival of the massaging balls 207 to the treatment regulation range 235, the control section 209 stops the neck air cells A1, the shoulder upper air cells A2 and the shoulder lower air cells A3 (at step 5).

At that time, the operation of the massaging balls 207 remains unchanged, and the massaging balls 207 are just moved up continuously to a predetermined position and then returned therefrom. The massaging balls 207 pass through the treatment regulation range 235 downward from above and are moved away from the treatment regulation range 235 (at step 6). After the massaging balls 207 are moved away from the treatment regulation range 235, the control section 209 restores the operations of the neck air cells A1, the shoulder upper air cells A2 and the shoulder lower air cells A3 (at step 7).

Then, the massaging balls 207 are moved up again and reach the treatment regulation range 235 (at step 4); in response to this, the above-mentioned steps 5 to 7 are repeated.

In other words, when the massaging balls 207 are located in the treatment regulation range 235, the control section 209 stops the neck air cells A1, the shoulder upper air cells A2 and the shoulder lower air cells A3; when the massaging balls 207 are moved away from the treatment regulation range 235, the control section 209 restores the neck air cells A1, the shoulder upper air cells A2 and the shoulder lower air cells A3.

According to this embodiment, the treatment operations using the massaging balls 207 (first treatment device) for treating the back portion and the air cells A (second treatment device) for treating the shoulder portions and the neck portion are controlled depending on the position of the pillow section, i.e., the shoulder position, and one of the treatment operations is selectively performed for the shoulder portions in the treatment regulation range 235, whereby the burden to the shoulder portions of the user can be relieved.

Furthermore, in the case that the user is small in stature, when the position of the pillow section 205 is adjusted, the pillow section 205 is lowered to the shoulder side air cells A4 disposed on the inner upper portions of the arm cover members 211 in some cases. If the shoulder side air cells A4 are operated continuously while this state is unchanged, the shoulder side air cells A4 just interfere with the pillow section 205 without treating the user. In this case, operating the shoulder side air cells A4 becomes wasteful, and the user suffers discomfort due to noise caused by the interference between the pillow section 205 and the shoulder side air cells A4.

The massage machine M23 according to the present invention is equipped with the air cell sensor portions 219 (third detection portion) on the side portions of the pillow section 205 as described above; when the shoulder side air cells A4 make contact with the air cell sensor portions 219, it is detected that the shoulder side air cells A4 have made contact with the side portions of the pillow section 205. At that time, the control section 209 stops the treatment operation of the shoulder side air cells A4 based on the detection result of the air cell sensor portions 219. Hence, operating the shoulder side air cells A4 does not become wasteful, and the pillow section 205 does not interfere with the shoulder side air cells A4, whereby the user is prevented from suffering discomfort.

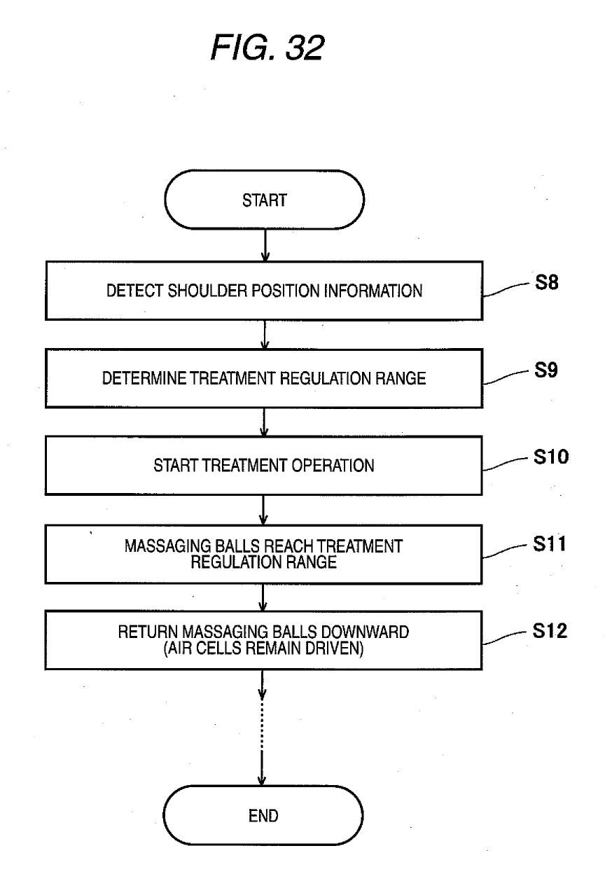

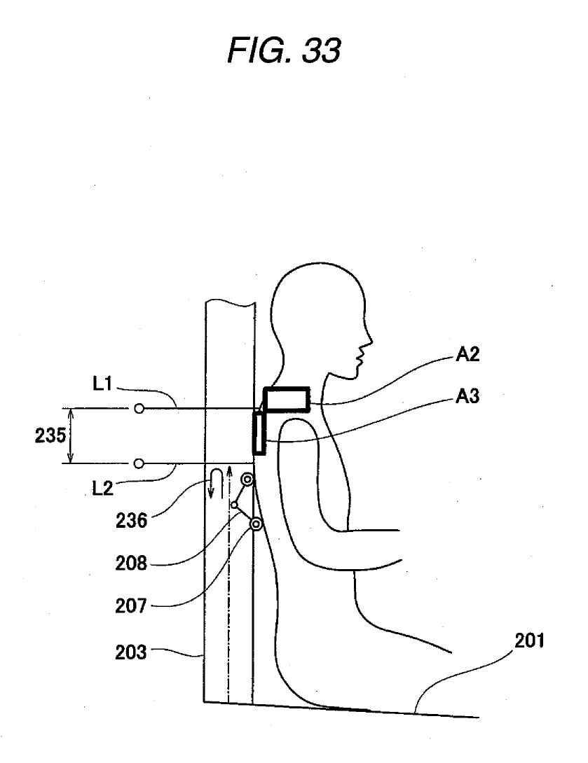

FIGS. 32 and 33 are views showing a 24th embodiment regarding the treatment operations of the massage machine M23. This embodiment is different from the above-mentioned 23rd embodiment in that the treatment operations of the massaging balls 207 and the respective air cells are changed in consideration of the relationship to the treatment regulation range 235.

When each mode is started, the shoulder position of the user is first detected using the shoulder position sensor portion (at step 8). Based on the result of this detection, the control section 209 determines the treatment regulation range 235 (at step 9). When the treatment operation is started (at step 10), the massaging balls 207 are moved up from below and reach the treatment regulation range 235 (at step 11). In response to an arrival of the massaging balls 207 to the lower limit L2 of the treatment regulation range 235, the control section 209 returns the massaging balls 207 downward as indicated by arrow 236 (at step 12).

Hence, the massaging balls 207 cannot enter the treatment regulation range 235. The control section 209 keeps causing the neck air cells A1, the shoulder upper air cells A2 and the shoulder lower air cells A3 to perform treatment operations. Then, the massaging balls 207 are moved up again and reach the treatment regulation range 235 (at step 11); in response to this, the above-mentioned step 212 is repeated. In other words, the control section 209 does not allow the massaging balls 207 to enter the treatment regulation range 235 while causing the neck air cells A1, the shoulder upper air cells A2 and the shoulder lower air cells A3 to operate at all times.

As described above, the treatment operations using the massaging balls 207 (first treatment device) for treating the back portion and the air cells A (second treatment device) for treating the shoulder portions and the neck portion are controlled depending on the position of the pillow section 205, i.e., the shoulder position L1, and one of the treatment operations is selectively performed for the shoulder portions in the treatment regulation range 235, whereby the burden to the shoulder portions of the user can be relieved.

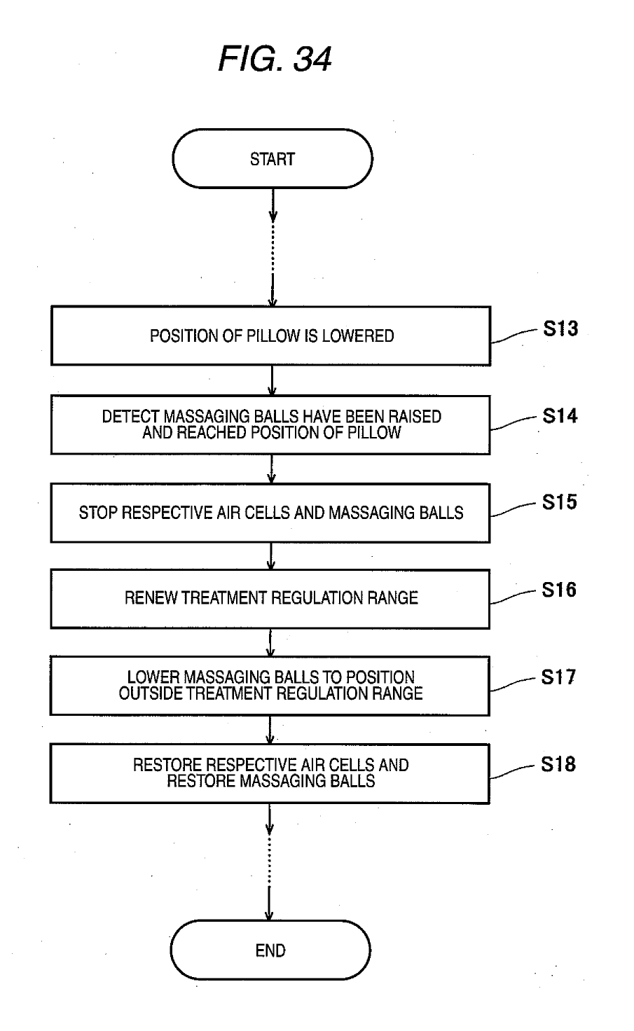

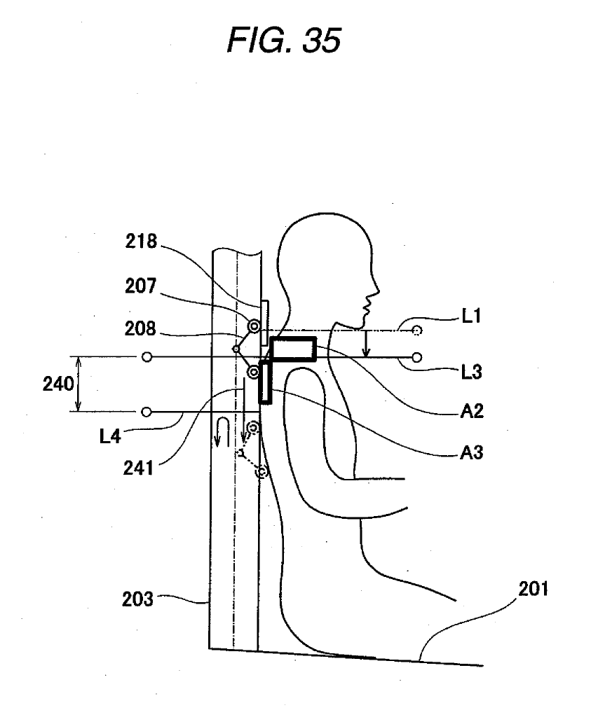

FIGS. 34 and 35 are views showing a 25th embodiment regarding the treatment operations of the massage machine M23. This embodiment is different from the above-mentioned 23rd embodiment and 24th embodiment in that, in the case that the shoulder position of the user is changed and the position of the pillow section 205 is adjusted, the treatment operations of the massaging balls 207 and the respective air cells are changed in consideration of the relationship to the treatment regulation range 235. In FIG. 35, only the shoulder upper air cells A2 are shown.

As in the cases of the 23rd and 24th embodiments, one of treatment operations using the massaging balls 207 and the respective air cells for treating the shoulder portions and the neck portion in the treatment regulation range 235 is selectively performed. However, after each mode is started and the treatment regulation range 235 is set once, if the backrest section 203 is reclined or the position of the body is displaced, the shoulder position is changed and the position of the pillow section 205 is lowered in some cases. In this case, the neck air cells A1, the shoulder upper air cells A2 and the shoulder lower air cells A3 disposed on the pillow section 205 are lowered from the initial positions thereof. At that time, the control section 209 receives signals transmitted from the above-mentioned massaging ball sensor portions 218 provided in the pillow section 205 and controls the massaging balls 207 and the respective air cells according to the following procedure.

As in the cases of the 23rd and 24th embodiments, the treatment regulation range 235 is set once depending on the shoulder position L1 and a treatment operation is performed. During the treatment operation, the position of the pillow section 205 is lowered by the user (at step 13). The massaging ball sensor portions 218 detect that the massaging balls 207 being raised have reached the position of the pillow section 205 (at step 14). The control section 209 stops the neck air cells A1, the shoulder upper air cells A2, the shoulder lower air cells A3 and the massaging balls 207 based on the result of the detection (at step 15).

As a result, when the position of the pillow section 205 is lowered, the burden to the shoulder portions of the user can be relieved. Furthermore, wasteful treatment operation of the massaging balls 207 is prevented, and the user is prevented from suffering discomfort due to interference noise caused when the massaging balls 207 push the pillow section 205.

Next, the control section 209 renews the treatment regulation range 235 and sets a new treatment regulation range 240 (at step 16). With respect to the setting of the treatment regulation range 240, a shoulder position L3 obtained after the pillow section 205 was lowered is calculated based on the detection result of the massaging ball sensor portions 218, and the new treatment regulation range 240 is set in a range from this shoulder position L3 to a position (L4) located downward approximately 150 mm therefrom.

At the same time, the control section 209 causes the massaging balls 207 to be lowered to the position of the lower limit L4 of the treatment regulation range 240 as indicated by arrow 241 (at step 17). The control section 209 lowers the massaging balls 207 to a position outside the treatment regulation range 240 and then restores the treatment operations of the neck air cells A1, the shoulder upper air cells A2, the shoulder lower air cells A3 and the massaging balls 207 (at step 18). In addition, after lowering the massaging balls 207 to L3, the control section 209 may restore the massaging balls 207 from the position (the respective air cells are in a stopped state). At that time, unless the control section 209 lowers the massaging balls 207 to L4, the neck air cells A1, the shoulder upper air cells A2 and the shoulder lower air cells A3 cannot be restored as a matter of course.

Subsequently, the control section 209 causes one of the treatment operations using the massaging balls 207, the neck air cells A1, the shoulder upper air cells A2 and the shoulder lower air cells A3 to be performed selectively in the new treatment regulation range 240 instead of the treatment regulation range 235 having been set previously. In other words, in the new treatment regulation range 240, for example, steps 4 to 7 in the above-mentioned first embodiment or steps 11 and 12 in the above-mentioned 24th embodiment should only be repeated. According to this embodiment, even if the position of the pillow section 205 is adjusted, the new treatment regulation range 240 is set, and one of the treatment operations using the massaging balls 207 and the respective air cells is performed selectively in the new treatment regulation range 240, the burden to the shoulder portions of the user can be relieved securely.

The embodiments disclosed above are all examples and do not impose any limitations. For example, the air cells serving as the second treatment device may also be disposed on the lower back portion and the back portion of the backrest section 203. More specifically, a treatment regulation range for the lower back portion and the back portion is preset, and the massaging balls are not allowed to enter the treatment regulation range while the air cells for the lower back portion and the back portion are driven. Or it may also be possible that, when the massaging balls have reached the treatment regulation range, the air cells for the lower back portion and the back portion are stopped and the massaging balls are allowed to keep performing treatment.

Next, a chair-type massage machine according to a 26th embodiment of the present invention will be described referring to the drawings.

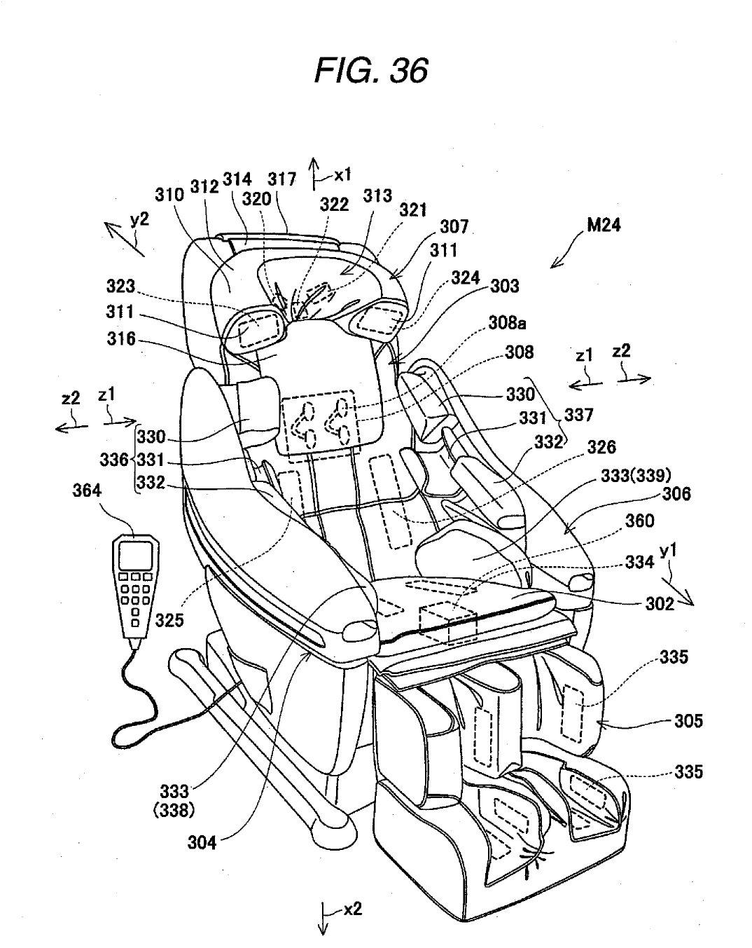

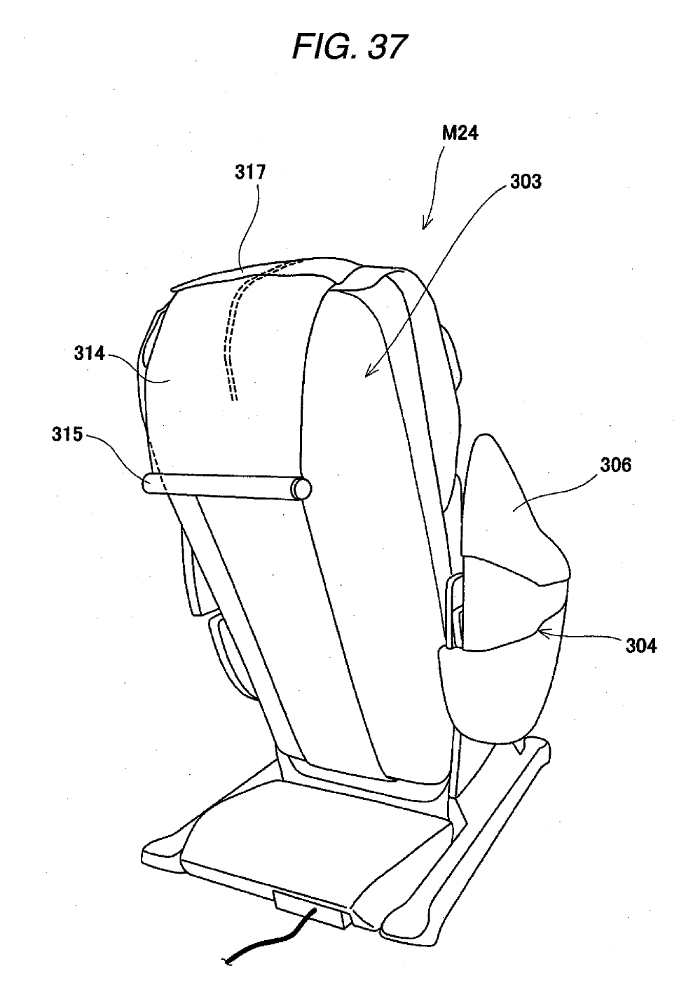

FIG. 36 is an overall perspective view showing the chair-type massage machine according to the 26th embodiment as seen from front, and FIG. 37 is an overall perspective view showing the chair-type massage machine shown in FIG. 36 as seen from behind. In this embodiment, an example is described in which the pillow section is configured so as to be separated from the backrest section, and the shoulder treatment portions and the neck treatment portion are provided on the pillow section. Furthermore, air cells are taken as examples of treatment devices provided on the shoulder treatment portions and the neck treatment portion. It is herein assumed that the concept of the directions used in the following description coincides with the concept of the directions as viewed from the user sitting on the seat section 2 as described above; it is determined that arrow x1 in the chair-type massage machine M24 shown in FIG. 36 indicates an upward direction, that arrow x2, reverse of arrow x1, indicates a downward direction, that arrow y1 indicates a forward direction, that arrow y2, reverse of arrow y1, indicates a backward direction, that arrow z1 pointing to the center of the chair-type massage machine M24 in the left and right direction indicates an inward direction, and that arrow z2, reverse of arrow z1, indicates an outward direction.

[Overall Configuration]

As shown in FIGS. 36 and 37, the chair-type massage machine M24 includes a seat section 302 on which the user sits, a backrest section 303 for supporting the upper body of the user from behind, armrest sections 304 (armrests) for supporting the arm portions of the user, and a footrest section (footrest) 305 for supporting the leg portions of the user. On the front upper portion of the backrest section 303, a pillow section 307 is provided as a separate member so that the position thereof can be freely adjusted in the up and down direction. In addition, the armrest sections 304 are each provided with an arm cover portion 306 formed so as to cover each of the entire arms of the user from the outside.

In order to support the upper body of the user, the above-mentioned backrest section 303 is designed to have a size to the extent that when an average-built adult sits on the chair-type massage machine M24, no part of the body of the adult protrudes from the outside thereof, and is formed into a vertically long and substantially rectangular shape in front view. Furthermore, above this backrest section 303, the above-mentioned pillow section 307 corresponding to the head portion of the user whose upper body is supported on the backrest section 303 is disposed. The backrest section 303 is turnably installed backwardly of the seat section 302 and can be tilted using a reclining mechanism (not shown) from its standing state shown in FIG. 36 to a reclined state in which the section is tilted backward. The inside of the backrest section 303 accommodates a mechanical massaging mechanism 308 having treatment devices 308a. This massaging mechanism 308 can reciprocate in the up and down direction of the backrest section 303 along a guide rail (not shown) extending in the up and down direction, thereby being capable of performing massage, such as rubbing, pounding and rolling, for the upper body of the user according to instructions from a control section 360. Both the side portions of the massaging mechanism 308 reciprocating in the up and down direction are provided with a back right air cell 325 (sixth air cell) and a back left air cell 326 (sixth air cell) serving as treatment devices for treating the back portion (the left and right portions of the back muscles) of the user leaning against the backrest section 303. The end portions of these back right and back left air cells 325 and 326 in the inward direction z1 serve as base end portions 325a and 326a that are not expanded at the time of air supply, and the end portions thereof in the outward direction z2 serve as expansion portions 325b and 326b that are expanded.

In addition, the above-mentioned footrest section 305 is installed forwardly of the seat section 302 so as to be turnable around a horizontal axis and can be moved using a lifting mechanism (not shown) from its moved-down state shown in FIG. 36 to its forward protruding moved-up state.

Furthermore, the above-mentioned arm cover portion 306 is formed into a shape so as to cover the arm portion of the user placed on the armrest section 304 in the range of the finger tips to the upper arm via the elbow. At the position corresponding to the outside of each shoulder portion of the user sitting on the seat section 302, the inside of the arm cover portion 306 is provided with a shoulder side air cell 330 for treating the area around the shoulder portion from the side, a holding air cell 331 for grasping the upper arm of the user, and an arm air cell 332 for treating the upper arm. In the following description, the shoulder side air cell 330, the holding air cell 331 and the arm air cell 332 provided inside the right arm cover portion 306 are collectively referred to as an arm right air cell 336 (fourth air cell), and the shoulder side air cell 330, the holding air cell 331 and the arm air cell 332 provided inside the left arm cover portion 306 are collectively referred to as an arm left air cell 337 (fourth air cell). Moreover, both the side portions of the seat section 302 are provided with leg air cells 333 for treating the thighs. In the following description, the leg air cell 333 provided on the right side of the seat section 302 is referred to as a leg right air cell 338 (fifth air cell), and the leg air cell 333 provided on the left side is referred to as a leg left air cell 339 (fifth air cell). Additionally, in the chair-type massage machine M24, the seat section 302 and the footrest section 305 are also provided with air cells 334 and 335 serving as treatment devices.

These air cells 330 to 335 are connected to an air unit having an air pump (not shown) provided below the seat section 302 and can perform pressure treatment for the user by virtue of the expansion of the air cells using the air pump. The above-mentioned configuration in which the air cells are provided is taken as an example, and the number of the air cells and the arrangement thereof are not limit to those according to this embodiment.

On the other hand, the above-mentioned pillow section 307 is covered with a covering member 310 and is, as a whole, long in the left and right direction and becoming wider downward in front view. The pillow section 307 has a left and right pair of shoulder treatment faces 311, which are formed into a flat shape and the back faces of which are formed along the front face of the backrest section 303, and which are also formed along both the shoulders of the user; a front face 312 formed so as to protrude forward; and a supporting portion 313 for supporting the rear portion of the head and the neck portion of the user. The shoulder treatment faces 311 extend from inside to outside and are inclined inward and upward along the shoulder portions of the user. The supporting portion 313 has a high cushioning property and is formed so as to be dented toward the lower central portion thereof. With the pillow section 307 formed as described above, the user places his or her head portion and neck portion on the supporting portion 313 and can receive treatment in a relaxed posture.

Furthermore, the back face upper fringe of the pillow section 307 is provided with a cloth-like upper apron 314, and this upper apron 314 extends from the position of the pillow section 307, passes through the insertion portion 317 of the backrest section 303 and hangs down on the rear side of the backrest section 303. To the rear end portion of the upper apron 314, a weight 315 extending in the left and right direction is secured. The back face lower fringe of the pillow section 307 is provided with a cloth-like lower apron 316, and this lower apron 316 hangs down on the front side of the backrest section 303.

When the user wishes to lower the position of the pillow section 307, the user holds the pillow section 307 or the lower apron 316 and pulls it downward. In the pillow section 307, since the lower apron 316 provided at the back face lower fringe of the pillow section 307 is sandwiched between the user and the backrest section 303 when the user leans against the backrest section 303, the position of the pillow section 307 having been lowered to a desired position can be secured and prevented from being displaced. When the position of the pillow section 307 is desired to be raised and when the pillow section 307 is moved away from the backrest section 303 by lifting the pillow section 307, for example, the pillow section is moved upward by virtue of the weight of the weight 315. With this configuration, the position of the pillow section 307 can be adjusted in the up and down direction.

[Configurations of Shoulder/Neck Treatment Portions]

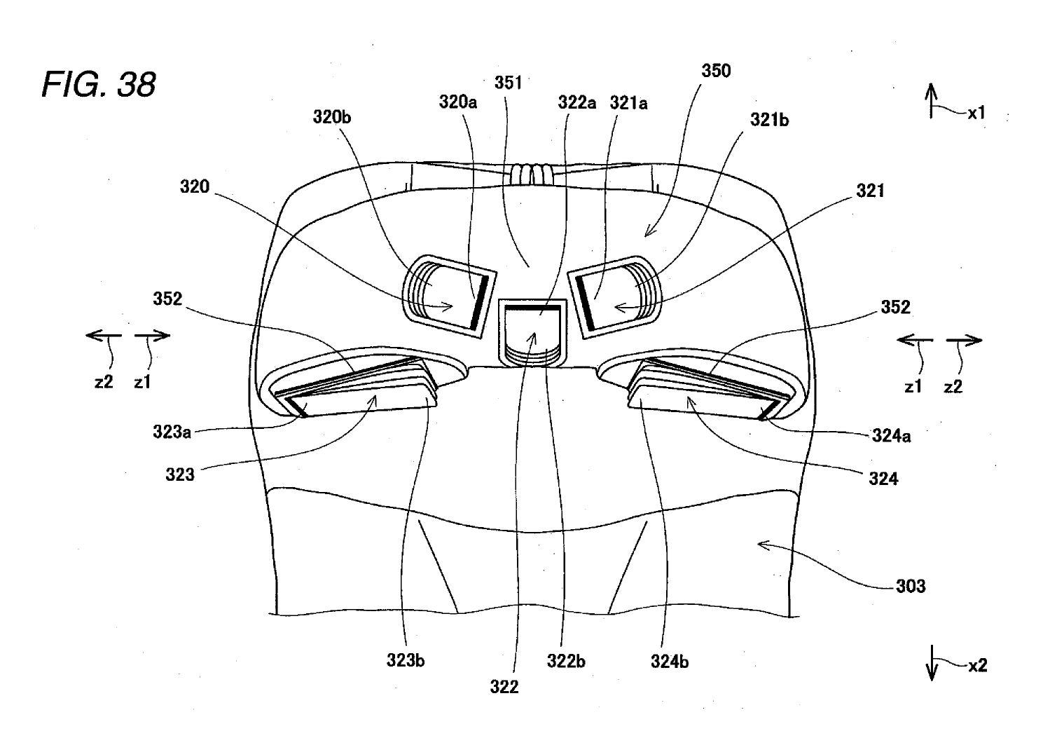

FIG. 38 is a front view showing the pillow section of the chair-type massage machine shown in FIG. 36 being in a state that the covering member 310, etc. are removed from the pillow section 307 shown in FIG. 36. As shown in the figure, the pillow section 307 is equipped with a pillow main body 350 covered with the above-mentioned covering member 310, and at the left and right positions of the head side portions of the user sitting on the seat section 302, the central portion 351 of this pillow main body 350 is provided with a left and right pair of head (neck) side air cells 320 and 321 (second air cells) serving as the head side treatment devices of the neck treatment portion so as to be opposed to the area ranging from the head side portions to the neck side portion. Furthermore, the central portion 351 of the pillow main body 350 is provided with a neck rear air cell 322 (third air cell) serving as the neck rear treatment device of the neck treatment portion for treating the neck portion so as to be opposed to the rear portion of the neck portion of the user sitting on the seat section 302. For the head (neck) side air cells 320 and 321 and the neck rear air cell 322, bellows-shaped air cells are adopted. Both the head (neck) side air cells 320 and 321 are disposed in an inclined state so that the outside portions (i.e., the end portions in the outward direction z2) thereof are positioned upper than the inside portions (i.e., the end portions in the inward direction z1) thereof. Moreover, the end portions of the head (neck) side air cells 320 and 321 in the inward direction z1 serve as base end portions 320a and 321a that are not expanded at the time of air supply, and the end portions thereof in the outward direction z2 serve as expansion portions 320b and 321b that are expanded. On the other hand, the end portion of the neck rear air cell 322 in the upward direction x1 serves as a base end portion 322a that is not expanded at the time of air supply, and the end portion thereof in the downward direction z2 serves as an expansion portion 322b that is expanded. The head (neck) side air cells 320 and 321 and the neck rear air cell 322 are expanded into a substantially fan-like shape when air is supplied and contracted into a flat shape when air is exhausted.

Hence, when air is supplied to the head (neck) side air cells 320 and 321 while the user sits on the seat section 302, the head side portions of the user are pressed slightly downward in the inward direction z1; hence, when air is supplied to one of the left and right air cells, the corresponding head side portion is pressed obliquely downward, and the head portion of the user can be tilted in the left or right direction. Furthermore, when air is supplied to both, the head side portions are pressed forward and downward, and the head portion of the user can be tilted forward and downward. Moreover, when air is supplied to the neck rear air cell 322 while the user sits on the seat section 302, the lower portion of the neck portion is pressed forward and upward, and the chin of the user is raised, whereby the front portion of the neck portion of the user can be stretched.

Furthermore, the main body bottom portions 352 corresponding to the shoulder treatment faces 311 (FIG. 36) are provided with a left and right pair of shoulder air cells 323 and 324 (first air cells) serving as the shoulder treatment devices of the shoulder treatment portions for treating the shoulder portions from above at positions opposed to the upper faces of the shoulder portions of the user. The end portions of these shoulder air cells 323 and 324 in the outward direction z2 serve as base end portions 323a and 324a that are not expanded at the time of air supply, and the end portions thereof in the inward direction z1 serve as expansion portions 323b and 324b that are expanded. The shoulder air cells 323 and 324 are expanded into a substantially fan-like shape when air is supplied and contracted into a flat shape when air is exhausted. Hence, when air is supplied to the shoulder air cells 323 and 324 while the user sits on the seat section 302, the shoulders can be pressed so as to be stretched from the upper inside (the areas of the shoulder portions close to the neck portion) to the lower outside (the areas of the shoulder portions away from the neck portion), whereby the shoulder portions of the user can be held and stretched downward and outward.

[Functions of Chair-Type Massage Machine]

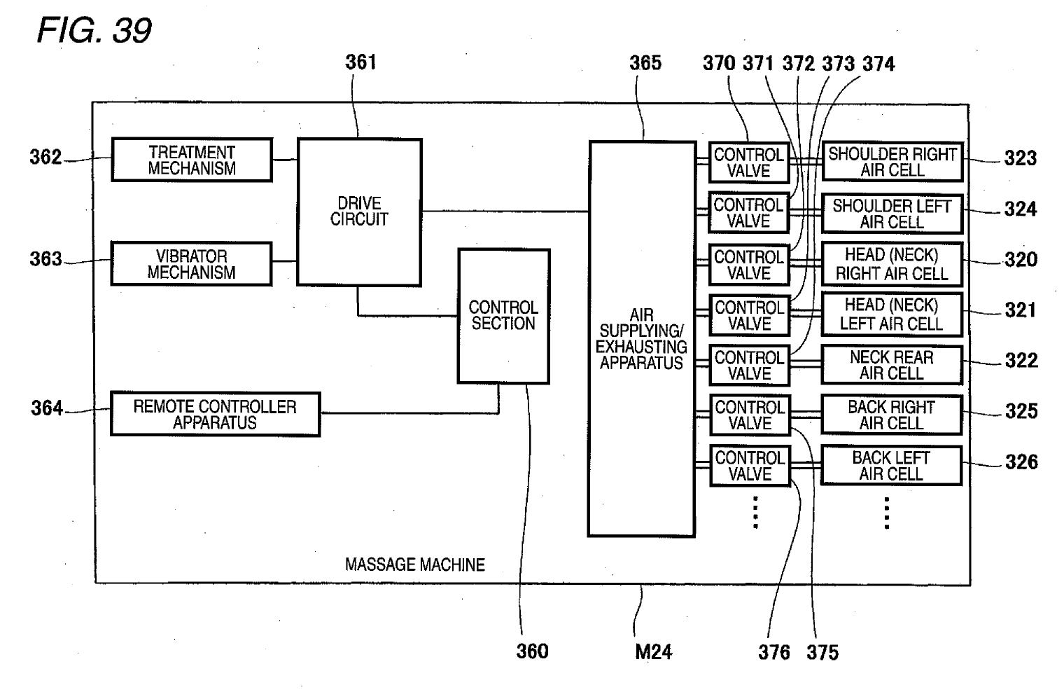

FIG. 39 is a block diagram illustrating the mechanical functions of the chair-type massage machine M24 shown in FIG. 36. The control section 360 shown in FIG. 39 includes a CPU, a ROM, a RAM, timers, etc. and executes various kinds of control programs, thereby controlling the treatment operations of the treatment units and the air cells connected thereto. Furthermore, a treatment mechanism 362 causing the massaging mechanism 308 (FIG. 36) to perform treatment operations, a vibrator mechanism 363, etc. are connected to the control section 36.0 via a drive section 361, and these are also controlled. Moreover, a remote control apparatus 364 operated by the user is connected to the control section 360.

The control section 360 is connected to an air supplying/exhausting apparatus 365 via the drive section 361. The drive section 361 outputs drive signals according to instructions from the control section 360 and drives the air supplying/exhausting apparatus 365 using these drive signals. The air supplying/exhausting apparatus 365 includes changeover valves, such as solenoid valves, an air pump, etc. The air supplying/exhausting apparatus 365 is respectively connected via air hoses to a control valve 370 that is connected to the shoulder right air cell 323 via air hoses, a control valve 371 that is connected to the shoulder left air cell 324 via air hoses, a control valve 372 that is connected to the head (neck) right air cell 320 via air hoses, a control valve 373 that is connected to the head (neck) left air cell 321 via air hoses, a control valve 374 that is connected to the shoulder rear air cell 322 via air hoses, a control valve 375 that is connected to the back right air cell 325 via air hoses, a control valve 376 that is connected to the back left air cell 326 via air hoses, and control valves (not shown) that are connected to other air cells via air hoses, thereby being capable of supplying and exhausting air to/from these independently of one another.

Hence, when an instruction is output from the control section 360 to the drive section 361 by the operation of the remote control apparatus 364 by the user or by the judgment of the control section 360, the shoulder right air cell 323, the shoulder left air cell 324, the head (neck) right air cell 320, the head (neck) left air cell 321 and the shoulder rear air cell 322 are controlled independently of one another, and the respective air cells 320 to 324 are expanded/contracted respectively individually by supplying/exhausting air from/to the air supplying/exhausting apparatus 365. As instructions for operating the massage machine M24 using the remote control apparatus 364 connected to the control section 360, control modes for operating the treatment mechanism and the respective air cells are prepared plurally so as to be able to perform various kinds of treatment modes, manual modes, etc.

The massage machine M24 according to this embodiment configured as described above can perform stretch treatment according to various treatment patterns for stretching the area ranging the shoulder portions to the neck portion of the user as described below, and the user can obtain a high treatment effect. These treatment patterns will be described below.

[Treatment Patterns]

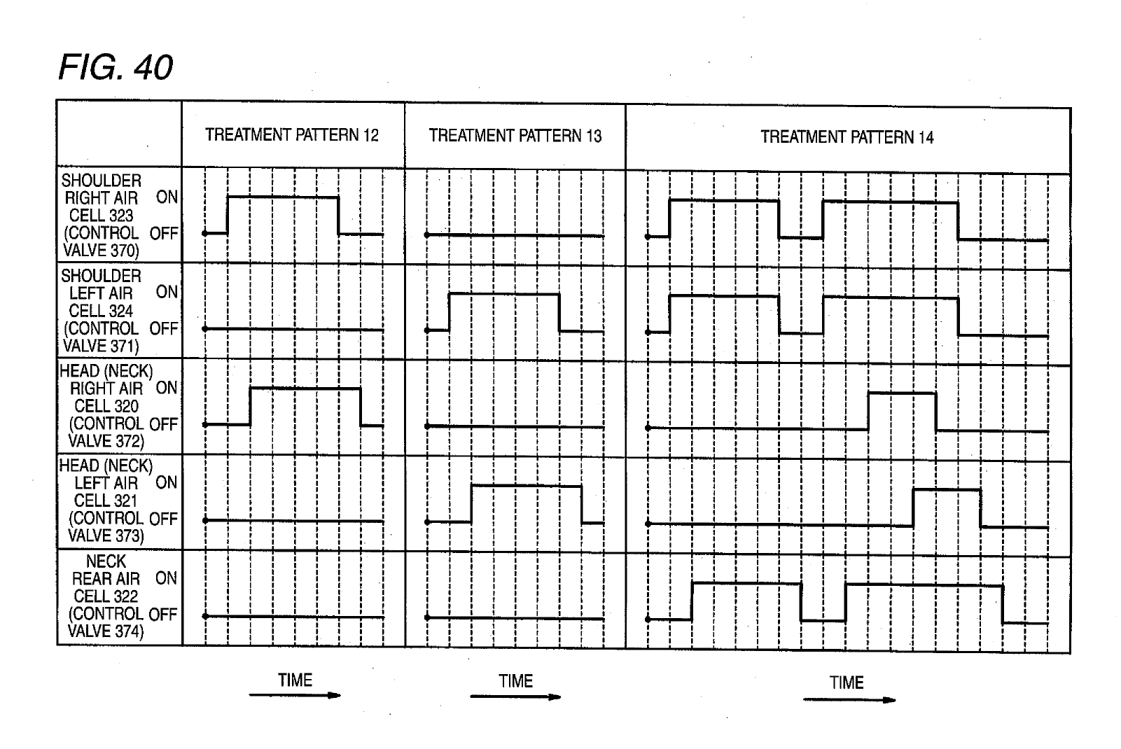

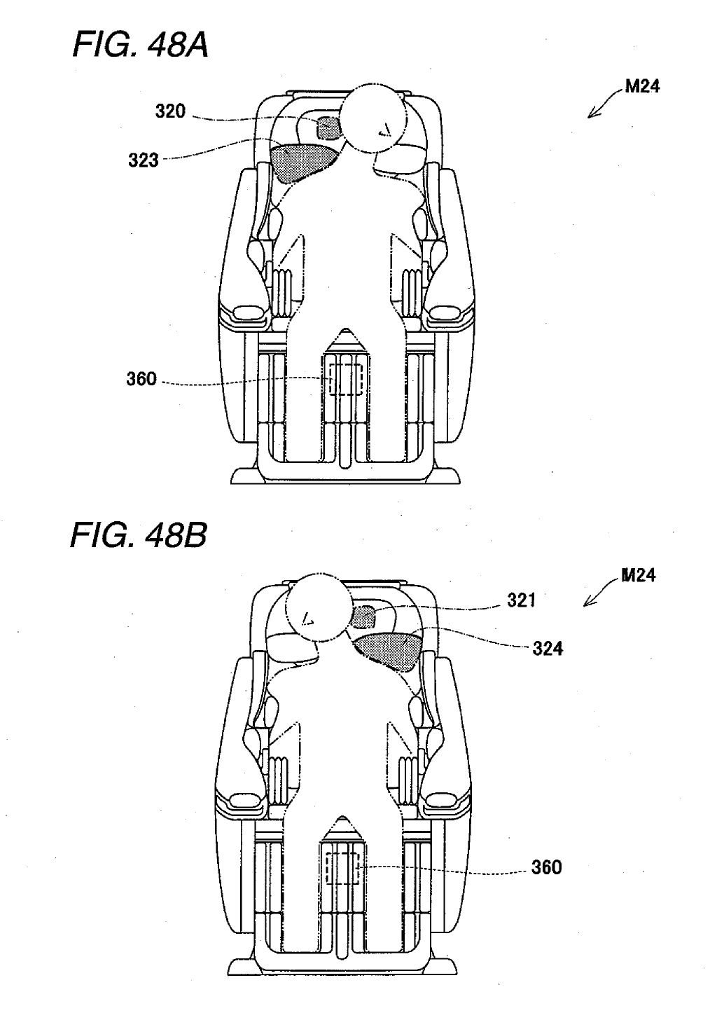

FIGS. 40 to 47 are diagrams illustrating the expansion and contraction operations of the respective air cells and showing some examples of treatment patterns in the chair-type massage machine M24; the vertical axis thereof represents the on/off states of the respective valves, and the horizontal axis thereof represents time. FIGS. 48A to 58B are front views of the chair-type massage machine, showing treatment positions in the respective treatment patterns; the air cells enclosed with dashed lines indicate air cells to be expanded/contracted. The respective air cells shown in these figures are schematically shown with their covers removed. Representative treatment patterns will be described below based on the respective drawings.

(Treatment Pattern 12)

As shown in FIGS. 40 and 48A, treatment pattern 12 is a pattern for performing neck stretching for the neck right portion of the user. The control section 360 supplies air to the shoulder right air cell 323 to expand it and then supplies air to the head (neck) right air cell 320 to expand it while the shoulder right air cell 323 remains expanded. Next, after a predetermined time has passed, the control section contracts the shoulder right air cell 323 and then contracts the head (neck) right air cell 320.

With treatment pattern 12, the right shoulder of the user is pressed, and the head right portion is pushed while the right shoulder is held and stretched; hence, the head portion is tilted leftward while the right shoulder is held and stretched so as not to float, whereby stretch treatment for stretching the area ranging from the neck right portion to the shoulder right portion can be received.

(Treatment Pattern 13)

As shown in FIGS. 40 and 48B, treatment pattern 13 is a pattern for performing neck stretching for the neck left portion of the user. The control section 360 supplies air to the shoulder left air cell 324 to expand it and then supplies air to the head (neck) left air cell 321 to expand it while the shoulder left air cell 324 remains expanded. Next, after a predetermined time has passed, the control section contracts the shoulder left air cell 324 and then contracts the head (neck) left air cell 321.

With treatment pattern 13, the left shoulder of the user is pressed, and the head left portion is pushed while the left shoulder is held and stretched; hence, the head portion is tilted rightward while the left shoulder is held and stretched so as not to float, whereby stretch treatment for stretching the area ranging from the neck left portion to the shoulder left portion can be received.

(Treatment Pattern 14)

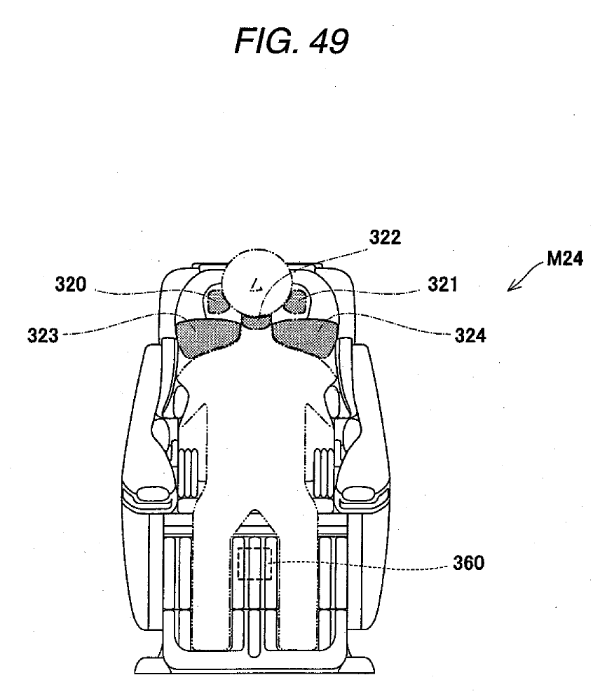

As shown in FIGS. 40 and 49, treatment pattern 14 is a pattern for mainly performing neck stretching for the neck front portion of the user. The control section 360 supplies air to the shoulder right air cell 323 and the shoulder left air cell 324 to expand them and then supplies air to the neck rear air cell 322 to expand it while the shoulder right air cell 323 and the shoulder left air cell 324 remain expanded. Next, after a predetermined time has passed, the control section contracts the shoulder right air cell 323 and the shoulder left air cell 324 and then contracts the neck rear air cell 322. Subsequently, after a predetermined time has passed, the control section supplies air to the shoulder right air cell 323 and the shoulder left air cell 324 again to expand them and then supplies air to the neck rear air cell 322 to expand it while the shoulder right air cell 323 and the shoulder left air cell 324 remain expanded; while these remain expanded, the control section expands the head (neck) right air cell 320 and then expands the head (neck) left air cell 321; after a predetermined time has passed, the control section contracts the head (neck) right air cell 320 and then contracts the shoulder right air cell 323 and the shoulder left air cell 324 and also contracts the head (neck) left air cell 321 and the neck rear air cell 322.

Furthermore, since the air supplying/exhausting operations of the shoulder right air cell 323 and the shoulder left air cell 324 are overlapped with those of the air cells 320 to 322, the treatment operations at the respective portions are performed not intermittently but smoothly in succession. In other words, the control section 360 is configured so that the lengths of the time zones in which the shoulder right air cell 323 and the shoulder left air cell 324 are expanded are substantially the same as each other and so that the time zones in which the head (neck) right air cell 320, the head (neck) left air cell 321 and the neck rear air cell 322 are expanded are partly overlapped with one another, whereby the treatment operations at the respective portions are performed smoothly in succession while being overlapped.

With treatment pattern 14, both the shoulder portions of the user are pressed; while both the shoulder portions are held and stretched, the neck rear portion is pushed and the rear portion of the head is thus lifted; hence, the head portion is tilted backward (in the direction that the chin is raised) while both the shoulder portions are held and stretched so as not to float, whereby stretch treatment for stretching the neck front portion can be received effectively. Moreover, while both the shoulder portions are held and stretched and the chin is raised, the head right portion and the head left portion are pressed alternately, and the head portion is thus tilted left and right, whereby stretch treatment for alternately stretching the left and right portions of the neck portion can be received effectively.

(Treatment Pattern 15)

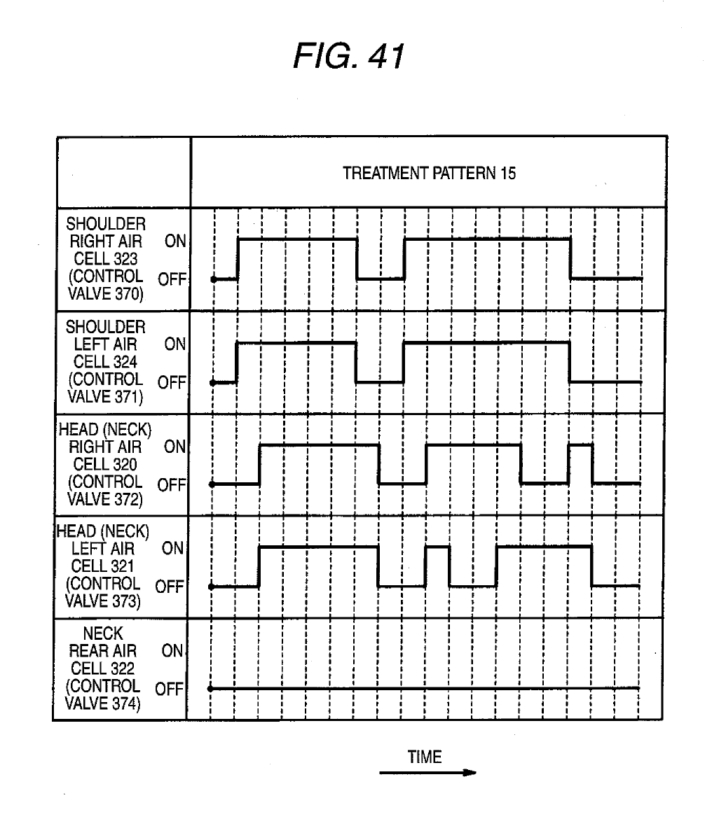

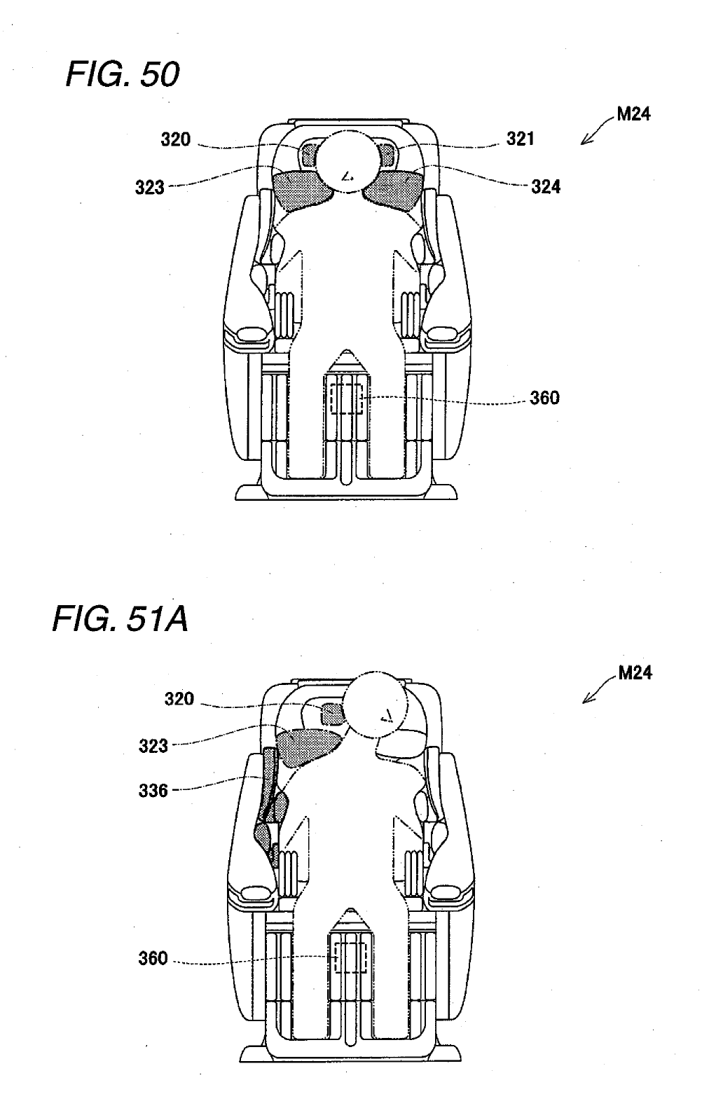

As shown in FIGS. 41 and 50, treatment pattern 15 is a pattern for mainly performing neck stretching for the neck rear portion of the user. The control section 360 supplies air to the shoulder right air cell 323 and the shoulder left air cell 324 to expand them and then supplies air to the head (neck) right air cell 320 and the head (neck) left air cell 321 to expand them while the shoulder right air cell 323 and the shoulder left air cell 324 remain expanded. Next, after a predetermined time has passed, the control section contracts the shoulder right air cell 323 and the shoulder left air cell 324 and then contracts the head (neck) right air cell 320 and the head (neck) left air cell 321. Subsequently, after a predetermined time has passed, the control section supplies air to the shoulder right air cell 323 and the shoulder left air cell 324 again to expand them and then supplies air to the head (neck) right air cell 320 and the head (neck) left air cell 321 to expand them while the shoulder right air cell 323 and the shoulder left air cell 324 remain expanded. Then, air is exhausted and supplied from/to the head (neck) left air cell 321, and air is exhausted and supplied from/to the head (neck) right air cell 320. In addition, after a predetermined time has passed, the shoulder right air cell 323 and the shoulder left air cell 324 are contracted, and the head (neck) right air cell 320 and the head (neck) left air cell 321 are contracted. Furthermore, since the air supplying/exhausting operations of the shoulder right air cell 323 and the shoulder left air cell 324 are overlapped with those of the head (neck) air cells 320 and 321 for a predetermined time, treatment portions are shifted not intermittently but smoothly.

With treatment pattern 15, both the shoulder portions of the user are pressed; while both the shoulder portions are held and stretched, the head left and right portions are pushed and the head portion is thus tilted forward and downward; hence, the head portion is tilted forward and downward (in the direction that the chin is pulled in) while both the shoulder portions are held and stretched so as not to float, whereby stretch treatment for stretching the neck rear portion can be received effectively. Moreover, while both the shoulder portions are held and stretched and the chin is pulled in, the head right portion and the head left portion are pressed alternately, and the head portion is thus tilted left and right, whereby stretch treatment for alternately stretching the left and right portions of the neck portion can be received effectively.

As described above, with treatment patterns 12 and 13, the neck left and right portions can be stretched; with treatment pattern 14, the neck front portion can be stretched; and with treatment pattern 15, the neck rear portion can be stretched. Hence, with treatment patterns 12 to 15, the shoulder right air cell 323, the shoulder left air cell 324, the head (neck) right air cell 320, the head (neck) left air cell 321 and the neck rear air cell 322 can be controlled independently of one another; as a result, various stretch treatment operations can be performed for the neck portion of the user while the shoulder portions of the user are pressed and the position of the upper body is held, whereby the user can obtain a high treatment effect.

(Treatment Pattern 16)

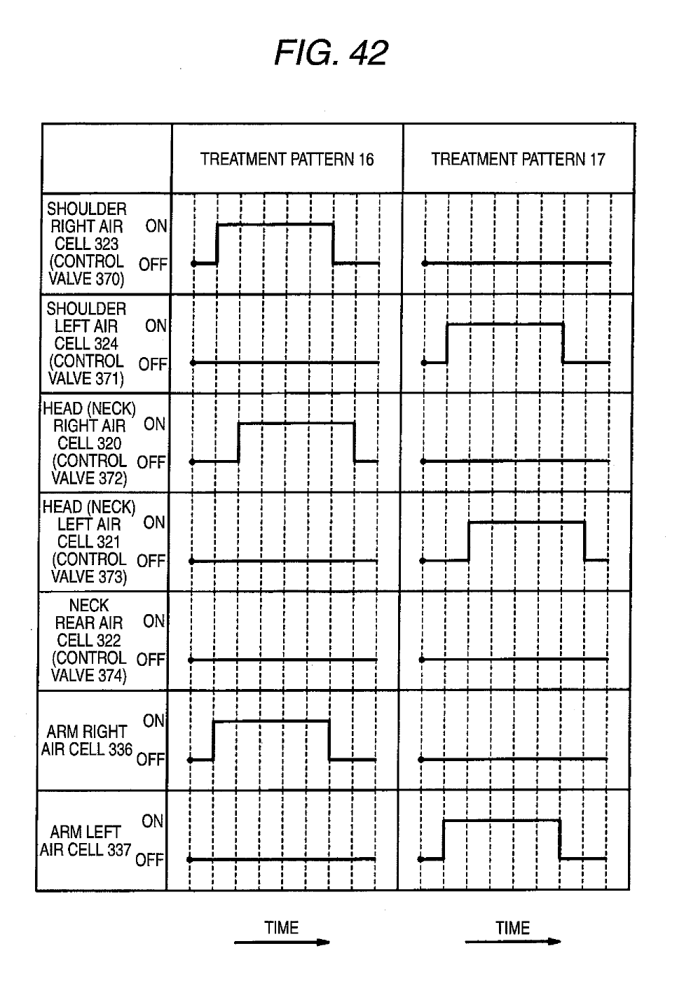

As shown in FIGS. 42 and 51A, treatment pattern 16 is a pattern for treating the right arm portion of the user while the above-mentioned treatment pattern 12 is performed. The control section 360 supplies air to the shoulder right air cell 323 to expand it and supplies air to the arm right air cell 336 to expand it simultaneously; then, the control section supplies air to the head (neck) right air cell 320 to expand it while the shoulder right air cell 323 and the arm right air cell 336 remain expanded. Next, after a predetermined time has passed, the control section contracts the shoulder right air cell 323 and the arm right air cell 336 and then contracts the head (neck) right air cell 320. Although all the air cells of the arm right air cell 336 are expanded simultaneously in treatment pattern 16, it may also be possible that the respective air cells of the arm right air cell 336 are expanded in order from the side of the end of the arm or only some of them are expanded.

With treatment pattern 16, while the right shoulder and right arm of the user are pressed, the head right portion is pushed and the head portion is tilted leftward; hence, stretch treatment for stretching the neck right portion ranging from the shoulder portion to the neck portion is received, and the right arm is pressure-treated; as a result, it is possible to receive stretch treatment in which the neck right portion and the shoulder right portion are stretched while the right arm of the user is pressure-treated.

Furthermore, in treatment pattern 16, the head (neck) right air cell 320 may also be expanded while the arm right air cell 336 is expanded without expanding the shoulder right air cell 323. In this case, stretch treatment for stretching the area ranging from the right arm portion to the neck right portion of the user can be received. In particular, it is desirable to expand the head (neck) right air cell 320 while only the air cell (the arm air cell 332) of the arm right air cell 336, disposed on the side of the end of the arm, is expanded because the area ranging from the end of the right arm portion to the neck right portion can be stretched.

(Treatment Pattern 17)

As shown in FIGS. 42 and 51B, treatment pattern 17 is a pattern for treating the left arm portion of the user while the above-mentioned treatment pattern 13 is performed. The control section 360 supplies air to the shoulder left air cell 324 to expand it and supplies air to the arm left air cell 337 to expand it simultaneously; then, the control section supplies air to the head (neck) left air cell 321 to expand it while the shoulder left air cell 324 and the arm left air cell 337 remain expanded. Next, after a predetermined time has passed, the control section contracts the shoulder left air cell 324 and the arm left air cell 337 and then contracts the head (neck) left air cell 321. Although all the air cells of the arm left air cell 337 are also expanded simultaneously in treatment pattern 17, it may also be possible that the respective air cells of the arm left air cell 337 are expanded in order from the side of the end of the arm or only some of them are expanded.

With treatment pattern 17, while the left shoulder and left arm of the user are pressed, the head left portion is pushed and the head portion is tilted rightward; hence, stretch treatment for stretching the neck left portion ranging from the shoulder portions to the neck portion is received, and the left arm is pressure-treated; as a result, it is possible to receive stretch treatment in which the neck left portion and the shoulder left portion are stretched while the left arm of the user is pressure-treated.

Furthermore, also in treatment pattern 17, the head (neck) left air cell 321 may also be expanded while the arm left air cell 337 is expanded without expanding the shoulder left air cell 324. In this case, stretch treatment for stretching the area ranging from the left arm portion to the neck left portion of the user can be received. In particular, also in treatment pattern 17, it is desirable to expand the head (neck) left air cell 321 while only the air cell (the arm air cell 332) of the arm left air cell 337, disposed on the side of the end of the arm, is expanded because the area ranging from the end of the left arm portion to the neck left portion can be stretched.

(Treatment Pattern 18)

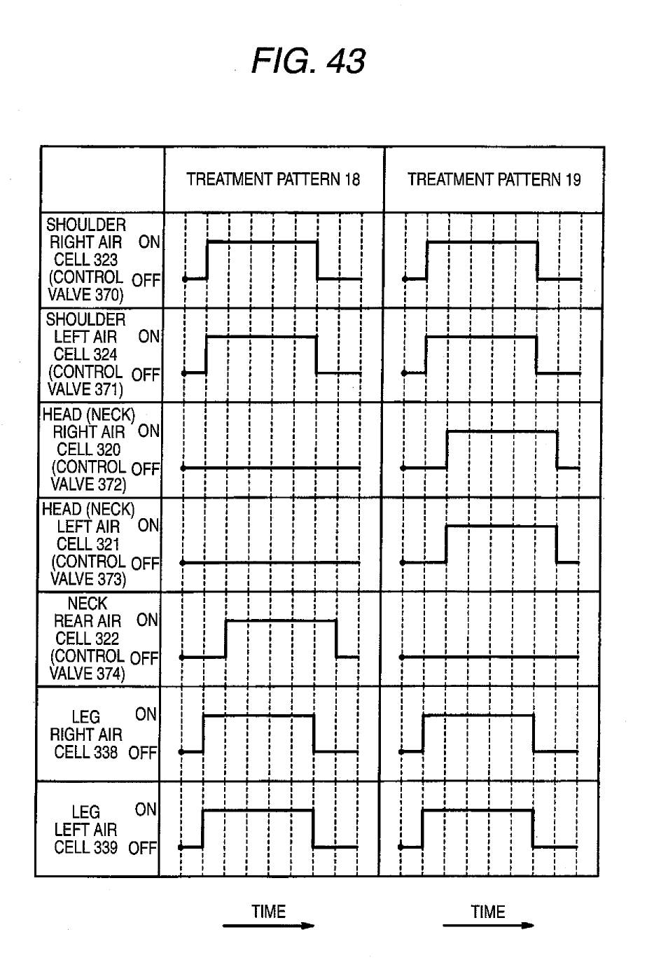

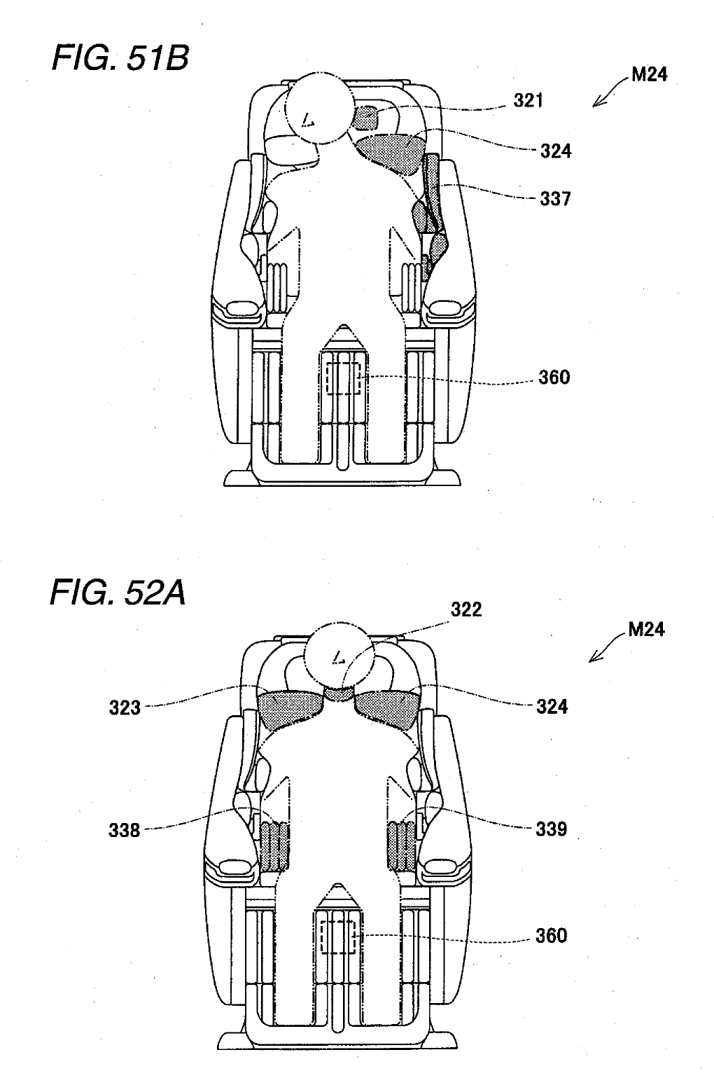

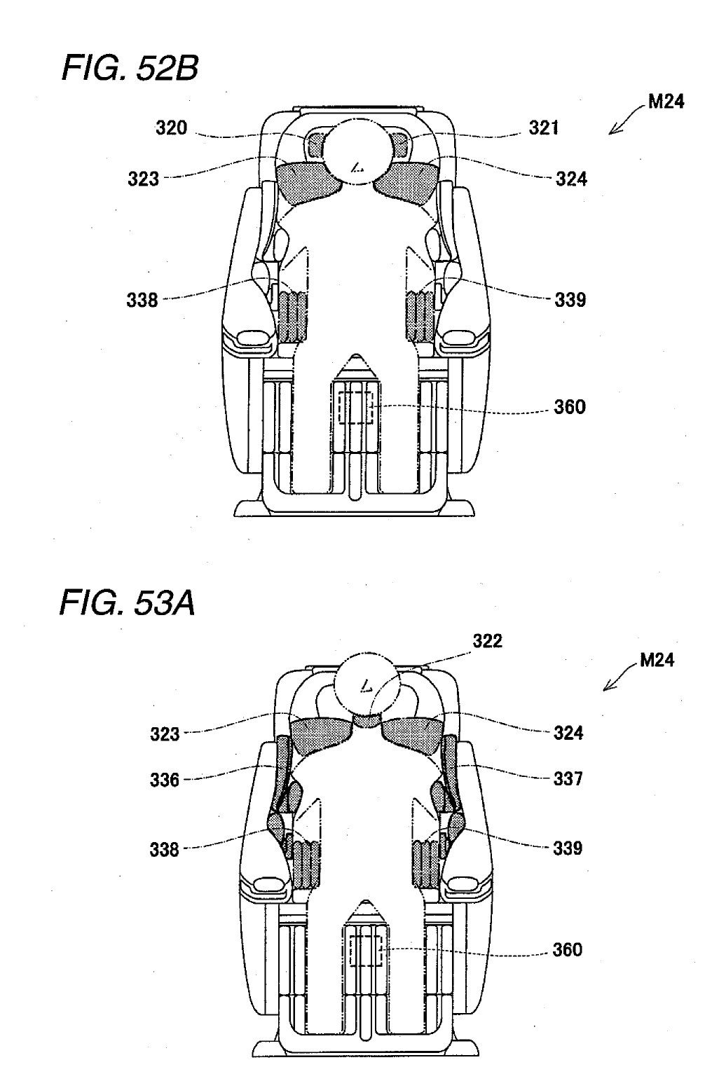

As shown in FIGS. 43 and 52A, treatment pattern 18 is a pattern for treating the neck front portion and the thighs of the user. The control section 360 supplies air to the shoulder right air cell 323 and the shoulder left air cell 324 to expand them and supplies air to the leg right air cell 338 and the leg left air cell 339 to expand them simultaneously; then, while the shoulder right air cell 323, the shoulder left air cell 324, the leg right air cell 338 and the leg left air cell 339 remain expanded, the control section supplies air to the neck rear air cell 322 to expand it. Next, after a predetermined time has passed, the control section contracts the shoulder right air cell 323, the shoulder left air cell 324, the leg right air cell 338 and the leg left air cell 339 simultaneously and then contracts the neck rear air cell 322.

With treatment pattern 18, while the shoulder portions and the thighs of the user are pressed, the neck rear portion is pushed, and the rear portion of the head is thus lifted; hence, stretch treatment for stretching the neck front portion can be received, and pressure treatment for the thighs on both sides thereof can also be received. In addition, since the neck rear portion is pressed while the thighs as well as the shoulder portions of the user are pressed, the rear portion of the head can be lifted without allowing the body to float, whereby effective stretch treatment for the neck front portion can be received. Although air is supplied to the leg right air cell 338 and the leg left air cell 339 simultaneously to pressure-treat both the thighs simultaneously in treatment pattern 18, it may also be possible that air is supplied to one of them to pressure-treat one of the left and right portions or it may also be possible that air is supplied to both of them while a time difference is provided between them so that pressure treatment at the left position is overlapped with that at the right position for a predetermined time; however, the air supplying pattern is not limited to these examples.

(Treatment Pattern 19)

As shown in FIGS. 43 and 52B, treatment pattern 19 is a pattern for treating the neck rear portion and the thighs of the user. The control section 360 supplies air to the shoulder right air cell 323 and the shoulder left air cell 324 to expand them and supplies air to the leg right air cell 338 and the leg left air cell 339 to expand them simultaneously; then, while the shoulder right air cell 323, the shoulder left air cell 324, the leg right air cell 338 and the leg left air cell 339 remain expanded, the control section supplies air to the head (neck) right air cell 320 and the head (neck) left air cell 321 to expand them. Next, after a predetermined time has passed, the control section contracts the shoulder right air cell 323, the shoulder left air cell 324, the leg right air cell 338 and the leg left air cell 339 simultaneously and then contracts the head (neck) right air cell 320 and the head (neck) left air cell 321.

With treatment pattern 19, while the shoulder portions of the user are pressed, the head left and right portions are pushed, and the head portion is tilted forward; hence, stretch treatment for stretching the neck rear portion can be received, and pressure treatment for the thighs on both sides thereof can also be received. In addition, since the head left and right portions are pressed while the thighs as well as the shoulder portions of the user are pressed, the head portion can be tilted forward without allowing the body to be pushed out forward, whereby effective stretch treatment for the neck rear portion can be received. Although air is supplied to the leg right air cell 338 and the leg left air cell 339 simultaneously to pressure-treat both the thighs simultaneously also in treatment pattern 19, it may also be possible that air is supplied to one of them to pressure-treat one of the left and right portions or it may also be possible that air is supplied to both of them while a time difference is provided between them so that pressure treatment at the left position is overlapped with that at the right position for a predetermined time; however, the air supplying pattern is not limited to these examples.

(Treatment Pattern 20)

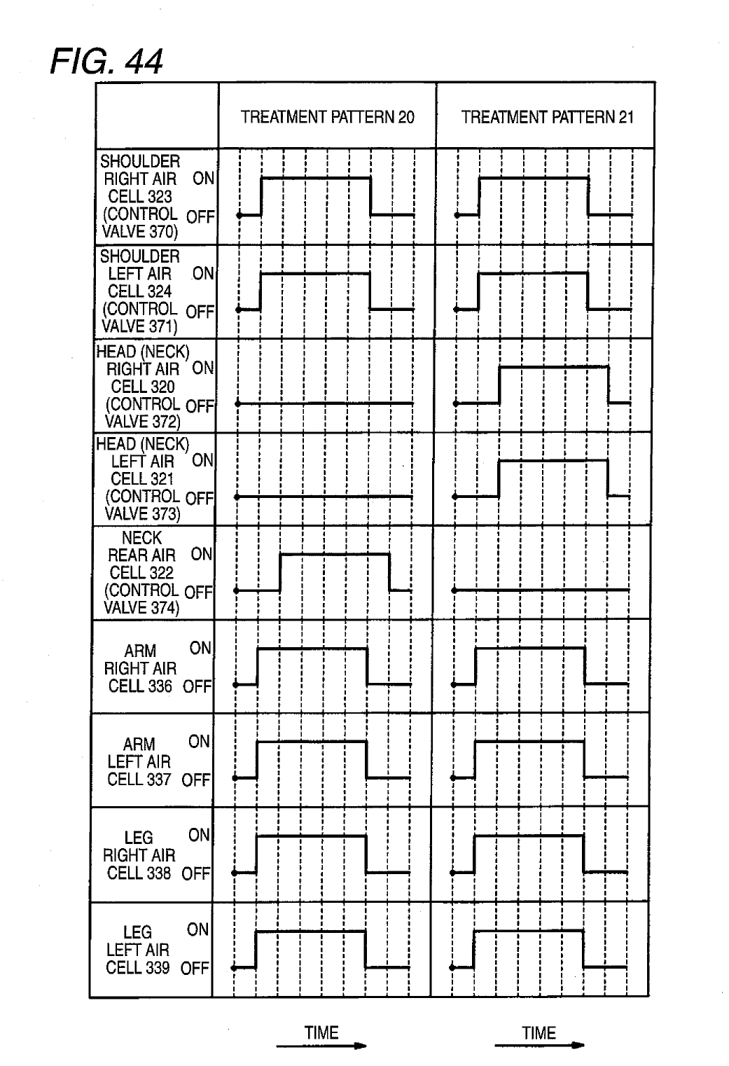

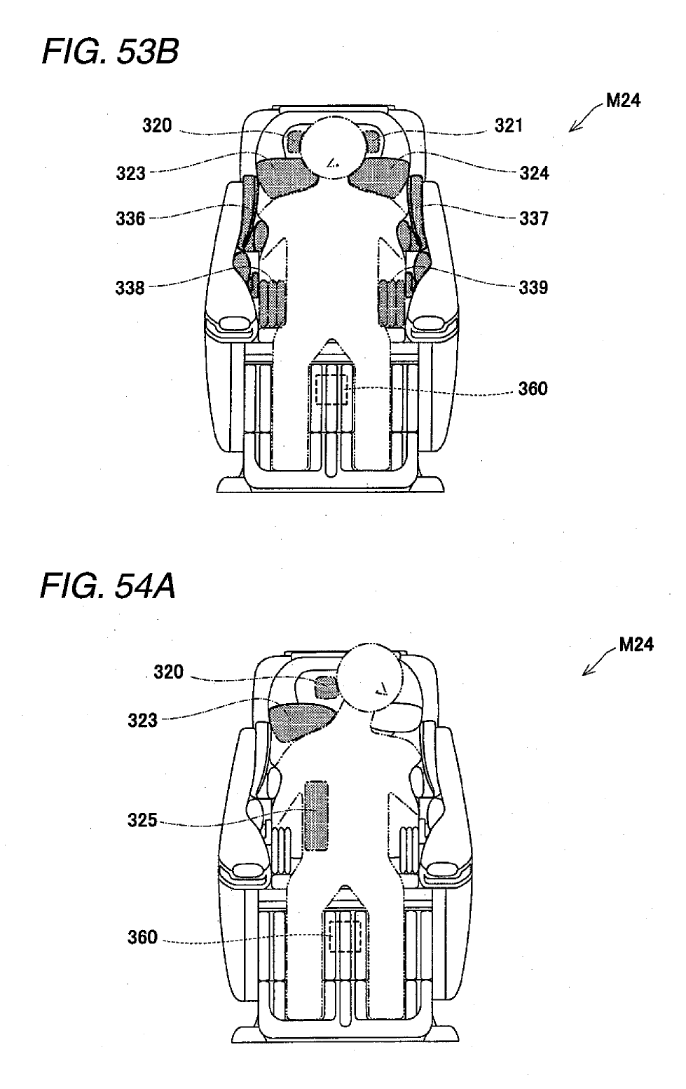

As shown in FIGS. 44 and 53A, treatment pattern 20 is a pattern for treating the neck front portion, both the arm portions and the thighs of the user. The control section 360 supplies air to the shoulder right air cell 323 and the shoulder left air cell 324 to expand them and supplies air to the arm right air cell 336, the arm left air cell 337, the leg right air cell 338 and the leg left air cell 339 to expand them simultaneously; then, while the shoulder right air cell 323, the shoulder left air cell 324, the arm right air cell 336, the arm left air cell 337, the leg right air cell 338 and the leg left air cell 339 remain expanded, the control section supplies air to the neck rear air cell 322 to expand it. Next, after a predetermined time has passed, the control section contracts the shoulder right air cell 323, the shoulder left air cell 324, the arm right air cell 336, the arm left air cell 337, the leg right air cell 338 and the leg left air cell 339 simultaneously and then contracts the neck rear air cell 322.

With treatment pattern 20, while the shoulder portions, both the arm portions and both the thighs of the user are pressed and,the body is held, the neck rear portion is pushed, and the rear portion of the head is lifted; hence, the head portion is tilted backward (in the direction that the chin is raised) without allowing the body to float, and stretch treatment for stretching the neck front portion can be received effectively. In addition, while the neck front portion is treated, pressure treatment for both the arm portions and both the thighs can also be received.

(Treatment Pattern 21)

As shown in FIGS. 44 and 53B, treatment pattern 21 is a pattern for treating the neck rear portion, both the arm portions and both the thighs of the user. The control section 360 supplies air to the shoulder right air cell 323 and the shoulder left air cell 324 to expand them and supplies air to the arm right air cell 336, the arm left air cell 337, the leg right air cell 338 and the leg left air cell 339 to expand them simultaneously; then, while the shoulder right air cell 323, the shoulder left air cell 324, the arm right air cell 336, the arm left air cell 337, the leg right air cell 338 and the leg left air cell 339 remain expanded, the control section supplies air to the head (neck) right air cell 320 and the head (neck) left air cell 321 to expands them. Next, after a predetermined time has passed, the control section contracts the shoulder right air cell 323, the shoulder left air cell 324, the arm right air cell 336, the arm left air cell 337, the leg right air cell 338 and the leg left air cell 339 simultaneously and then contracts the head (neck) right air cell 320 and the head (neck) left air cell 321.

With treatment pattern 21, while the shoulder portions, both the arm portions and both the thighs of the user are pressed and the body is held, the head left and right portions are pressed, and the head portion is tilted forward (in the direction that the chin is pulled in); hence, stretch treatment for stretching the neck rear portion can be received effectively without allowing the body to be moved when the head left and right portions are pressed addition, while the neck portion is treated, pressure treatment for both the arm portions and the thighs can also be received.

As described above, with treatment patterns 16 to 21, the shoulder right air cell 323, the shoulder left air cell 324, the head (neck) right air cell 320, the head (neck) left air cell 321 and the neck rear air cell 322 are controlled independently of one another, and the arm right air cell 336, the arm left air cell 337, the leg right air cell 338 and the leg left air cell 339 are also controlled independently; hence, in addition to the stretch treatment operations for the neck portion of the user according to the above-mentioned treatment patterns 12 to 15, various treatment operations are performed for other portions, and the user can obtain a high treatment effect.

(Treatment Pattern 22)

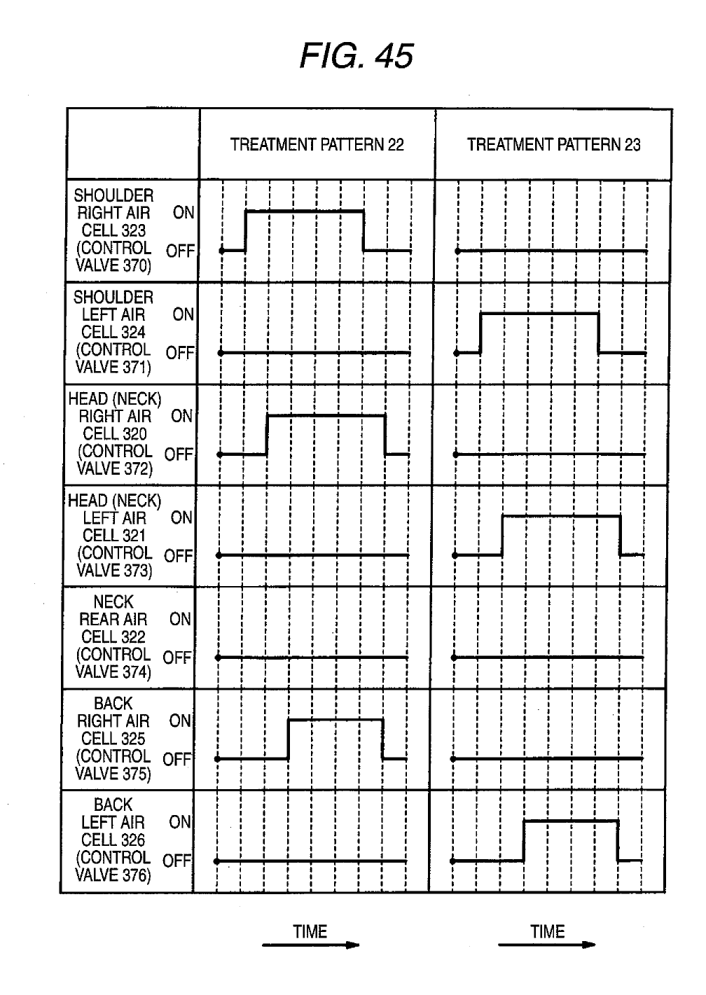

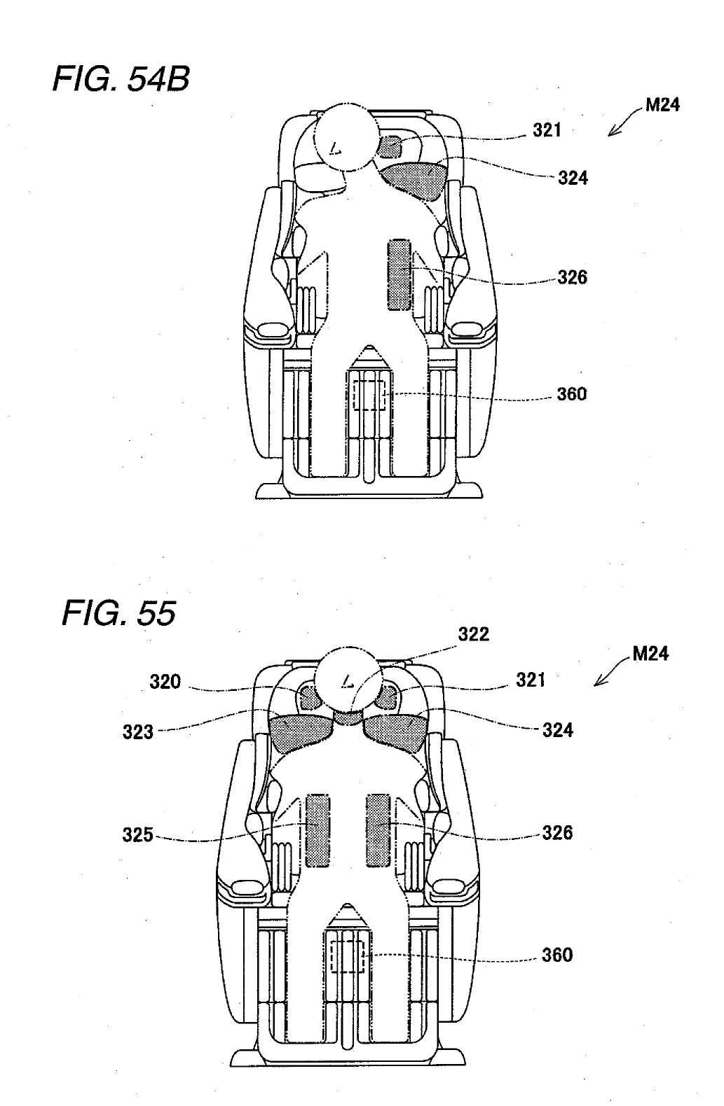

As shown in FIGS. 45 and 54A, treatment pattern 22 is a pattern for performing treatment such that the back portion is bent backward or twisted in addition to neck stretching for the neck right portion of the user. The control section 360 supplies air to the shoulder right air cell 323 to expand it; then, while the shoulder right air cell 323 retrains expanded, the control section supplies air to the head (neck) right air cell 320 to expand it; furthermore, while the shoulder right air cell 323 and the head (neck) right air cell 320 remain expanded, the control section expands the back right air cell 325. Next, after a predetermined time has passed, the control section contracts the shoulder right air cell 323 and then contracts the head (neck) right air cell 320 and the back right air cell 325.

With treatment pattern 22, the right shoulder of the user is pressed, and the head right portion and the back right portion are pushed while the right shoulder is held and stretched; hence, while the right shoulder is held and stretched so as not to float, the head portion is tilted leftward, and the right portion of the back portion is pushed such that the back portion is twisted so as to be bent backward; as a result, it is possible to receive stretch treatment in which the area ranging from the neck right portion to the shoulder right portion and the back right portion is stretched such that the back portion is twisted.

(Treatment Pattern 23)

As shown in FIGS. 45 and 54B, treatment pattern 23 is a pattern for performing treatment such that the back portion is bent backward or twisted in addition to neck stretching for the neck left portion of the user. The control section 360 supplies air to the shoulder left air cell 324 to expand it; then, while the shoulder left air cell 324 remains expanded, the control section supplies air to the head (neck) left air cell 321 to expand it; furthermore, while the shoulder left air cell 324 and the head (neck) left air cell 321 remain expanded, the control section expands the back left air cell 326. Next, after a predetermined time has passed, the control section contracts the shoulder left air cell 324 and then contracts the head (neck) left air cell 321 and the back left air cell 326.

With treatment pattern 23, the left shoulder of the user is pressed, and the head left portion and the back right portion are pushed while the left shoulder is held and stretched; hence, while the left shoulder is held and stretched so as not to float, the head portion is tilted rightward, and the left portion of the back portion is pushed such that the back portion is twisted so as to be bent backward; as a result, it is possible to receive stretch treatment in which the area ranging from the neck left portion to the shoulder left portion and the back right portion is stretched such that the back portion is twisted.

(Treatment Pattern 24)

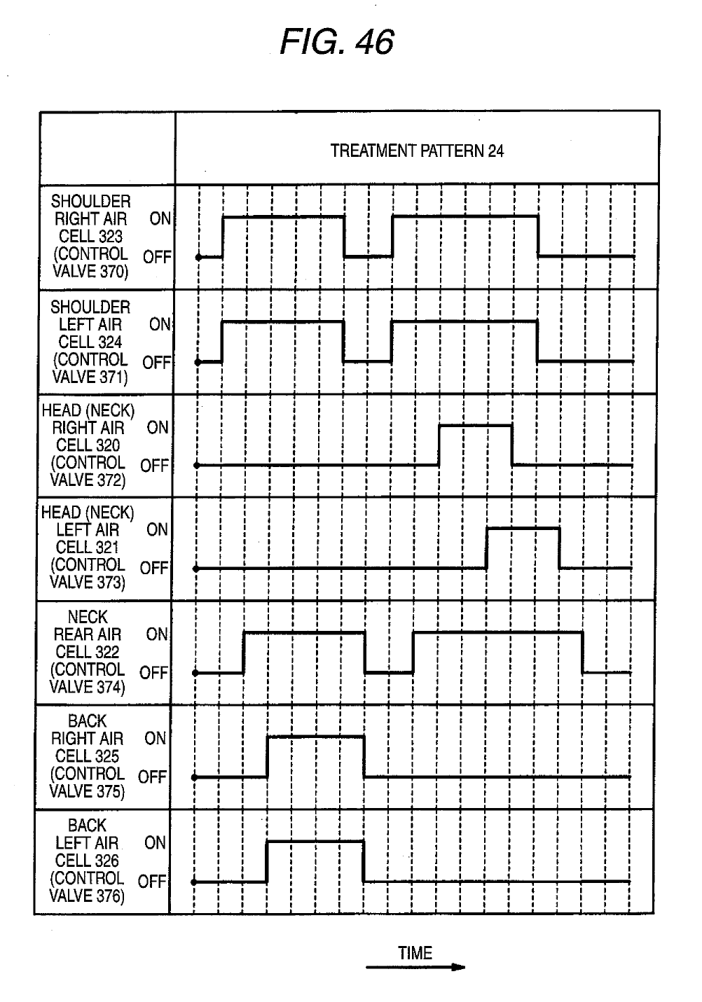

As shown in FIGS. 46 and 55, treatment pattern 24 is a pattern for performing treatment such that the back portion is bent backward or twisted in addition to neck stretching for the neck front portion of the user. The control section 360 supplies air to the shoulder right air cell 323 and the shoulder left air cell 324 to expand them; then, while the shoulder right air cell 323 and the shoulder left air cell 324 remain expanded, the control section supplies air to the neck rear air cell 322 to expand it; furthermore, while the shoulder right air cell 323, the shoulder left air cell 324 and the neck rear air cell 322 remain expanded, the control section supplies air to the back right air cell 325 and the back left air cell 326 to expand them. Next, after a predetermined time has passed, the control section contracts the shoulder right air cell 323 and the shoulder left air cell 324 and then contracts the neck rear air cell 322, the back right air cell 325 and the back left air cell 326. Then, after a predetermined time has passed, the control section supplies air to the shoulder right air cell 323 and the shoulder left air cell 324 again to expand them and then supplies air to the neck rear air cell 322 to expand it while the shoulder right air cell 323 and the shoulder left air cell 324 remain expanded; while these remain expanded, the control section expands the head (neck) right air cell 320 and then expands the head (neck) left air cell 321; after a predetermined time has passed, the control section contracts the head (neck) right air cell 320 and then contracts the shoulder right air cell 323 and the shoulder left air cell 324 and contracts the head (neck) left air cell 321 and the neck rear air cell 322.

Furthermore, since the air supplying/exhausting operations of the shoulder right air cell 323 and the shoulder left air cell 324 are overlapped with those of the air cells 320 to 322, the treatment operations at the respective portions are performed not intermittently but smoothly in succession. In other words, the control section 360 is configured so that the lengths of the time zones in which the shoulder right air cell 323 and the shoulder left air cell 324 are expanded are substantially the same as each other and so that the time zones in which the head (neck) right air cell 320, the head (neck) left air cell 321 and the neck rear air cell 322 are expanded are partly overlapped with one another, whereby the treatment operations at the respective portions are performed smoothly in succession while being overlapped.

With treatment pattern 24, both the shoulder portions of the user are pressed; while both the shoulder portions are held and stretched, the neck rear portion is pushed and the rear portion of the head is thus lifted; hence, the head portion is tilted backward (in the direction that the chin is raised) while both the shoulder portions are held and stretched so as not to float, whereby stretch treatment for stretching the neck front portion can be received effectively. Furthermore, since both the shoulder portions are pushed and the back portion is bent backward when the neck front portion is stretched, it is possible to receive stretch treatment in which an extensive area ranging from the back portion to the rear portion of the head is stretched. Moreover, while both shoulder portions are held and stretched and the chin is raised, the head right portion and the head left portion are pressed alternately, and the head portion is thus tilted left and right, whereby stretch treatment for alternately stretching the left and right portions of the neck portion can be received effectively.

(Treatment Pattern 25)

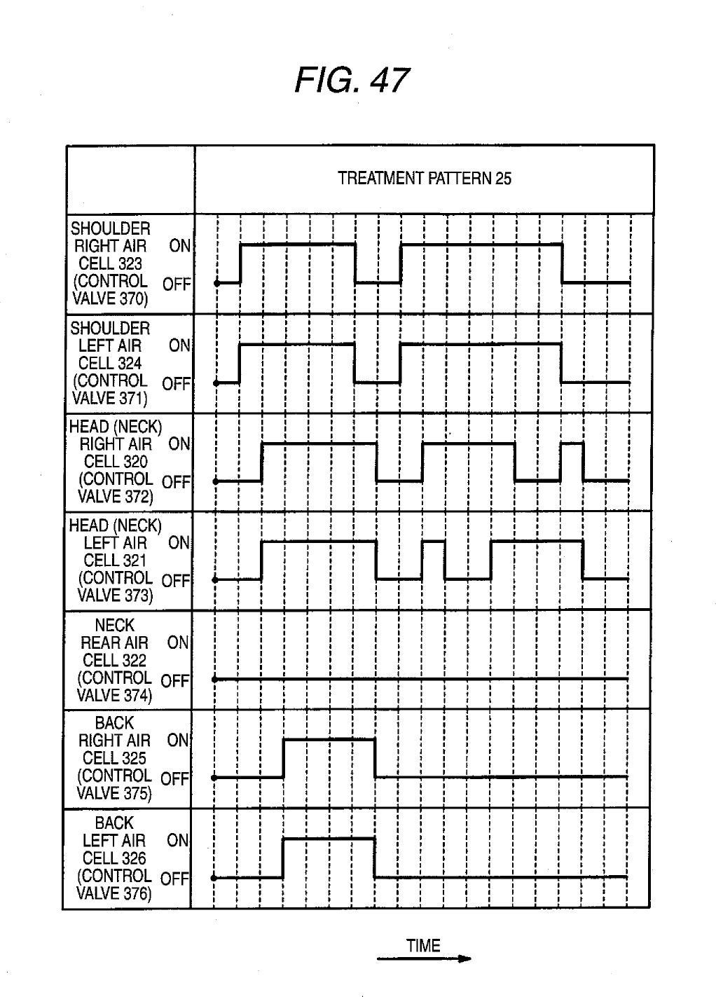

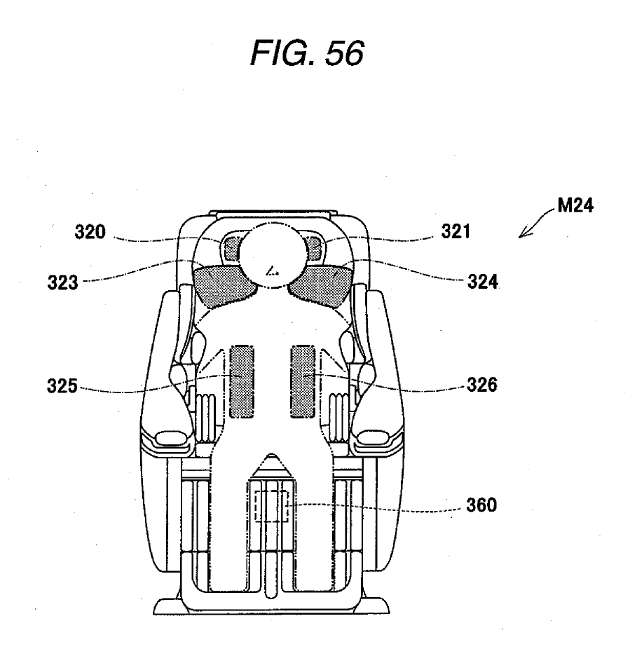

As shown in FIGS. 47 and 56, treatment pattern 25 is a pattern for performing treatment such that the back portion is bent backward or twisted in addition to neck stretching for the neck rear portion of the user. The control section 360 supplies air to the shoulder right air cell 323 and the shoulder left air cell 324 to expand them; then, while the shoulder right air cell 323 and the shoulder left air cell 324 remain expanded, the control section supplies air to the head (neck) right air cell 320 and the head (neck) left air cell 321 to expand them; furthermore, while the shoulder right air cell 323, the shoulder left air cell 324, the head (neck) right air cell 320 and the head (neck) left air cell 321 remain expanded, the control section supplies air to the back right air cell 325 and the back left air cell 326 to expand them. Next, after a predetermined time has passed, the control section contracts the shoulder right air cell 323 and the shoulder left air cell 324 and then contracts the head (neck) right air cell 320, the head (neck) left air cell 321, the back right air cell 325 and the back left air cell 326. Then, after a predetermined time has passed, the control section supplies, air to the shoulder right air cell 323 and the shoulder left air cell 324 again to expand them and supplies air to the head (neck) right air cell 320 and the head (neck) left air cell 321 to expand them while the shoulder right air cell 323 and the shoulder left air cell 324 remain expanded. Then, air is exhausted and supplied from/to the head (neck) left air cell 321, and air is exhausted and supplied from/to the head (neck) right air cell 320. In addition, after a predetermined time has passed, the shoulder right air cell 323 and the shoulder left air cell 324 are contracted, and the head (neck) right air cell 320 and the head (neck) left air cell 321 are contracted. Furthermore, since the air supplying/exhausting operations of the shoulder right air cell 323 and the shoulder left air cell 324 are overlapped with those of the head (neck) air cells 320 and 321 for a predetermined time, treatment portions are shifted not intermittently but smoothly.

With treatment pattern 25, both the shoulder portions of the user are pressed; while both the shoulder portions are held and stretched, the head left and right portions are pushed, and the head portion is tilted forward and downward; hence, the head portion is tilted forward and downward (in the direction that the chin is pulled in) while both the shoulder portions are held and stretched so as not to float, whereby stretch treatment for stretching the neck rear portion can be received effectively. Furthermore, since both shoulder portions are pushed and the back portion is bent backward when the neck rear portion is stretched, it is possible to receive stretch treatment in which the neck rear portion is stretched while the extensive area ranging from the back portion to the neck portion is stretched. Moreover, while both shoulder portions are held and stretched and the chin is pulled in, the head right portion and the head left portion are pressed alternately, and the head portion is thus tilted left and right, whereby stretch treatment for alternately stretching the left and right portions of the neck portion can be received effectively.

As described above, with treatment patterns 22 and 23, it is possible to perform treatment such that the back portion is bent backward or twisted together with the stretching of the neck left and right portions; with treatment pattern 24, it is possible to bend the back portion backward in an extensive range together with the stretching of the neck front portion; and with treatment pattern 25, it is possible to bend the back portion backward and stretch the portion together with the stretching of the neck rear portion. Hence, with treatment patterns 22 to 25, since the shoulder right air cell 323, the shoulder left air cell 324, the head (neck) right air cell 320, the head (neck) left air cell 321, the neck rear air cell 322, the back right air cell 325 and the back left air cell 326 are controlled independently of one another, it is possible to perform treatment such that the back portion is bent backward or twisted together with the various stretch treatment operations for the neck portion of the user while the shoulder portions of the user are pressed and the position of the upper body is held; as a result, the user can obtain a high treatment effect. In the above-mentioned treatment patterns 24 and 25, the back right air cell 325 and the back left air cell 326 are expanded/contracted simultaneously; however, the back right air cell 325 and the back left air cell 326 may be expanded/contracted alternately. Moreover, in the case that the treatment operations using the arm right air cell 336, the arm left air cell 337, the leg right air cell 338 and the leg left air cell 339 described above are additionally performed in these treatment patterns, various treatment operations are performed for other portions, and the user can obtain a high treatment effect.

Furthermore, in addition to the above-mentioned embodiments, the entire body of the user may also be bent further backward by bending the body of the user backward using a rolling function in combination with the above-mentioned stretching of the neck front portion. Besides, in the case that rubbing/pounding operations using the massaging mechanism 308 are performed in combination with the stretching of the neck front portion and the stretching of the neck rear portion, massage operations, such as rubbing and pounding, are performed for the back portion, the muscles of which have been stretched by the stretching of the neck front portion and the neck rear portion, whereby more effective massage can be performed. Moreover, massage for further bending the entire body backward can be performed by reclining the backrest section 303 so that the stretching of the entire body is performed in combination with the stretching of the neck front portion. What's more, massage in which the upper body is twisted further can be performed by performing pressure massage for the lower back portion and the buttocks in combination with the stretching of the neck right portion and the stretching of the neck left portion. Still further, the entire body may be massaged by rocking the seat section 2 in the left and right direction using a seat rocking mechanism (not shown) in addition to the above-mentioned neck stretching.

As described above, in the above-mentioned chair-type massage machine M24, by pressing the shoulder portions of the user, stretch treatment in which the neck portion is stretched while the position of the upper body is held and the shoulder portions are stretched can be received effectively. In addition, by pressing the back portion when this treatment is performed, the back portion of the user is bent backward or twisted, whereby stretch treatment for stretching the neck portion can be received more effectively.

The above-mentioned treatment patterns 12 to 21 are examples of treatment operations in the chair-type massage machine M24, and the control section 360 can set the air supplying/exhausting timings and the expansion duration times for the respective air cells 320 to 324 and 336 to 339, combinations and repetitions of plural patterns, etc. as necessary; hence, patterns are not limited to the above-mentioned treatment patterns. For example, the length of the expansion time and the length of the contraction time of each air cell in the above-mentioned treatment patterns 12 to 21 can be selected from among 2 seconds, 3 seconds, . . . , 10 seconds, etc., for example, and the cycles of the treatment patterns may be changed; furthermore, the strength of pressing the user may also be made different among the respective air cells by changing the strengths of the expansion of the respective air cells so as to be different from one another.

In addition, in the above-mentioned embodiments, although the neck treatment device is formed of the head (neck) right air cell 320, the head (neck) left air cell 321 and the neck rear air cell 322, the device may also be formed of only the head (neck) right air cell 320 and the head (neck) left air cell 321 or only the neck rear air cell 322 or may also be formed of others. Furthermore, the head (neck) right air cell 320, the head (neck) left air cell 321, the neck rear air cell 322, the shoulder right air cell 323 and the shoulder left air cell 324 in the above-mentioned embodiments can each be formed of two pieces, and the numbers of the respective air cells 320 to 324, etc. are not limited to those in the above-mentioned embodiments.

Moreover, air cells are taken as examples of the respective treatment devices in the above-mentioned embodiments, the respective treatment devices may also be other treatment devices, such as treatment elements, and are not limited to those in the above-mentioned embodiments.

Still further, the above-mentioned embodiments are examples and can be modified variously within the scope of not impairing the gist of the present invention, and the present invention is not limited to the above-mentioned embodiments.

### INDUSTRIAL APPLICABILITY

The present invention can be applied to a chair-type massage machine, and more particularly, to a chair-type massage machine from which treatment effects for the shoulder portions and neck portion of the user are desired to be obtained.

1. A chair-type massage machine comprising:
a seat section;
a backrest section provided backward the seat section;
a pillow section provided above the backrest section;
shoulder treatment portions that are disposed on the pillow section and that have a plurality of treatment devices to perform treatment correspondingly to a plurality of positions of each shoulder portion of the user; and
a control section configured so as to control the plurality of treatment devices independently of one another.

2. The chair-type massage machine of claim 1,
wherein the plurality of treatment devices comprise:
shoulder outside treatment devices provided correspondingly to the outside portions of the shoulder portions of the user to treat these portions from above;
shoulder inside treatment devices provided correspondingly to the inside portions of the shoulder portions of the user to treat these portions from above; and
shoulder lower treatment devices provided correspondingly to the rear side portions of the shoulder portions of the user to treat these portions from behind, and
wherein the shoulder outside treatment devices, the shoulder inside treatment devices and the shoulder lower treatment devices are each formed of an air cell that is expanded by supplying air.

3. The chair-type massage machine of claim 2,
wherein the control section executes control so that part of the time zone in which the shoulder outside treatment devices are expanded is overlapped with part of the time zone in which the shoulder inside treatment devices are expanded, whereby inside/outside double rubbing treatment is performed for the shoulder portions.

4. The chair-type massage machine of claim 3,
wherein the control section sets the length of the time zone in which the shoulder outside treatment devices are expanded to be substantially the same as the time zone in which the shoulder inside treatment devices are expanded.

5. The chair-type massage machine of claim 2,
wherein the control section expands the shoulder lower treatment devices when part of the time zone in which the shoulder outside treatment devices are expanded is overlapped with part of the time zone in which the shoulder inside treatment devices are expanded.

6. The chair-type massage machine of claim 2,
wherein the control section executes control so that the shoulder outside treatment devices, the shoulder inside treatment devices and the shoulder lower treatment devices are expanded simultaneously for a certain time and then, among them, the shoulder outside treatment devices or the shoulder inside treatment devices and the shoulder lower treatment devices are contracted, whereby inside/outside rubbing treatment is performed for the shoulder portions.

7. The chair-type massage machine of claim 2,
wherein the control section executes control so that the shoulder lower treatment devices are expanded for a certain time and, while these remain expanded, the shoulder outside treatment devices and the shoulder inside treatment devices are expanded, whereby pushing-up rubbing treatment is performed for the shoulder portions.

8. The chair-type massage machine of claim 2,
wherein a neck treatment device is provided at a portion of the pillow section corresponding to the neck portion of the user to treat the neck portion,
wherein the neck treatment device is formed of an air cell that is expanded by supplying air thereto, and
wherein the control section is configured so as to control the neck treatment device independently of the plurality of treatment devices.

9. The chair-type massage machine of claim 2,
wherein a neck treatment device is provided at a portion of the pillow section corresponding to the neck portion of the user to treat the neck portion,
wherein the neck treatment device is formed of an air cell that is expanded by supplying air thereto,
wherein the control section is configured so as to control the neck treatment device independently of the plurality of treatment devices, and
wherein the control section executes control so that only the neck treatment device is expanded for a certain time and, while this remains expanded, the shoulder outside treatment devices and the shoulder inside treatment devices are expanded, whereby pushing-down treatment is performed for the shoulder portions.

10. The chair-type massage machine of claim 1,
wherein the plurality of treatment devices comprise:
shoulder upper treatment devices provided correspondingly to the shoulder portions of the user to treat these portions from above;
shoulder lower treatment devices provided correspondingly to the rear side portions of the shoulder portions of the user to treat these portions from behind; and
a neck treatment device provided correspondingly to the neck portion of the user to treat the portion, and
wherein the shoulder upper treatment devices, the shoulder lower treatment devices and the neck treatment device are each formed of an air cell that is expanded by supplying air.

11. The chair-type massage machine of claim 10,
wherein the neck treatment device comprises:
neck holding treatment devices provided correspondingly to portions near the left and right rear portions of the neck portion of the user to treat the neck portion while holding the neck portion therebetween; and
a neck pushing treatment device provided correspondingly to the rear side portion of the neck portion of the user to treat the portion from behind and to push out the neck holding treatment devices toward the user, and
wherein the control section is configured so as to control the neck holding treatment devices and the neck pushing treatment device independently of each other.

12. The chair-type massage machine of claim 11,
wherein the control section executes control so that the neck pushing treatment device is expanded for a certain time and, while this remains expanded, the neck holding treatment devices are expanded for a certain time and then, while the neck holding treatment devices remain expanded, the neck pushing treatment device is contracted, whereby push-pull rubbing treatment is performed for the neck portion.

13. The chair-type massage machine of claim 10,
wherein the control section executes control so that the shoulder upper treatment devices and the shoulder lower treatment devices are expanded simultaneously for a certain time, whereby sandwiching/rubbing treatment is performed for the shoulder portions.

14. The chair-type massage machine of claim 10,
wherein the control section executes control so that the shoulder upper treatment devices are expanded for a certain time and, while these remain expanded, the shoulder lower treatment devices are expanded, whereby pushing-down/sandwiching/rubbing treatment is performed for the shoulder portions.

15. The chair-type massage machine of claim 11,
wherein the air cells of the neck holding treatment devices are configured so as to be expanded while positions corresponding to the rear side portions of portions near the left and right rear portions of the neck portion of the user or positions corresponding to the front side portions thereof are used as rocking fulcrums.

16. The chair-type massage machine of claim 10,
wherein the air cells of the shoulder upper treatment devices are configured so as to be expanded while positions corresponding to the outside portions of the shoulder portions of the user or positions corresponding to the inside portions thereof are used as rocking fulcrums.

17. The chair-type massage machine of claim 10,
wherein the air cells of the shoulder lower treatment devices are configured so as to be expanded while positions corresponding to the upper side portions of the rear side portions of the shoulder portions of the user or positions corresponding to the lower side portions thereof are used as rocking fulcrums.

18. A chair-type massage machine comprising:
a seat section on which the user sits;
a backrest section provided behind the seat section;
a pillow section provided above the backrest section so that the position thereof can be freely adjusted in the up and down direction;
an up/down movable first treatment device provided in the backrest section to treat the back portion of the user;
a second treatment device provided so as to treat predetermined portions of the user sitting on the seat section; and
a control section configured so as to control the treatment operations of the first treatment device and the second treatment device depending on the position of the pillow section.

19. The chair-type massage machine of claim 18,
wherein the second treatment device is a pillow treatment device provided in the pillow section to treat the shoulder portions of the user, and
wherein the control section is configured so as to selectively perform one of treatment operations using the first treatment device and the pillow treatment device for the shoulder portions of the user.

20. The chair-type massage machine of claim 19,
wherein a first detection portion that detects the shoulder portion is provided, and
wherein the control section sets a treatment regulation range extending in the up and down direction of the shoulder portions based on the detection result of the first detection portion and executes control so that one of the treatment operations using the first treatment device and the pillow treatment device is performed selectively in the treatment regulation range.

21. The chair-type massage machine of claim 20,
wherein the control section stops the pillow treatment device in response to an arrival of the first treatment device to the treatment regulation range from below.

22. The chair-type massage machine of claim 20,
wherein the, control section returns the first treatment device in response to an arrival of the first treatment device to the treatment regulation range from below.

23. The chair-type massage machine of claim 20,
wherein the pillow treatment device has shoulder lower treatment devices extending from the shoulder portions to the back portion, and
wherein the treatment regulation range is a range extending from the shoulder position detected using the first detection portion to a position below the vertical dimension of the shoulder lower treatment devices.

24. The chair-type massage machine of claim 20,
wherein a second detection portion that detects the first treatment device when the first treatment device has been raised to the position of the pillow is provided.

25. The chair-type massage machine of claim 24,
wherein the control section renews the treatment regulation range extending in the up and down direction of the shoulder portions based on the detection result of the second detection portion and executes control so that one of the treatment operations using the first treatment device and the pillow treatment device is performed selectively in the renewed treatment regulation range.

26. The chair-type massage machine of claim 19,
wherein the pillow treatment device has:
shoulder upper treatment devices that treat the shoulder portions from above; and
a neck treatment device that treats the neck portion.

27. The chair-type massage machine of claim 18,
wherein the second treatment device has shoulder side treatment devices provided at positions corresponding to the sides of the shoulder portions to treat the shoulder portions from the sides.

28. The chair-type massage machine of claim 27,
wherein a third detection portion that detects that the shoulder side treatment devices have made contact with the side portions of the pillow section is provided, and
wherein the control section stops the treatment operation of the shoulder side treatment devices based on the detection result of the third detection portion.

29. A chair-type massage machine comprising:
a seat section on which the user sits;
a backrest section that supports the upper body of the user sitting on the seat section from behind;
a pillow section provided above the backrest section;
shoulder treatment portions having shoulder treatment devices provided at the left and right positions so as to be opposed to the upper faces of the shoulder portions of the user sitting on the seat section; and
a neck treatment portion having a neck treatment device provided so as to be opposed to the neck portion or the head portion of the user sitting on the seat section, and further comprising:
a control section that drives/controls the shoulder treatment devices at the left and right positions independently of each other and that independently drives/controls the neck treatment device.

30. The chair-type massage machine of claim 29,
wherein the control section has a function in which, after the shoulder treatment devices on either one of the left and right positions are expanded for a certain time, while the shoulder treatment devices remain expanded, the neck treatment device is expanded for a certain time.

31. The chair-type massage machine of claim 29,
wherein the neck treatment device has head side treatment devices provided at the left and right positions so as to be opposed to the head side portions of the user sitting on the seat section, and
wherein the control section has a function of driving/controlling the head side treatment devices at the left and right positions independently of each other.

32. The chair-type massage machine of claim 31,
wherein the shoulder treatment devices have first air cells that are expanded/contracted by supplying/exhausting air,
wherein the head side treatment devices have second air cells that are expanded/contracted by supplying/exhausting air,
wherein the first air cells are configured so that the outside portions thereof serve as base end portions and the inside portions thereof are expanded toward the upper faces of the shoulder portions of the user, and
wherein the second air cells are configured so that the inside portions thereof serve as base end portions and the outside portions thereof are expanded toward the head side portions of the user.

33. The chair-type massage machine of claim 32,
wherein the second air cells are each disposed so as to be inclined such that the outside portion thereof is positioned above the inside portion.

34. The chair-type massage machine of claim 29,
wherein the neck treatment device has a neck rear treatment device provided so as to be opposed to the rear face of the neck portion of the user sitting on the seat section, and
wherein the control section has a function of independently driving/controlling the neck rear treatment device.

35. The chair-type massage machine of claim 34,
wherein the neck rear treatment device has a third air cell that is expanded/contracted by supplying/exhausting air, and
wherein the third air cell is configured so that the upper side portion thereof serves as a base end portion and the lower side portion thereof is expanded toward the neck portion of the user.

36. The chair-type massage machine of claim 29,
wherein armrest sections that support the arm portions of the user sitting on the seat section are provided at the left and right positions,
wherein the armrest sections have fourth air cells that treat the arm portions of the user, and
wherein the control section has a function of driving/controlling the fourth air cells located at the left and right positions independently of each other.

37. The chair-type massage machine of claim 29,
wherein fifth air cells that treat the leg portions of the user sitting on the seat section from the left and right positions are provided, and
wherein the control section has a function of driving/controlling the fifth air cells located at the left and right positions independently of each other.

38. The chair-type massage machine of claim 29,
wherein back treatment devices that treat the back portion of the user leaning against the backrest section from the left and right positions are provided, and
wherein the control section has a function of driving/controlling the back treatment devices located at the left and right positions independently of each other.
